(19) United States
(12) Patent Application Publication
(10) Pub. No.: US 2023/0378863 A1
(43) Pub. Date: Nov. 23, 2023

(54) Apparatus For Moving A Movable Module Thereof Based On Magnetic Interactions

(71) Applicant: MagPol International B.V., Lisse (NL)

(72) Inventor: Attila K. Szalóky, Telki (HU)

(73) Assignee: MagPol International B.V., Lisse (NL)

(21) Appl. No.: 18/031,366

(22) PCT Filed: Oct. 12, 2021
(86) PCT No.: PCT/NL2021/050617

§ 371 Date: Apr. 12, 2023

(30) Foreign Application Priority Data
Oct. 15, 2020 (NL) 2026680

(51) Int. Cl. H02K 53/00; H02K 7/116

(52) U.S. Cl. CPC H02K 53/00; H02K 7/116

(57) ABSTRACT

The invention is an apparatus for moving a movable module, comprising
a stationary module (30′) having first permanent magnets (21),
a movable module (29′) arranged movably with respect to the stationary module (30′) and having second permanent magnets (23), and
polarizer elements (24),
   wherein
during operation, a movement of the movable module (29′) is exclusively based on magnetic interactions, wherein continuously by means of moving polarizer elements (24)
   a pushing effect is present between the same magnetic poles a first pair of a first permanent magnet (21) and a second permanent magnet (23), and/or
   a pulling effect is present between a second pair of a first permanent magnet (21) and a second permanent magnet (23) via a polarizer element (24) being moved into between the second pair of magnets.

### TECHNICAL FIELD

The invention relates to an apparatus for moving a movable module thereof based on magnetic interactions.

### DESCRIPTION OF PRIOR ART

It is a commonly known physical phenomenon that magnetism manifests in a force that exerts a force effect on magnetizable materials in its proximity. Any such materials that generate a magnetic field while retaining their magnetic properties are called permanent magnets.

Providing such apparatuses that can generate continuous motion utilizing the magnetic force of permanent magnets as a power source has been a long-time research interest. Accordingly, many known devices have been built to achieve this goal.

A rotary device having a rotor and a stator provided with permanent magnets is disclosed in U.S. Pat. No. 4,831,296. In this approach a shielding member is utilized and a gear connection is inserted between the axis of the rotor and the cylindrical shielding member (this latter encompasses the rotor) to interlock these. Through holes are formed in the cylindrical shielding member which—when the rotary device is operated—rotates in opposite direction compared to the rotor.

In US 2005/225831 A1 a rotator based on magnetic principles is disclosed, the cylindrical shaped rotator comprises an arrangement of permanent magnets on its ends and also a permanent magnet isolator between them.

In U.S. Pat. No. 4,151,431 a permanent magnet motor having different shaped magnets on its stator as well as on its rotating part is disclosed. A motor built with permanent magnets is disclosed in FR 2542144.

Similarly, further magnetic motors are disclosed in U.S. Pat. No. 7,312,548 B2, WO 2009/016045 A1, WO 2009/019001 A1, WO 2006/045333 A1, US 2007/296284 A1.

From the above documents, in WO 2006/045333 A1 a so-called Perendev-type magnetic motor (in short: Perendev-type arrangement) is disclosed. According to its principle, the Perendev motor consists of two components. One of these components is a stationary outer ring, while the other is an internal rotor. In both components there are arranged magnets at a relative angle, with their identical poles facing each other. The principle is that the repulsive force generated between the magnets disposed at an offset angle urges the internal rotor to move.

Further from the above documents, in WO 2009/019001 A1 a so-called Yildiz-type magnetic motor is disclosed. The developer, Muammer Yildiz, also built his magnet motor based on the Perendev principle. He placed magnets of different arrangement and size opposite each other. The difference from the Perendev principle is that the magnets are arranged on the rotating shaft in a helical arrangement.

Similar magnetic motors having magnets coated with magnetic shielding material are disclosed in CN105991066 and DE 3526806 A1. Similar type shielding material is disclosed in US 2010/156223 A1. Outer shielding is applied in CN 106549539 A.

A magnetic motor performing a complex type of moving when operates is disclosed in U.S. Pat. No. 6,867,514 B2.

In view of the known approaches, there is a demand for an apparatus for moving a movable module thereof based on magnetic interactions that is more effective than the known approaches.

### DISCLOSURE OF THE INVENTION

The primary object of the invention is to provide an apparatus for moving a movable module thereof based on magnetic interactions which is free of the disadvantages of prior art approaches to the greatest possible extent.

It is an object of the invention to provide an apparatus for moving a movable module thereof based on magnetic interactions that is more effective than the known approaches.

The objects of the invention can be achieved by the apparatus for moving a movable module thereof based on magnetic interactions according to claim 1. Preferred embodiments of the invention are defined in the dependent claims.

Primarily, the invention is an apparatus for moving a movable module based on magnetic interactions.

In other words, the invention may be described with other approaches, such that it relates—many times in embodiments—to a magnetic polarizer arrangement adapted to utilize permanent magnets as a power source, a system comprising the magnetic polarizer arrangement (as well as permanent magnets), an arrangement for producing controllable rotational or translational motion applying the system comprising the magnetic polarizer arrangement. Furthermore, the invention may be interpreted as a method for operating the magnetic polarizer arrangement, as a method for producing the magnetic polarizer arrangement as well as the system comprising the magnetic polarizer arrangement. The invention further relates to the application of a system comprising the magnetic polarizer utilizing permanent magnets as a power source.

In the invention, there is a magnetic polarizer arrangement that allows two permanent magnets arranged with their identical poles facing each other to move relative to each other in a controlled manner.

The invention is, furthermore, an apparatus and method utilizing which a controllable rotational or translational movement can be realized applying a permanent magnet power source.

It is essential that in the invention by the pulse-like, controlled sinusoidal polarization of a given magnetic field a controlled translational or rotational motion can brought about, whereby the passive energy of the magnetic field is converted into unidirectional, positive torque energy (i.e. active energy).

### BRIEF DESCRIPTION OF THE DRAWINGS

Preferred embodiments of the invention are described below by way of example with reference to the following drawings, where

FIG. 1 is a schematic drawing of magnetic interaction,

FIG. 2 is further schematic drawing of magnetic interaction,

FIG. 3 is a schematic drawing of introducing a polarizer element into the arrangement of FIG. 2,

FIGS. 4A and 4B are schematic drawings of introducing a polarizer element between two repulsive magnets,

FIGS. 5A and 5B are further schematic drawings of introducing a polarizer element between repulsive magnets,

FIGS. 6A, 6B and 6C are spatial drawings of a polarizer element from above, in a view and in a front view,

FIG. 7A is a partial view of a first embodiment of the invention,

FIG. 7B is a section made on B-B section line indicated on FIG. 7A,

FIG. 8 is a top view illustrating the first embodiment of the invention,

FIG. 9A is a spatial drawing illustrating an embodiment of the invention,

FIG. 9B is a spatial drawing of a circular control element,

FIGS. 10A and 10B are schematic drawings illustrating the movement of a polarizer element in the first embodiment,

FIG. 11A is an exploded view of the first embodiment of the invention from above,

FIG. 11B is a further exploded view of the first embodiment of the invention from below,

FIG. 11C is a spatial view of the first embodiment of the invention,

FIG. 11D is a further spatial view from below of the first embodiment of the invention,

FIG. 12 is a partial sectional view of the first embodiment of the invention,

FIG. 13A-13D are spatial, sectional-spatial, sectional and further sectional illustrations of a further embodiment (a variant of the first embodiment) which is similar to the first embodiment of the invention,

FIGS. 14A-14D are top partial views of the first embodiment illustrating the movement of movable disc,

FIG. 14E is a graph showing the torque as a function of time,

FIGS. 15A-15I are schematic illustrations of exemplary arrangement of magnets in the first embodiment,

FIGS. 16A and 16B are schematic illustrations of optical control of the first embodiment of the invention,

FIGS. 17 and 18 are illustrations of polarizer elements in a second embodiment of invention,

FIG. 19 is an exploded spatial view of a second embodiment of the invention,

FIG. 20A is a sideview of the second embodiment of the invention,

FIG. 20B is a partial view of the second embodiment of the invention and circled in FIG. 20A,

FIGS. 21-23 are sideview drawings illustrating discs of the second embodiment of the invention,

FIGS. 24A-24I are drawings illustrating the movement of the movable disc in the second embodiment of the invention alternating a spatial view and a transparent view,

FIG. 25 is a spatial view of arrangement of stationary discs in the second embodiment of the invention,

FIG. 26 is an illustration of arrangements of movable discs in the second embodiment of the invention,

FIG. 27 is an illustration of arrangement of polarizer discs in the second embodiment of the invention,

FIG. 28 is a further illustration of polarizer discs,

FIG. 29 is a spatial view of an apparatus according to the second embodiment of the invention,

FIG. 30 is a spatial drawing of the third embodiment of the invention,

FIG. 31 is a sideview of the stationary disc of the third embodiment,

FIG. 32 is a spatial drawing of the movable disc in the third embodiment,

FIG. 33 is a spatial drawing of a guiding element for moving the polarizer element,

FIG. 34A is a spatial drawing of a polarizer element,

FIG. 34B is a spatial drawing of a further polarizer element,

FIG. 35 is spatial drawing of an apparatus according to the third embodiment of the invention,

FIG. 36 is an exploded view of the arrangement illustrated in FIG. 30,

FIG. 37 is a sideview illustrating the movement of the movable disc in the third embodiment of the invention,

FIG. 38A is a spatial view of a compensator applicable in the third embodiment of the invention,

FIGS. 38B and 38C are illustrate a part of the compensator,

FIG. 39 is a spatial illustration of the arrangement of the compensator of FIGS. 38A-38C,

FIG. 40 is a further illustration of the arrangement of the compensator,

FIGS. 41-45 are yet further illustrations of the arrangement of the compensator,

FIGS. 46-47 are schematic drawings illustrating the operation of the compensator.

### MODES FOR CARRYING OUT THE INVENTION

To illustrate the operating principle of the invention, basic magnetic principles are introduced herebelow. There is a (magnetic) dipole-dipole interaction between two permanent magnets. The force arising between the magnets can be attractive (attracting) or repulsive. The arrangement (i.e. apparatus as introduced below) according to the invention utilizes the repulsive force arising between two magnets as a power source (giving an appropriate motion to the movable module or movable disc).

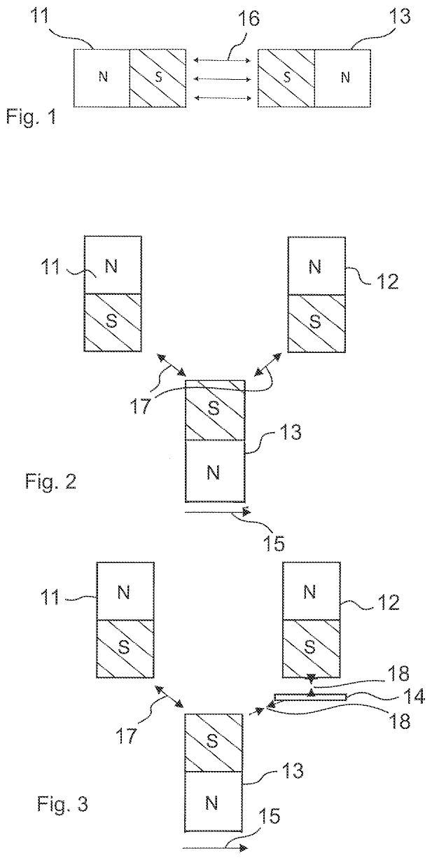

According to the principle of the arrangement applied in the invention, stationary (static) and movable (moving) permanent magnets are positioned (arranged) with their identical poles facing each other. Thus, a repulsive interaction occurs between the two magnets. This is illustrated in FIG. 1 between a first permanent magnet 11 and a second permanent magnet 13 (these could be stationary and movable permanent magnets as well) showing a repulsive force 16 with the help of arrows pointing at both ends. FIG. 1 shows that the same magnetic poles (S, i.e. south poles) are close to each other and the other opposite magnetic poles (N: north poles) are further away from each other. Magnetic poles may be called simply as poles.

By moving the two magnets along a predetermined line (a line 15 in the illustration of FIG. 2), at a constant relative distance, in front of each other, a negative and a positive repulsive force occurs between the magnets (in the arrangement illustrated in FIG. 2, depending on the relative position of the poles, i.e. during the movement; similarly to FIG. 1 same poles face to each other). When the two magnets are brought closer to each other, a force has to be exerted against the negative repulsive force and to maintain the continuous motion (i.e. when a magnet is moved closer and closer to the other magnet).

As soon as the longitudinal axes of the two magnets become aligned, the lateral negative repulsive force disappears. At this point, these act on each other by the repulsive force along the axial direction of the magnets situated opposite each other.

The force occurring during the further movement of the movable magnet (after the alignment of the axes) is termed “positive repulsive force” (this a helping type repulsive force from the point of view of the movable magnet which is a shortened name of movable permanent magnet). The negative and positive forces that occur are in balance, so the resultant force is zero (in the arrangement of FIG. 2). In FIG. 2 that position is illustrated in which the movable permanent magnet 13 is at the halfway between permanent magnets 11 and 12, thus repulsive forces 17 are in balance (see also line 15 of the movement of the movable permanent magnet 13 and the arrangement of magnetic poles). In this arrangement a further (third) permanent magnet 12 has been brought in compared to FIG. 1 and permanent magnet is subjected to movement.

To enable the operation of the arrangement (apparatus) according to the invention, the negative force occurring between the two magnets is reduced, or is eliminated for a predetermined period of time, by means of magnetic polarization brought about by a polarizer (a polarizer element 14, with other term: magnetic polarizer) inserted between the two magnets. Unidirectional motion is brought about as a result of eliminating the negative repulsive forces and sustaining the positive forces that arise between the two magnets as shown in FIG. 3.

As a result of the arrangement modified compared to FIG. 2 a different distribution of forces can be achieved. A repulsive force 17 remains between the permanent magnets 11 and 13, but—by the help of the arrangement of the polarizer element 14, attractive forces 18 can be achieved between the polarizer element 14 and the second permanent magnet 13 as well as the third permanent magnet 12. Thanks to this the “positive” repulsive force 17, as well as the attractive force 18 between the polarizer element and the permanent magnet 13 helps the movement of permanent magnet 13 along the line 15.

Herebelow, a short introduction is given to the principles of magnetic polarization.

All permanent magnets have a constant magnetic field (as well as constant magnetic induction). The strength of the magnetic field cannot be increased or reduced temporarily. This can be achieved solely by an external influence that permanently affects the properties of the permanent magnet. For example, in the case of neodymium magnets, such an influence is the high external temperature, as a result of which the magnet partially or entirely loses its magnetic field.

Permanent magnets act on various materials by magnetic force. According to the invention, the permanent magnets by which they act on paramagnetic materials were investigated, analyzed, and applied.

Every magnet has two poles, a north and a south pole (dipole) that are in balance with each other. The atoms constituting the material of the magnet consist of charged particles (atomic nucleus and electrons) that are in constant motion. The motion of the charges in the nucleus is negligible, but the electrons undergo significant motion on an atomic scale, which means that electric currents are generated in the atom. These atomic currents generate magnetic dipole moments and a magnetic (force) field.

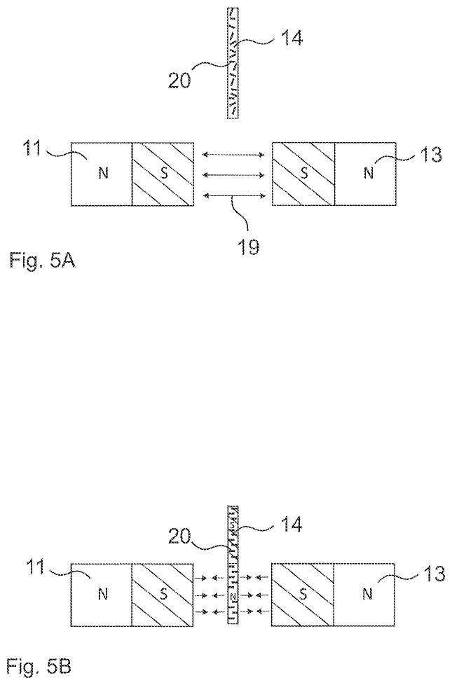

In the majority of materials, the combined magnetic dipole moment of the atoms is non-zero, and therefore the atoms have a resultant magnetic dipole moment. However, in the absence of an external magnetic field, these dipole moments are distributed in a disordered (non-ordered, unaligned) manner, and their average resultant magnetic force field is zero. Under the effect of an external magnetic force field these atomic dipoles become ordered (aligned), and thus the material will have an own magnetic force field. When the magnetic force field disappears, the majority of the atomic dipoles will again become disordered (unaligned), whereupon the own magnetic force field disappears (see FIG. 5). These are called paramagnetic materials. The five most typical of the paramagnetic materials are soft iron, nickel, cobalt, gadolinium and dysprosium.

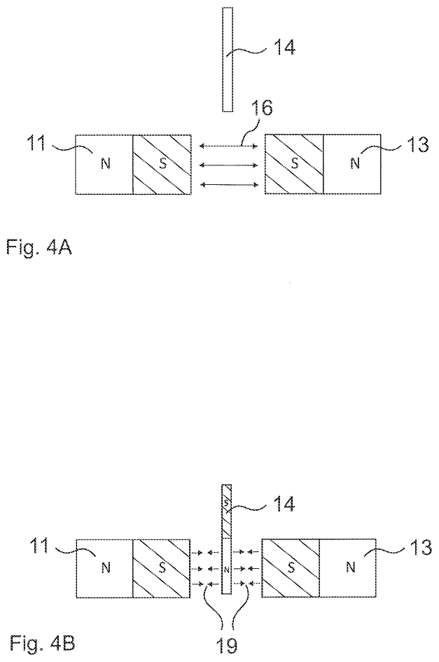

The polarity of the atomic dipoles of paramagnetic materials is opposite the polarity of the external magnetic force field, so an attraction is produced between the magnetic force field of the paramagnetic material and the external magnetic force field (see FIGS. 4A and 4B).

In FIG. 4A such a situation is illustrated where a magnetic polarizer element 14 is not yet inserted between permanent magnets 11 and 13, accordingly there are no poles denoted on it and the repulsive forces 16 are indicated between the permanent magnets 11 and 13 (cf. FIG. 1). On the contrary, the polarizer element 14 is inserted between the first and second permanent magnets 11, 13 in FIG. 4B. As a result of the insertion, the polarizer element 14 become polarized (see the poles denoted on the polarizer element 14) and polarized attractive forces—i.e. attractive forces exerting as a result of arranging the polarizer element—19 will emerge between the polarizer element 14 and the permanent magnets 11, 13.

This is also illustrated in FIGS. 5A and 5B where the arrangement of atomic magnetic dipoles of the polarizer element 14 are illustrated schematically: disordered and ordered, respectively (this illustration is, of course, fully schematic: there are much more dipoles in a material and their sizes are many orders of magnitude smaller compared to the macroscopic magnets).

The magnetic effect of permanent magnets exerted on other materials can be reduced without the modification or deterioration of the characteristics of the permanent magnet. When a paramagnetic material is placed into the magnetic field of a permanent magnet, the magnet exerts a force on the material placed in the field. The properties of the permanent magnet will not be removed, but the magnetic force of the permanent magnet will be reduced by the extent (polarization) of the force exerted on the paramagnetic material placed in the field (in other words, by the help of a polarizer element, the field of a permanent magnet can be changed and the repulsive effect can be avoided in those stages when it is necessary; i.e. this effect is used in the invention to ensure a preferably continuous motion of the movable module). By further increasing the thickness and surface area of the paramagnetic material, the magnetic force of the permanent magnet can be reduced further, or it can be fully neutralized, i.e. polarized. This is called magnetic polarization.

Herebelow, materials of magnetic polarizers are introduced. The application of magnetic polarizers enables that the negative repulsive force arising between identical-pole magnets approaching each other can be—mostly—eliminated. The required magnetic polarization can be realized utilizing any such paramagnetic material of which material the atomic dipoles become aligned in an external magnetic field, but upon removing the magnetic field the dipoles again become completely or largely unorganized (unaligned). This means that the material does not have a magnetic field in itself, but under the effect of an external magnetic field it will have an own magnetic field, which magnetic field is of opposite polarity with respect to the polarity of the external magnetic field. For realizing and utilizing the magnetic polarization according to the invention, all paramagnetic materials can be applied. There are other materials which are magnetically polarizable, for example some alloys have this property, such as soft iron.

To summarize, the stationary and movable permanent magnets are basically realizable by any permanent magnet (like magnetized ferromagnetic materials). The material of the polarizer is a magnetically polarizable material, like soft iron. As the material of the polarizer, also paramagnetic materials could be utilized, like chrome, platina and wolfram. These aspects are applicable at the operating temperature of the apparatus, which is typically room temperature (approx. 25° C.), i.e. those materials can be applied which constitute at the (selected) operating temperature a permanent magnet (e.g. ferromagnetic at this temperature) as well as constitute at the (selected) operating temperature a magnetically polarizable material (e.g. paramagnetic at this temperature).

In the following results or the magnetic polarization tests and experiments are introduced. For applying the magnetic polarization effect, several experiments and measurements were carried out.

The Perendev-type arrangement was primarily tested (see in the introduction), which lacks polarizers, i.e. only comprises magnets that are arranged in different manners with their identical poles facing each other. In all such cases, in accordance with the laws of physics, a balance state was produced, so the movement of magnets relative to each other is not possible. Further testing of these arrangements was therefore interrupted.

As it was established in the early stages of testing the magnetic polarizer (i.e. in the apparatus according to the invention), the kinetic energy realization based on the interaction between the magnets is possible exclusively by the intermittent (time-to-time) polarization of the magnetic field.

In addition to determining the material of the polarizer, determining the exact dimensions thereof is of predominant importance in order to achieve an adequate level magnetic polarization. For determining the dimensioning of the polarizer, the following series of experiments and measurements was carried out.

For the measurements a HT20 Tesla Meter (https://kenswu.zzvps.com/cjc-fashion/HT20-manual.pdf) was utilized.
Measurement range: 0.001 mT-2000 mT
Magnet: Neodymium N48—8 mm*20 mm (diameter*length) rod (having cylindrical shape)
Central Gauss value (the magnetic field in the centre of the rod, on the surface of the circle): 154 mT
Polarizer material: soft iron
Dimensions: 8*8 mm—Soft iron 0.5; 1; 1.5; 2 mm (the latter data is the thickness)
   10*10 mm—Soft iron 0.5; 1; 1.5; 2 mm
   12*12 mm—Soft iron 0.5; 1; 1.5; 2 mm

TABLE 1

Sheet thickness (Lv)

| Polarizer | 0.5 mm | 1.0 mm | 1.5 mm | 2.0 mm |
|---|---|---|---|---|
| 8 × 8 mm | 143 mT | 99 mT | 65 mT | 34 mT |
| 10 × 10 mm | 139 mT | 97 mT | 59 mT | 31 mT |
| 12 × 12 mm | 127 mT | 87 mT | 45 mT | 28 mT |

The magnet—having a cylindrical shape—may not touch the polarizer (which has a square shape with low thickness), so during the measurements an air gap of 1 mm was maintained between the magnet and the polarizer. The square shaped polarizer was placed to the circle shaped base of the cylindrical magnet symmetrically such that the 8*8 mm polarizer covers totally the circle base having a diameter of 8 mm. When a larger polarizer is applied it also covers the circle end of the magnet symmetrically. For the measurements the probe body of the HT20 Tesla Meter was at 1 mm from the polarizer on its other side than the magnet, also symmetrically.

The results listed in Table 1 has proven our expectations. Applying a larger or thicker polarizer will decrease more and more the strength of the field measurable at the opposite side of the polarizer (see the values in Table 1).

Based on the results of the measurements and verification tests, it is appropriate to apply a polarizer having a surface area that is preferably maximally 10-15%, particularly preferably maximally 15% greater than the working surface area (free surface, see below) of the magnet to be polarized. In the lateral directions (see its interpretation below) in total, the overextension compared to the respective extension of the magnet to be polarized is preferably maximized in 50% and the overextension is typically over 20%, i.e. the overextension is concentrated to the lateral directions. These conclusions are basically applicable to the first and third embodiment, in the second embodiment, other aspects are to be taken into account.

The magnets—as illustrated in the figures—are typically arranged in respective indentations. The indentations are preferably configured so that a permanent magnet is surrounded by (encompassed into) a stationary or movable module having preferably a non-magnetizable material at many of its sizes so that a free surface of the magnet faces outside with a selected magnetic pole which can meet with the same pole of the permanent magnet of the other of stationary module or movable module. The free surface can be clearly identified in many of the drawings; sometimes the indentation surrounds the magnet only from three sides but in this case the other sides except of the free surface are typically covered by covering plates of the stationary module and the movable module.

Since typically the free surface is the “meeting surface” and the magnet is encompassed into an indentation, the polarizer element is to be arranged in front of the free surface, this side of the magnet should be covered by the polarizer element from the point of view of the other magnet. To have a polarizer element with the above specified maximum 10-15% greater than the free surface is typically means a lateral overextension of the polarizer element to the extent as specified above. The lateral direction is typically the direction of the movement of the movable module which is lateral of the free surface. It the directions perpendicular to the lateral direction typically such overextension is applied with which the magnet is securely covered (this is applicable also for the second embodiment).

As also specified above the coverage can be investigated from the point of view of the movable permanent magnet, i.e. when the stationary permanent magnet is seen from front and the polarizer element is fully inserted before it. It is noted that in many case the free surface of the magnet is a circle while the polarizer element may have a rectangular shape (e.g. in the first and third embodiments), thus the overextension can have additional parts around the circle.

Herebelow, there is given some data about N48 magnet applied as the material of the permanent magnet and soft iron applied as the material of the polarizer.

Neodymium magnets are graded according to their maximum energy product, which relates to the magnetic flux output per unit volume. Higher values indicate stronger magnets (accordingly, N48 is a quite strong magnet). For sintered NdFeB (this is an abbreviation, more precisely, it is for Nd₂Fe₁₄B alloy) magnets, there is a widely recognized international classification. Their values range from 28 up to 52. The first letter N before the values is short for neodymium, meaning sintered NdFeB magnets. Letters following the values indicate intrinsic coercivity and maximum operating temperatures (positively correlated with the Curie temperature), which range from default (up to 80° C. or 176° F.) to AH (230° C. or 446° F.).

The soft iron and other raw irons are produced from iron ores, e.g. Fe₂O₃, Fe₃O₄, FeS and FeCO3. The different kinds of irons are differentiated based on their (added) carbon content. The carbon content of the soft iron is the lowest, it has under 0.06% carbon content. Other materials have higher carbon content, the steel has at least 0.1% carbon content, as well as the hardened steel has 0.3-1.72% carbon content. Naturally, there are other kinds of iron ores.

Herebelow, the details of the invention are given.

The invention is an apparatus for moving a movable module thereof based on magnetic interactions. The apparatus can be called alternatively a motion converter apparatus (converting the motion of the polarizer elements into the movement of the movable module) or a motion generator apparatus. Furthermore, it can be considered as a torque generator or torque converter.

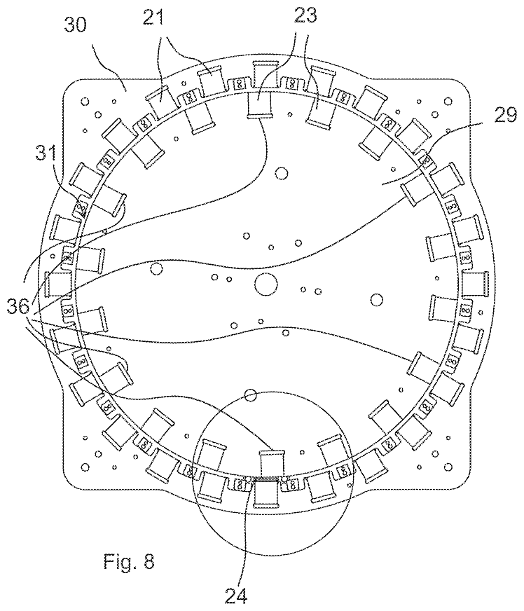

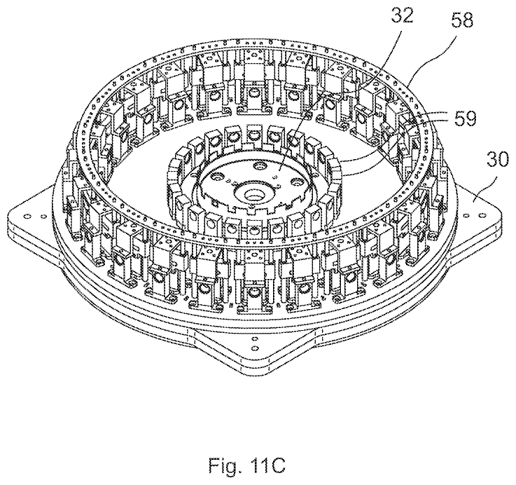

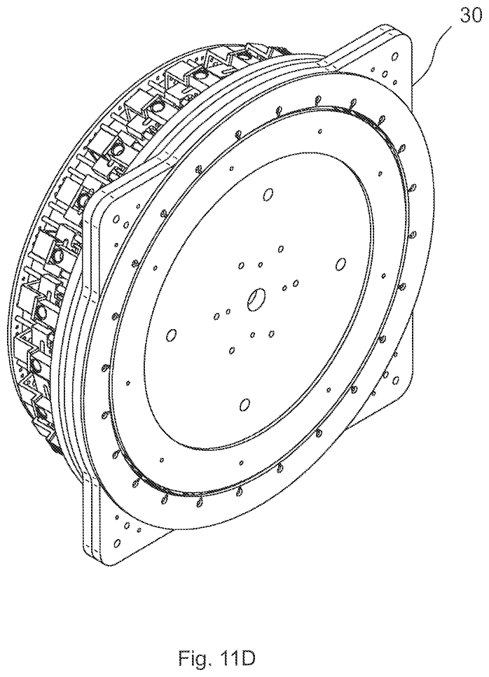

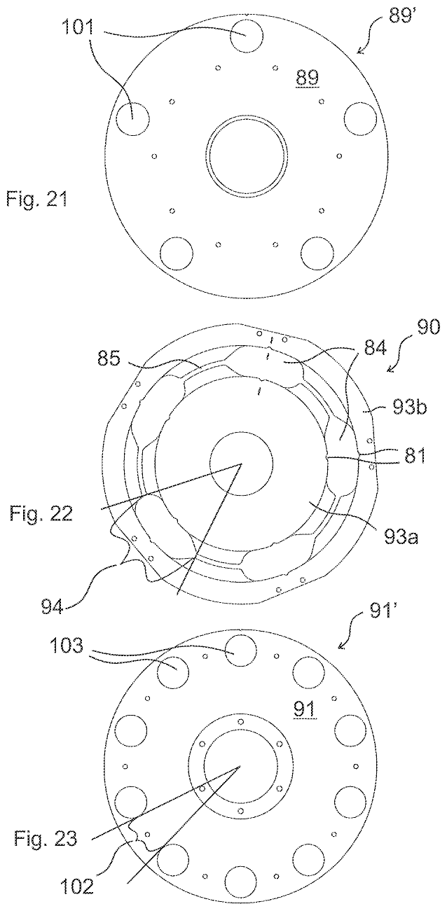

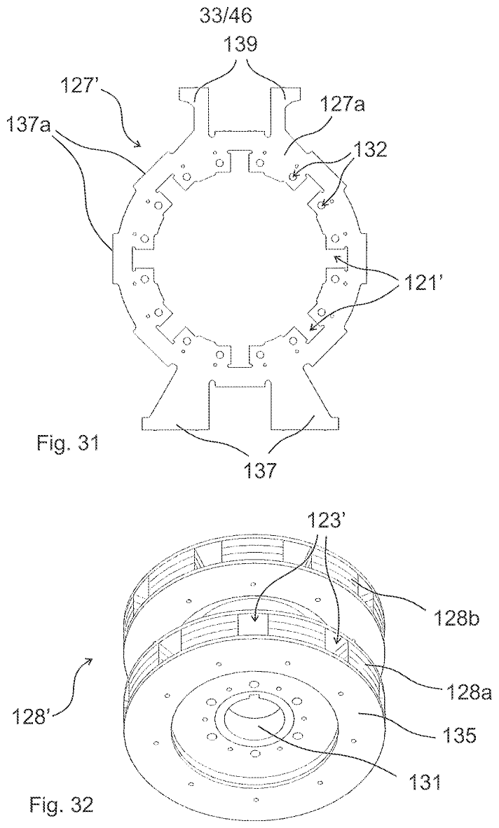

The apparatus according to the invention comprises
a stationary module (a stationary module 30′ implemented by a stationary ring 30 is shown in FIG. 11B; for a stationary module 89′ implemented by a stationary disc 89, see FIG. 21; and for a stationary module 127′ implemented by a stationary ring 127a, see FIG. 31) having (comprising) a plurality of first permanent magnets (e.g. permanent magnets 21 in FIG. 8), and
a movable module (a movable module 29′ implemented by a movable disc 29 is shown in FIG. 11B; for a movable module 91′ implemented by a stationary disc 91, see FIG. 23; and for a movable module 128′ implemented by a movable disc 128a, see FIG. 32) arranged movably (it can be moved with respect to it) with respect to the stationary module (the movable module is always the one which can be moved/displaced, while the stationary module remains stationary) and having a plurality of second permanent magnets (e.g. permanent magnets 23 in FIG. 8), wherein the plurality of the first permanent magnets and the plurality of the second permanent magnets are arranged on the stationary module and the movable module (of course, the movable and stationary modules are also configured and arranged so that to allow this), respectively, so that upon a movement of the movable module same magnetic poles of a first permanent magnet and a second permanent magnets are directed to each other.

According to the last part of the previous section, if a first and a second permanent magnet meet (i.e. are moved in front of each other, according to the configuration, these will never collide into each other) during the movement of the movable module, the first permanent magnet and the second permanent magnet will face each other with their same magnetic poles. As it is illustrated in the figures, the movable permanent magnets will meet with different stationary permanent magnets, these are not always face each other since there are periods when these are not arranged in front of each other but e.g. the movable permanent magnet is somewhere between two stationary permanent magnets on its path. However, when these partially or totally face each other, then their same poles will be directed to each other (i.e. the stationary and movable permanent magnets are brought in front of each other with their same poles, sometimes with polarizer element brought between them). In other words, in the apparatus according to the invention, no such situation occurs during the movement of the movable disc when opposite poles of the first and second permanent magnet would face to each other (which would lead to an attracting force).

The permanent magnets utilized in the invention—as illustrated in FIGS. 1-5B and interpreted in connection with them—are (macroscopic) permanent magnets with two opposite magnetic poles so these can be arranged according to the above detailed principles. The permanent magnets of the stationary module may be called first permanent magnet or stationary permanent magnet, but throughout the description in many cases the term “first” or “stationary” is omitted and the respective permanent magnets are differentiated by the help of their numbers. The case is similar for the permanent magnets of the movable module, these may be called second or movable permanent magnet, but the term “second” or “movable” also may be omitted.

It is clear from the figures and the interpretations how the magnets and the modules (stationary and movable module) are arranged with respect to each other. In case of a translational motion, the magnets can be arranged in a row, as well as in case of rotating motion—as illustrated in many of the figures—the magnets can be arranged on a certain radius (i.e. the radius does not necessarily mean the outer radius) or on the outer periphery of disc, and on the inner periphery of a ring, etc. It is also clear from the figures that the magnets are many times arranged in an indentation, typically with only one facing-out (free) surface.

The apparatus according to the invention further comprises a plurality of polarizer elements (e.g. polarizer element 24 in FIG. 8) made of magnetically polarizable material, and the plurality of polarizer elements being arranged in the same number as the plurality of the first permanent magnets of the movable module.

In the apparatus according to the invention, the plurality of polarizer elements are arranged movably with respect to the stationary module (and, of course with respect to the movable module, but this is a consequence of the movability of the movable module) so that (i.e. arranged so that) each of the polarizer elements can be moved to be arranged between a first permanent magnet and a second permanent magnet (i.e. each is movable between a first and a second permanent magnet so that it can select or designate a temporary pair of them by its arrangement).

As it will be shown in the embodiments a polarizer element can be arranged between a first permanent magnet and a second permanent magnet in several ways. This is also influenced by the fact that the second permanent magnets move together with the movable module (i.e. the second permanent magnet is typically different time to time, or in other words, it is the same only cyclically; this is true if any of the embodiments is considered). The arrangement is typically done in such a way that a corresponding polarizer element (see first and third embodiment) or a cyclically moving polarizer element is arranged between a stationary first permanent magnet and a second permanent magnet being just there (to “sandwich” the polarizer element with the first permanent magnet).

Furthermore, the apparatus according to the invention is configured such that during an operation of the apparatus (i.e. when the apparatus is operated) a movement of the movable module is exclusively based on magnetic interactions, wherein continuously during the operation of the apparatus for the movement of the movable module by means of moving of polarizer elements (the polarizer elements are moved in a controlled manner for the movement of the movable module, in many times these are—in some cases, directly—synchronized with each other to this end)
a pushing (repulsive) effect is present between the same magnetic poles a first pair of a first permanent magnet and a second permanent magnet (there is a pushing effect somewhere between the stationary and movable module between any of their magnets, it can emerge in more positions, i.e. between more pairs, such a repulsive pair is called a ‘first pair’), and/or
a pulling (attractive) effect is present between a second permanent magnet and a polarizer element (the pulling effect is established by the help of the polarizer element) being moved into between a second pair of a first permanent magnet and the second permanent magnet (that said second permanent magnet, which is mentioned at the beginning of this section; the pulling effect is established by the help of the polarizer element, there will be an attraction also between the stationary first permanent magnet and the polarizer element; and the pulling effect can also be anywhere in the stationary and movable modules, such an attractive pair is called a ‘second pair’).

The “and/or” separator means that at least one of the pushing effect and the pulling effect is required continuously during the operation (see above), but also it is possible that the two types of effects emerge at the same time. According to the above a continuous pushing and/or pulling effect is present during the operation of the apparatus (i.e. there are arranged enough first and second permanent magnets to achieve this). If, according to the first option of the “or” is required, i.e. a continuous pushing effect, it means that the overlap is preferably required (see also below). If the other option of the “or” is required, it can correspond to a situation when the movable magnet is far from the stationary magnets, i.e. there is no pushing effect, but it is helped to proceed by a pulling effect. These are the magnetic interactions on which the invention is based, the pulling effect also can be considered as a magnetic interaction between permanent magnets which interaction is “transmitted” by the help of the polarizer element.

As touched upon above the pushing effect (interaction) and pulling effect (interaction) can also be called as a repulsive and attractive effect, respectively, or, in other words, the effect itself can be called repulsion and attraction. This effect is present between the respective components, which can be termed also that the effects act between the components. The terms “pushing/pulling” also show that these effects facilitate the movement of the movable module.

It is noted that it is necessary to have a plurality of magnetic interactions (i.e. different magnetic interactions between different entities) during the operation of the apparatus, since there are arranged a plurality of all the respective components (polarizer elements, first and second permanent magnets). Based on this, it is required that the stationary and movable modules have a rather complex configuration. Furthermore, during the operation of the apparatus, movement of polarizer elements is done. Moreover, during the whole operation preferably all of the plurality of polarizer elements are moved (typically many times, according to a predefined rhythm).

To summarize, during the operation of the apparatus for the movement of the movable module by means of moving of polarizer elements it is achieved that the pushing effect and the pulling effect is manifested in an appropriate manner for establishing the movement of the movable module, or, in some embodiments, the—preferably continuous—rotational motion of the movable disc. As illustrated in the disclosure of the embodiments, this is preferably achieved by controlled moving of polarizer elements.

It is noted that the stationary module may be called simply a first module arranged stationary and the movable module may be called simply a second arranged movably. The movable module can also have the name ‘moving module’ or ‘non-stationary module’. These names can be brought for the discs and ring also. It is also noted that movable module/disc moves passively, while the polarizer elements are actively moved. It can also be said that both are displaced or that the movable module is moved and the polarizer element is displaced (both of them may have rotational and translational motion). In case of rotational motion, the movable disc may also be called a rotation or rotating disc.

It is noted that the various embodiments show particular optional details of the invention within the general features of the invention. The embodiments are connected to each other by the common concept of the invention given above through the features of the invention.

As given above, a movement—which is preferably a continuous translational or rotational motion—of the movable module is exclusively based on magnetic interactions. This means—as detailed for each of the embodiments—that there is no other effect on the movable module to move—in many cases on the movable disc to rotate—than the magnetic interactions. In other words, in the invention the movement of the plurality of polarizer elements is converted to the motion of the movable module based on magnetic interactions, i.e. magnetic principles.

This kind of movement establishing (generation) is detailed at the embodiments. Hereby it is summarized that in the case of the first and third embodiment the cross-direction movement of the polarizer elements leads to a rotational motion of the movable disc, and in the case of the second embodiment the rotational motion of the polarizer elements in a polarizer disc leads also to a rotational motion of the movable disc. Accordingly, in all of the cases the motion of the movable module is generated based on the motion of the polarizer element by the help of attractive effect via a polarizer element or an appropriate repulsive (pushing) effect of a permanent magnet. This can be generalized to a translational type embodiment.

From other point of view, it will be shown in connection with all of the embodiments that no other type effect acts on the movable disc to move (in the direction into where it is designed to move, i.e. to the movement direction), only the—pushing and pulling—effects having magnetic origin, i.e. originating from a magnetic interaction.

As given in the disclosure of the embodiments, the movement of the movable module is typically a continuous motion as far as the appropriate movement of the polarizer elements continues. In other words, a continuous motion of the movable module is achieved via the movement of the polarizer element, more particularly via the synchronized movement of the polarizer element in predetermined stages. The synchronization can be established by a synchronizing mechanism (optical gate or gear synchronization of the first embodiment), by incorporating the polarizer elements into a polarizer disc in the second embodiments, or the synchronized drive of the third embodiment via (elongated) control elements.

In the embodiments illustrated in the figures a continuous rotational motion is described, where the details of the establishing of this motion are shown. In order to establish the rotational motion, a shaft is needed around which the rotation is performed. However, the movable module (movable disc in this case) is not rotated by the help of the shaft, but sometimes it can freely rotate around the shaft or the shaft itself is rotated by the movable disc (this can happen in the second and third embodiments).

As a summary of the above, these is the technical basis of the term of “the movement of the movable module is exclusively based on magnetic interactions”, i.e. this is the background of term.

Preferably, each of the plurality of polarizer elements are adapted for covering a respective first permanent magnet. Furthermore, this means that when the polarizer element is arranged in front of a first permanent magnet it covers the first permanent magnet from the point of view of the movable second permanent magnet which passes in front of it.

Moreover, there are details elsewhere that the first permanent magnet is typically arranged in an indentation which one of its poles facing outside—this is the free (working) surface. In other words, the polarizer element is adapted for covering the free surface of the first permanent magnet (this is in line with the above, since this is the part which can be “seen” from the point of view of the passing movable permanent magnet). The polarizer elements have all typically the same shape, like typically the magnets to be covered (as well as the movable permanent magnets).

The coverage is thus somehow means that the first permanent magnet is separated—for the time while it is located in front of the first permanent magnet—by the polarizer element.

Furthermore, as shown by the figures, the polarizer element is preferably implemented as a polarizer sheet having uniform thickness (having a—mainly —rectangular shape in the first and third embodiments and an arcuate shape in the second embodiment; the thickness specified in some cases can be considered to be uniform; the thickness can also be uniform even in the case of a curved polarizer element).

In the realization apparatus according to the invention, tolerances can be applied. It is relevant to avoid collisions, i.e. gaps are to be applied in some cases. Another tolerance aspect is that from the point of view of the magnetic interaction little distances compared to the relevant components (in particular, permanent magnets, polarizer elements) does not have a relevant influence on the effects, i.e. sometimes, for example, in the coverings, fully insertions, fully removals, tolerances can be applied.

The tolerance—when interpreted to a size, e.g. how much a polarizer element is inserted—can be ±2 mm, preferably ±1 mm, particularly preferably ±0.5 mm. This tolerance can be applied in the size of sides of the polarizer (not in the thickness of it). This can be a tolerance of maximum±5% in the size of the side (in case there is—enough—space to apply the tolerance). The tolerance may be applied sometimes to avoid collisions.

A surface approach can be also applied to the tolerance. In this case it can be required for a coverage that at least 90% of the surface to be covered is covered (e.g. the coverage of the free surface by the polarizer element), more preferably at least 95% of the surface is covered, and particularly preferably at least 98% of the surface is covered.

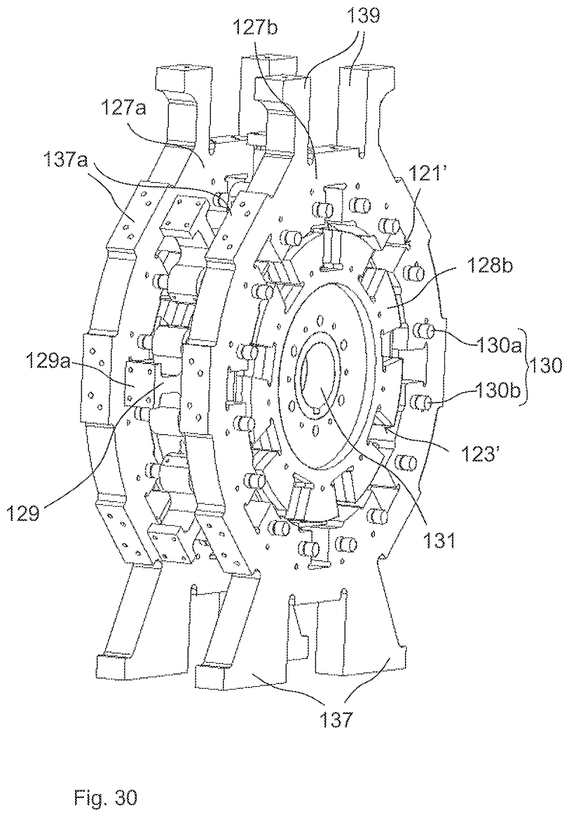

In an embodiment the movable module is implemented by a movable disc (this is shown in FIGS. 11B, 21, 23, 31, 32; in other words, in these embodiments the movable module is a movable disc) arranged rotatable with respect to the stationary module and the plurality of second permanent magnets are arranged at a first periphery of the movable disc. As it will be shown later, the first periphery can be the outer periphery of the disc, when the magnetic poles of the movable permanent magnets are arranged on the edge of the movable disc (see e.g. the embodiments of FIG. 8 and FIG. 30). Furthermore, the first periphery can be an inside periphery of the movable disc, it this case the magnetic poles of the movable permanent magnets are arranged on the base plate of the movable disc (see e.g. FIG. 23). The relevant magnetic pole—with which another magnetic pole will have an interaction during the operation—is always on the surface.

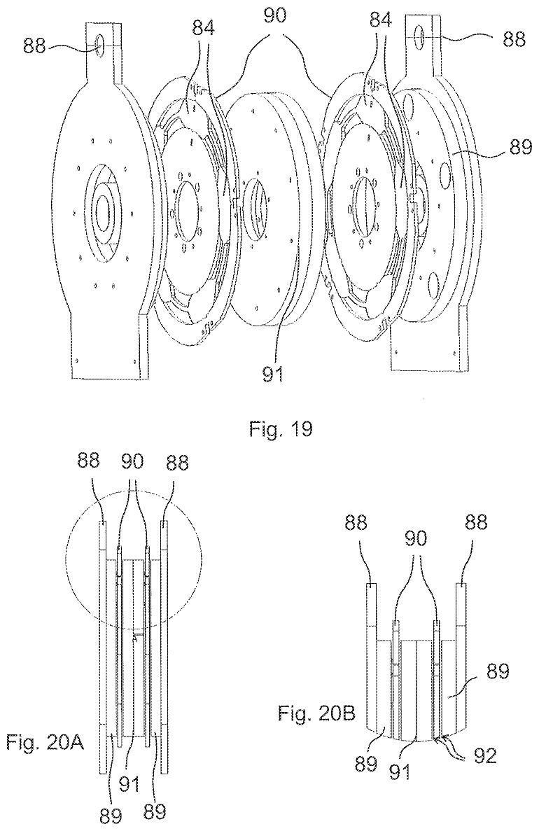

It is a typical function of the movable module that the movement given to it will be utilized. In the above introduced embodiment rotation is given as a movement to the movable disc, i.e. the output can be yielded from a rotating component. As it will be seen below, the rotating movable disc can be encompassed by a stationary ring (in other words, ring element) as a stationary module (see e.g. FIG. 8 and FIG. 30), i.e. the movable module will rotate within it, or, in another embodiment the stationary module can be a stationary disc (in other words, disc element) with a shape similar to the movable disc (see e.g. FIG. 19). However, independent of the realization of the stationary module, the operation of the inventive apparatus will result in the rotation of the movable disc.

Not only rotational but also linear motion (generally, translational motion with arbitrary path) can be established in an apparatus based on the principles of the inventions. Generally, the movable module is moved. In the embodiments where the movable module is implemented by a movable disc, the apparatus is adapted (suitable) for rotating the movable module (see below for the details). By specifying rotation, the manner of movement is specified, since “rotation” is a specific form of movement.

According to the above introduction, the apparatus according to the invention comprises general stationary and movable modules (as it will be detailed below, the various discs and rings also can be considered as modules in a general level, i.e. a module can have various configuration; the stationary and movable modules may be called also stationary and movable units, or stationary and movable blocks, or stationary and movable parts of the apparatus, respectively; the modules are (holding) structures or assemblies in which magnets are arranged and to which other components can be connected) and these are provided with stationary and movable permanent magnets, respectively. Moreover, according to the general principle, a polarizer element is arranged or assignable for each of the stationary permanent magnets.

Based on this scenario, such a translational or in particular linear motion and an apparatus using this type of motion is achievable, where the stationary module is a base like module, where the stationary permanent magnets are arranged on a surface facing e.g. to above. The movable module will have a path for motion above the stationary permanent magnets (e.g. it is confined in its movement in directions other than the predefined path) and the movable module can be started to move by the help of a movement of the polarizer elements and its motion can be maintained by the help of a predetermined controlled motion of the polarizer elements, i.e. by the help of controlled polarisation of the respective stationary permanent magnets.

Such a movement of a movable module can be a part of the operation of an apparatus just like in other embodiments where the motion of the movable module (or, in particular, movable disc) can be achieved via the—controlled and predetermined—moving operations of the polarizer elements. In other words, those parts which are defined as parts of the invention will be considered as part of the inventive apparatus even if the modules are realized with huge sizes and the motion is especially large-scaled.

In the course of the development process, we have built and tested several experimental arrangements. The description of three of these experimental arrangements (configurations) as embodiments of the apparatus according to the invention is included below.

Firstly, a first example is disclosed herebelow, which can also be considered as an experimental arrangement no. 1. With appropriate generalizations, the present example can be considered as a specific example of an embodiment (first embodiment as cited in the brief description of drawings): in the disclosure below generalization possibilities will be given as well as these are straightforward in many cases (in connection with the present example, as well as the other detailed examples afterwards). All of the experiments were performed at room temperature, i.e. approx. 25° C.

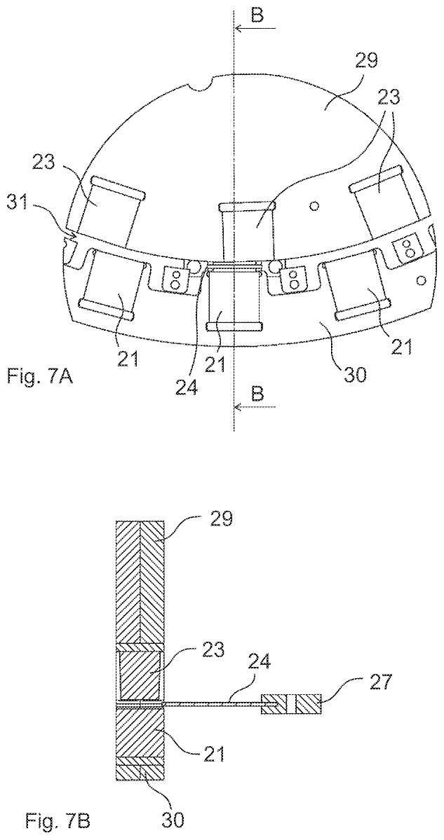

For experimental application of magnetic polarizer, in the present example, an apparatus that has circular arrangement and has two major components: an internal rotating (rotor) disc and a stationary ring (outer ring, stator). According to the experimental arrangement, 18 and 24 neodymium magnets are mounted in the rotation disc and the stationary ring, respectively. The magnets are mounted in a radial direction of the circle, at an equal distance from each other both in the inner disc and in the outer ring. In the example, the inner movable (rotatable, rotation, rotor) disc and the stationary ring are assembled with a 6 mm air gap. The magnetic polarizer is inserted into this air gap (for an air gap 31, see FIG. 7A).

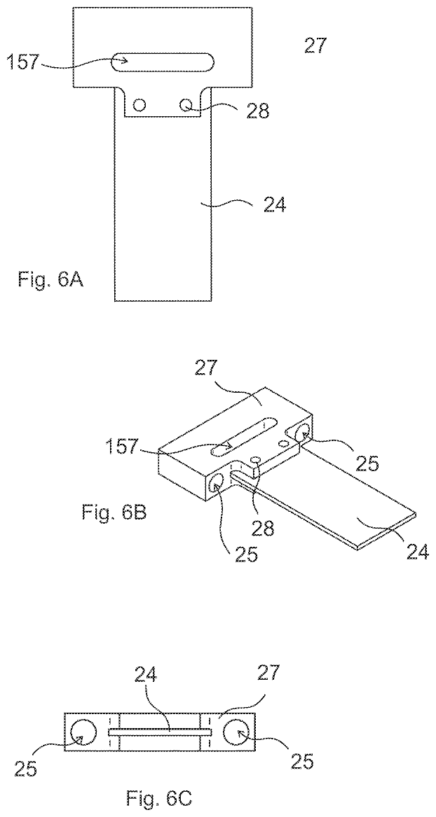

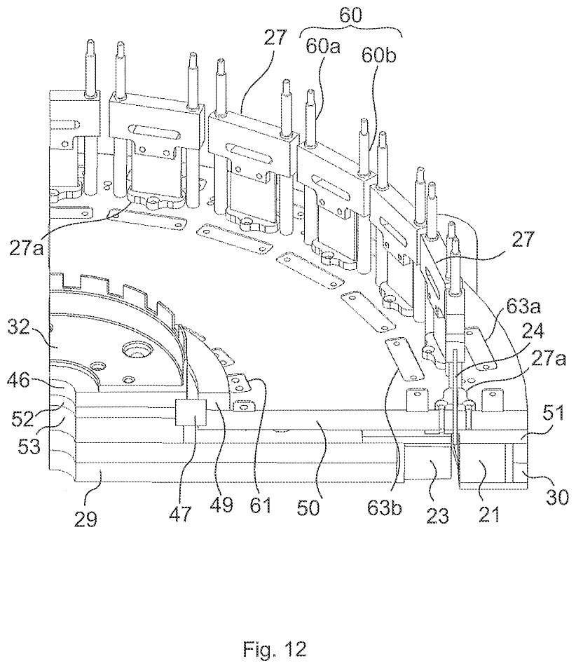

The magnetic polarizer element applied in the present embodiment is illustrated in FIGS. 6A-6C (top, spatial and front views). In these figures it is observable that a polarizer element 24 (magnetic polarizer) is held in a guiding element 27 (non-magnetizable mounting metal bed; the polarizer element 24 is fixed to it), into which it is mounted by the help of two mounting bolts 28 (in FIG. 7A only polarizer element 24 is observable from this unit, the unit itself is observable in FIG. 12). The guiding element 27 is also adapted for grabbing the polarizer element 24.

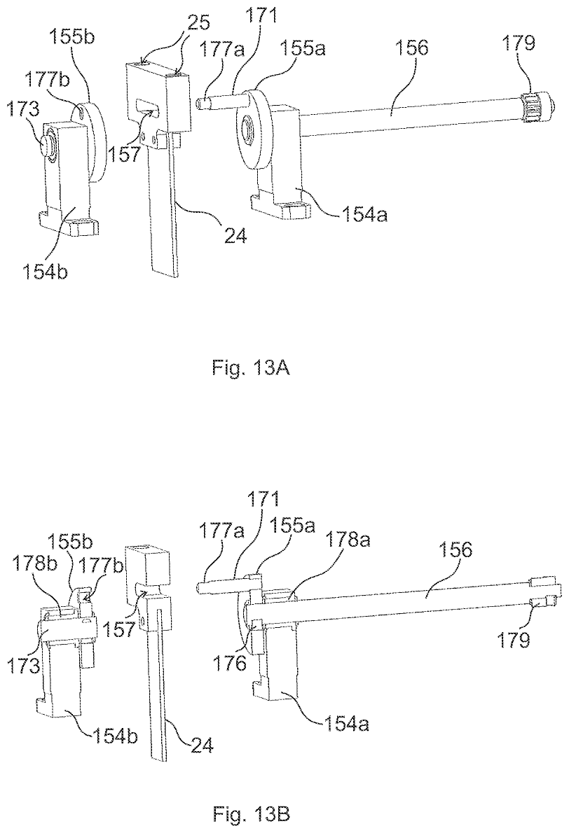

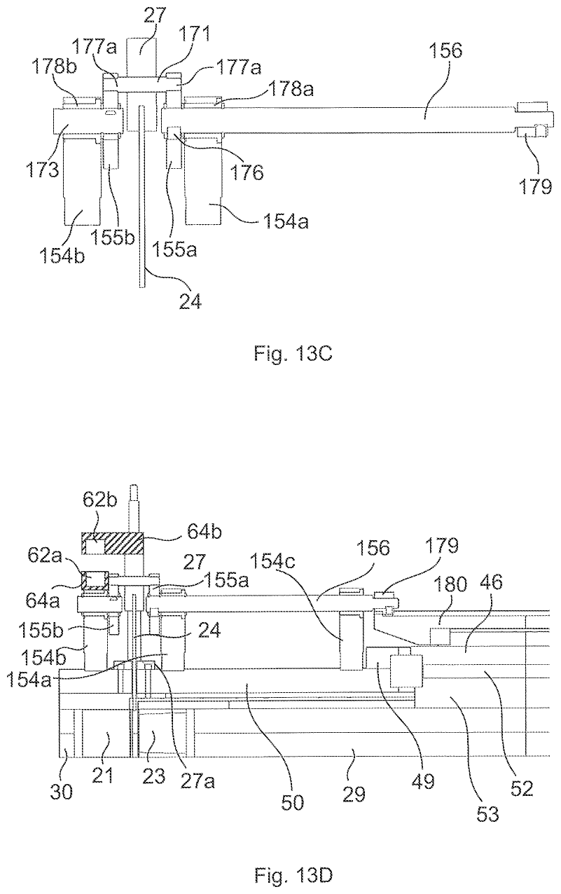

In FIGS. 6B and 6C also through holes 25 are shown which are adapted for receiving guiding shafts (i.e. the guiding element 27 connected to the polarizer element 24 can be moved along shafts by the help of these holes 25, see FIGS. 11A-11B and 12). See also a driving opening 157 in FIGS. 6A-6B, the role of which is disclosed in connection with FIGS. 13A-13D.

Thus, in this embodiment, each of the polarizer elements 24 are fixed to a respective guiding element 27 movable (displaceable) along a respective guiding shaft arrangement 60 adapted for moving the respective polarizer element 24 to the working position and out of the working position (preferably, between the working position and the resting position).

The proportion of the number of magnets arranged on the movable disc and on the stationary ring applied in the experimental arrangement affects the power (torque) output and balanced running of the apparatus, and also the extent of polarization losses.

The power which can be generated by the simultaneously working magnets that are applied in the experimental arrangements and are arranged in the movable disc is summed up, and thus determines the maximum power (output) of the experimental arrangement. By increasing or reducing the number of the simultaneously working magnets, the power of the given apparatus (i.e. of an apparatus built for an experiment: this is an exemplary apparatus) can be increased or reduced. These simultaneously working magnets is termed a “magnet unit”. In FIG. 8, a working phase in a time instant is illustrated. It is clear from FIG. 8—as well as from the applied proportions of the numbers of permanent magnets in the stationary part and in the movable disc—that some of permanent magnets 23 will be in the same phase compared to permanent magnets 21, these simultaneously working permanent magnets 36 of the movable disc 29 are denoted (these are the magnets of a magnet unit; see below the disclosure of FIG. 8 in details). In FIG. 8 a single polarizer element 24 is illustrated: this is for illustration only, polarizer elements 24 are arranged also for the other stationary permanent magnets 21, also. In FIG. 8 also air gap 31 is illustrated between a stationary permanent magnet 21 and a movable permanent magnet 23. The polarizer element can be inserted into to this (air) gap 31.

To summarize, the movable permanent magnets being in the same position are always in the same phase compared to stationary permanent magnets and these can be handled together as magnet units (in other words: arrangement of same phase magnets). The common phase can be polarized, repulsive, working or neutral phase (in the latter case, the movable permanent magnet in question is far from the other permanent magnets, if this is the case for a movable permanent magnet, the movement is based on other movable permanent magnet-stationary permanent magnet pair(s)).

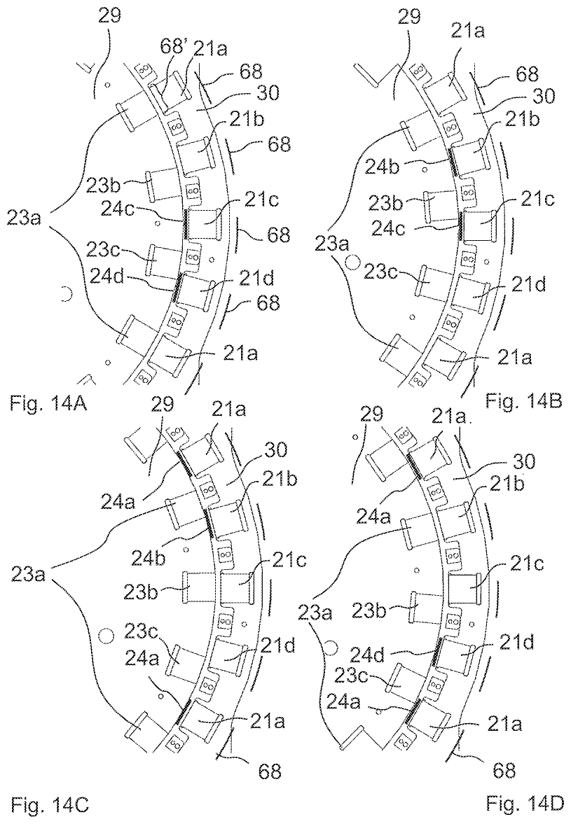

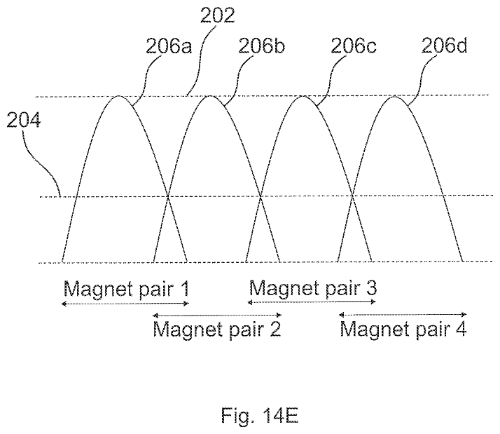

In order to achieve a constant, evenly produced torque, multiple magnet units need to be arranged in the movable disc. By applying two or more magnet units, an overlap between successive work stages can be brought about, and thus power output is constant and has a balanced level. By increasing the number of magnet units, the degree of overlap between the work stages also increases, so the utilizable power of the experimental arrangement will also be higher (see also FIG. 14E).

The number of magnets arranged on the stationary ring is defined as the product of the number of envisaged work stages and the number of magnets in the magnet unit on the movable disc. In the experimental arrangement the number of work stages is four. Accordingly, the number of magnets arranged on the stationary ring of the experimental arrangement is obtained as the product of the envisaged stages and the number of the magnet unit magnets:

4(stages)*6(working magnets)=24

The number of magnets arranged in the stationary ring is 24.

All magnets arranged on the stationary ring is to be equipped with a polarizer. The number of the polarizers affects the amount energy required for operating the system (apparatus), and also the rotational speed (number of rotations) of the experimental arrangement. By adjusting the ratio of the magnets, the amount of the necessary frequency (frequency of moving the polarizers), the magnitude of the torque, and the energy necessary for operating the apparatus can be increased or reduced.

Based on the ratio of the number of magnets arranged on the inner movable disc and on the outer stationary ring, the following magnetic drive was built:
Applied magnet: 30 mmø, length: 30 mm, N48, neodymium;
Inner movable disc: 3 simultaneously working magnet units, each consisting of 6 magnets (see FIG. 8: every third magnet in the movable disc is in the same phase compared to the stationary ring);
Outer stationary ring: 6 magnet units performing 4 strokes and 24 magnetic polarizers preferably with a thickness of 2 mm (see FIG. 8: every fourth magnet in the stationary ring is in the same phase compared to the movable disc).

Hereby the data are summarized in an example. Several other sizes can be derived from the—non-schematic—figures on which the different components are proportionally scaled with each other. The outer diameter of the inner rotating disc is 516.7 mm. The inner diameter of the outer ring is 527.8 mm (for the inside facing end of the permanent magnets). The sizes of the polariser 72×33×2 mm. The polariser is moved by pneumatic cylinders by 11.2 Hz in the example. The type and sizes of the magnets placed into the stationary and movable disc are: N48 30 (diameter)×30 (length) mm. The degree of the highest magnetic peak pushing force measured on a magnet pair (on an R=258.35 mm arc) during the experiments is 3.609 kg*f. This value expressed in torque measured on the shaft is 9.15 Nm.

The ratios of magnets arranged in the inner movable disc and in the outer stationary ring were both determined such that the number of magnets that perform work uniformly, at the same time is six. These are called magnet units performing the work and the stages. The energy of the magnets disposed in the magnet unit is combined, so the torque [unit: Nm] of the arrangement can be determined based on the repulsive force (utilizing a dimension: kg*f/m—kilogram-force/meter) arising during the operation of the arrangement.

The operating frequency of the polarizer elements determines the rotational speed of the apparatus, namely its movable module (the movable module moves as a consequence of the movement of the polarizer elements, so the pace of the movement of the polarizer elements has direct consequence on the operation of the overall apparatus). The power of the apparatus depends on the effected torque and the rotational speed at a time instance. Consequently, at a constant torque, the power can be increased by increasing the rotational speed.

The torque can be measured in an experiment, many different components can have a role in the rotation, namely repulsion of a same-pole permanent magnet (these are the so-called working magnets, i.e. magnets performing work, when a stationary permanent magnet pushes a movable permanent magnet), pulling of a polarizer element but losses also occur. Accordingly, the final torque can be increased if the number of magnets working simultaneously is increased.

As touched upon above, a first embodiment is illustrated in FIGS. 7A-8. FIG. 7A shows a detail of FIG. 8, that part (encircled part at the bottom of FIG. 8) where the polarizer element 24 is visible (see also FIGS. 6A-6C). In FIG. 7A, it is clearly visible that the distance between two neighboring movable permanent magnet 23 is larger than the distance between stationary neighboring permanent magnets 21 (thus, the permanent magnets at the centre of FIG. 7A are closer to each other than those at the left of FIG. 8).

FIG. 7B shows a B-B section, the section line of which is denoted in FIG. 7A. This section line intersects permanent magnets 21 and 23, and the polarizer element 24 held by the guiding element 27 (FIG. 7B shows a position where the polarizer element 24 is not inserted between permanent magnets 21 and 23; however, polarizer element 24 is similarly observable both when inserted and when not inserted between the permanent magnets 21 and 23). FIG. 7B also illustrates how permanent magnets 21 and 23 are incorporated into (fixed to) the movable disc 29 and stationary ring 30, respectively.

FIG. 8 shows the whole movable disc 29 arranged within the stationary ring 30 from above. In these, permanent magnets are arranged on their outer and inner periphery, respectively.

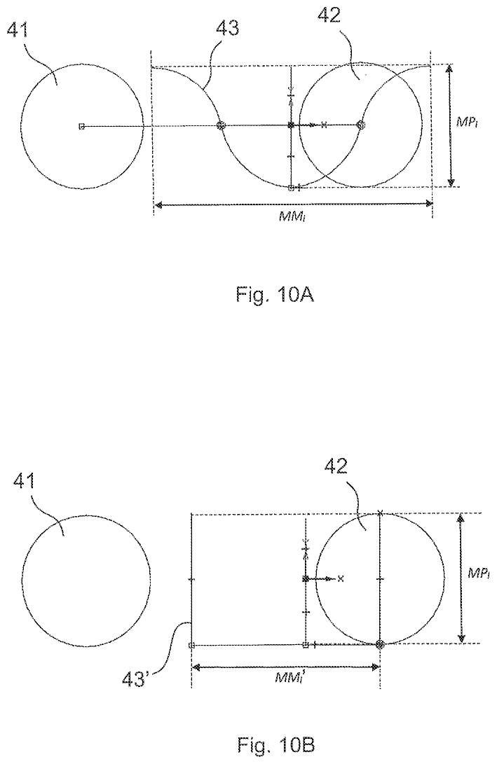

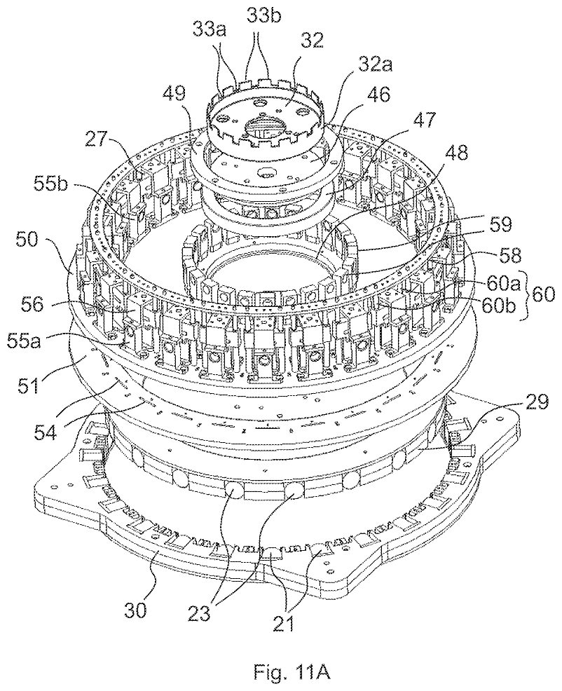

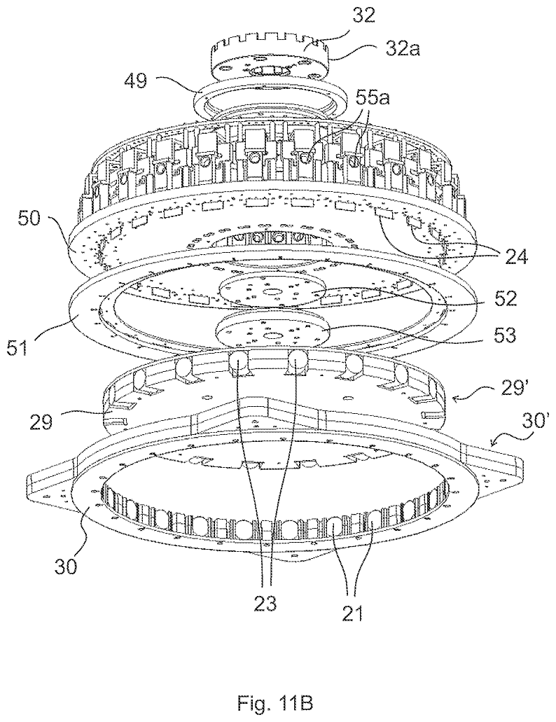

By the help of the apparatus a four-stage arrangement was provided that has three working units and is adapted for rotational motion. The four stages have the following stages (the stages can be interpreted based on the schematic drawing of FIG. 3, but similarly, FIG. 8 can also be interpreted on similar bases):
1. Repulsion—The 3rd magnet (permanent magnet 13) passes in front of the 1st magnet (permanent magnet 11). At this point the longitudinal axis of the permanent magnet 13 has passed the longitudinal axis of the 1st magnet —preferably by at least 1°—in order that such repulsive force arises which pushes the movable permanent magnet from permanent magnet 11. Therefore, in this stage, the positive repulsive force arising between the two magnets acts on the movable permanent magnet 13.
2. Repulsion and attraction—The permanent magnet 13 is e.g. at ¼ of the working path between the 1st and the 2nd magnets (i.e. between permanent magnets 11 and 12, see e.g. FIGS. 10A-10B, as well as FIGS. 14A-14D for possibilities). The magnetic polarizer element 14 is —approximately at this point—inserted in front of the permanent magnet 12. In this stage, the dominant force is the repulsive force arising from the direction of the permanent magnet 11; however, the attractive force arising from the direction of the magnetic polarizer element 14 inserted in front of the permanent magnet 12 is also effective (permanent magnet 13 is closer to permanent magnet 11 than to permanent magnet 12).
3. Attraction and repulsion—The permanent magnet 13 is e.g. at ½ and ¾ of the working path between the permanent magnets 11 and 12. In this stage, the dominant force is the attractive force arising from the direction of the magnetic polarizer element 14 inserted in front of the permanent magnet 12, although the repulsive force arising from the direction of the permanent magnet 11 is still effective.
4. Attraction—The permanent magnet 13 passes in front of the permanent magnet 12. In this stage, only an attractive force arising from the direction of the magnetic polarizer element 14 acts on the permanent magnet 13, until the longitudinal axis of the permanent magnet 13 passes the longitudinal axis of the permanent magnet 12, preferably by 1°. At this point the magnetic polarizer element 14 is lifted out (removed), thus eliminating the attractive force arising due to magnetic polarization. Thereafter, the repulsive force arising between the permanent magnets 12 and 13 prevails.

In the embodiment illustrated in FIG. 8 (and on other figures)
the stationary module 30′ is implemented by a stationary ring 30 (as illustrated in FIG. 11B) arranged around the movable disc 29,
the plurality of first permanent magnets 21 are arranged on an inner periphery of the stationary ring 30 (these will be in the inner side of the ring, i.e. these will face inside; as shown enlarged in FIG. 7A, the indentations for stationary permanent magnets are formed within a part projecting from the inner periphery of the stationary ring 30), and the plurality of second permanent magnets 23 are arranged at the first periphery of the movable disc 29 being the outer periphery thereof (in accordance with the fact that the stationary permanent magnets are arranged on the inner side of the ring, the movable permanent magnets are arranged on the edge of the movable disc; so that a magnetic pole of the plurality of second permanent magnets 23 are arranged on the outer periphery of the movable disc 29), and
a polarizer element 24 corresponds to each of the first permanent magnets 21 (accordingly, in this case there is a corresponding polarizer element for each of the permanent magnet—it is arranged there—so the polarizer elements have the same number as the first permanent magnet) and each of the plurality of polarizer elements 24 is moveable (displaceable) to a working position, wherein a respective polarizer element 24 is arranged at the inner periphery of the stationary ring 30 in front of a first permanent magnet 21 corresponding to the respective polarizer element 24.

The polarizer elements 24 are preferably movable between the working position and a resting (out-of-working) position, wherein the respective polarizer element 24 is removed (pulled away) from in front of the first permanent magnet 21 (in other words: when it is removed from the working position, i.e. the resting position can be a position when the polarizer element is removed from the working position).

Preferably, in the working position the polarizer element 24 is fully inserted to be in front of the magnet, and it is fully removed when it is in the resting position. Preferably, the polarizer element 24 is “overpulled” to a final resting position by the 8-10% of the respective length of the polarizer (this is the direction of the movement), e.g. 2-3 mm in an example (this can be also applied in the third embodiment below, where the final resting position is preferably the working position from the view of the other stationary ring).

In the present embodiment, furthermore, the first permanent magnets 21 are arranged equidistantly on the inner periphery of the stationary ring 30 and the second permanent magnets 23 are arranged equidistantly on the outer periphery of the movable disc 29 (according to the requirement that same magnetic poles of a first permanent magnet and a second permanent magnets are directed to each other, the arrangement principles of the magnetic poles are defined here).

Furthermore, preferably, a first magnet number of the plurality of first permanent magnets 21 of the stationary ring 30 is different from a second magnet number of the plurality of second permanent magnets 23 of the movable disc 29 (the first magnet number and the second magnet number are the total number of the first permanent magnets 21 of the stationary ring 30 and of the second permanent magnets 23 of the movable disc 29).

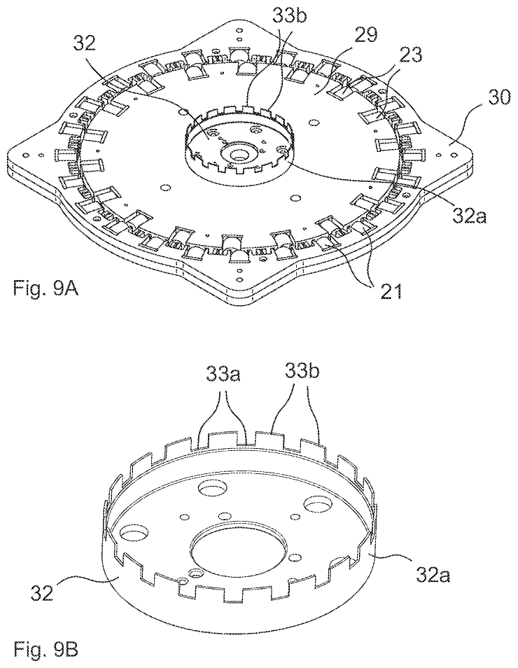

Compared to FIG. 8, in FIGS. 9A-9B further details of the presently disclosed embodiment are observable. In FIG. 9A the arrangement of the movable disc 29 and the stationary ring 30 is shown in a spatial view, in which the manner of arrangement of the cylindrical permanent magnets 21 and 23 is clearly visible. As a further detail, a circular control element 32 is affixed to the movable disc 29; the circular control element 32 is shown in FIG. 9B in an enlarged view. The circular control element 32 has a disc-like base (bottom side) and a cylindrical side wall 32a which has blocking portions 33b on its upper end. Transparent portions 33a are formed between the blocking portions 33b (i.e. transparent portions 33a are cut out from the cylindrical side wall 32a). The blocking portions 33b are formed in the same number as the permanent magnets 23 in the movable disc.

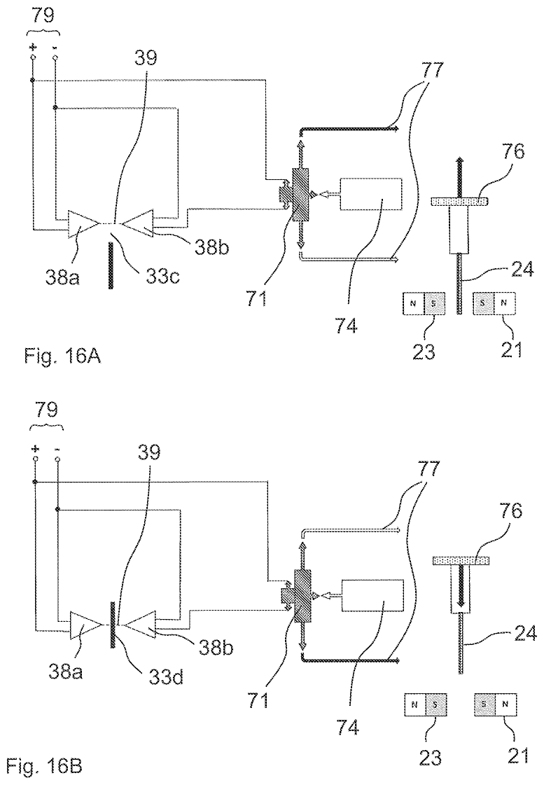

In this embodiment, therefore, a circular control element 32 (it may also be called simply as a circular control element or (opto or optical gate) control disc, however, the word ‘circular’ has been inserted to its name for showing that it has a circle base—may be called circle-based control element—in accordance with that it has a cylindrical side wall) is fixed to the movable disc 29, wherein
the circular control element 32 comprises a cylindrical side wall 32a having an axis coincident with an axis of rotation of the movable disc 29 and having, at a first distance (may also be called simply ‘a distance’, in case of a portion the distance is preferably measured from the centre of the portion) from the movable disc 29, a plurality of transparent portions and a plurality of blocking portions (for transparent portions 33a and blocking portions 33b, see FIG. 9B, see also FIGS. 16A-16B; these all are arranged at the same height, namely the first distance from the movable disc 29),
an optical source adapted for emitting light along a light path and an optical receiver adapted for receiving the light emitted by the optical source and arranged on the light path (see FIGS. 16A-16B for an optical source 38a, an optical receiver 38b and a light path 39) are arranged in a fixed manner with respect of the stationary ring 30 so that during a rotation of the movable disc 29 a transparent portion or a blocking portion of the cylindrical side wall 32a is in the light path (i.e., the rotational position of the circular control element is observed from a stationary point of view; according to the previous section, these are on the same height so that these can be rotated into the light path, either a transparent portion or a blocking portion),
the plurality of blocking portions of the cylindrical side wall 32a are arranged in a same blocking portion number as a first permanent magnet number of the plurality of first permanent magnets 21, a respective projected transparent arc portion (an arc 68 is shown in FIG. 14A behind the permanent magnets 21a-21d because of visibility reasons, but it can be radially projected to in front of the permanent magnets to have the respective projected transparent arc portion, where it can be compared to the respective first permanent magnet arc 68′; in short arcs 68 correspond to the transparent portions 33a of the circular control element 32) overlapping at least partially with a first permanent magnet arc 68′ (shown also in FIG. 14A; it is clear that these overlap with each other; for the value of the overlap see some details below) of the inner periphery of the stationary ring 30 corresponds to each of the plurality of first permanent magnets 21, the plurality of transparent portions and the plurality of blocking portions are arranged in the cylindrical side wall 32a so that, when during a rotation of the movable disc 29 a radial centreline of a second permanent magnet 23 is within a projected transparent arc portion, a transparent portion of the cylindrical side wall 32a is in the light path 39, and
during an operation of the apparatus, a polarizer element 24 corresponding to a respective first permanent magnet 21 is in the working position when the radial centrelines of the plurality of second permanent magnets 23 are outside a projected transparent arc portion (the investigation of this is irrespective that the illustrated arc 68 is considered or its radial projection being the projected transparent arc portion) corresponding to the respective first permanent magnet 21.

It is noted that the above embodiment can also be combined with the compensator element, since it can also help the movement of the polarizer and preferably leads to a quieter operation of the (pneumatic) drive. In this case the compensator arrangement is to be arranged in the same way as shown below in FIG. 13D.

Moving the magnetic polarizer precisely is extremely important for the operation of the arrangement. The magnetic polarizer has a polarized interaction with the magnetic field of the stationary and movable magnets, so the magnetic polarizer is subjected to a large attractive force. For moving the magnetic polarizer, a force has to be exerted against this attractive force such that the magnetic polarizer can be removed from and inserted into the magnetic field at the right moment and with the appropriate speed. The force required for moving the magnetic polarizer has to be determined. In the experimental arrangement, the magnetic polarizer was placed in the magnetic field, and the magnitude of the necessary motive force was determined applying a pull scale. According to the measurement results, the force—based on the repulsive force—is 4.83 kg*f×9.81=47.3823 N.

In light of these results, the technology applicable for moving the polarizers was determined in the course of the experiments such that a moving force of at least 50 N is provided for moving each of the magnetic polarizers of the arrangement. For the entire arrangement this amounts to a combined force of 1200 N.

The revolution ratio is determined by the 18 magnets disposed on the inner movable disc.

### Revolution Ratio: 1:18

According to the arrangement, the revolution ratio means that in a single revolution of the inner movable disc each of the 24 magnetic polarizers arranged on the stationary ring performs 18 cycles. Based on the revolution ratio, the frequency of the movement of the magnetic polarizer required for a prolonged rotational motion can also be calculated (number of cycles—cyclic movement—of the polarizer per second):

$$Magnetic polarizer {f}_{v} = \frac{\frac{revolutions}{min} \times 18}{60} = Hz$$

The physical (motion) frequency module of the magnetic polarizer can be sinusoidal and modulated (see FIGS. 10A-10B, where the variants of the movement paths of the magnetic polarizer are shown). The polarizer element can be inserted fully, as well as can be removed also even if the drawing is too schematic.

In FIG. 10A a sinusoidal movement path of the polarizer element corresponding to a stationary permanent magnet 42 is shown. Parallelly, in FIG. 10B a modulated movement path is illustrated in the same stationary permanent magnet arrangement. For the sake of illustration, two neighbouring stationary permanent magnet, namely stationary permanent magnets 41 and 42 are shown.

Firstly, the interpretation of FIG. 10A is given. In the figure, the position of the stationary permanent magnets 41 and 42 is naturally fixed. Furthermore, the path of the movable permanent magnet ordered to stationary permanent magnet 42 is illustrated also by the section MM_{I}. This is that section of the path on which the polarizer element—the trajectory of which is illustrated by a line 43—performs a full cycle. The figure can be interpreted so that the line 43 corresponds to the end point of the polarizer element: it starts from a totally removed position at the beginning of the section MM_{I}, it is in a fully inserted position in the middle of the section MM_{I}, and again fully removed at the end of the section MM_{I}. The centre of the movable permanent magnet is illustrated by the two vertical dashed lines at the beginning and the end of the section MM_{I}.

The meaning of these is detailed in the followings.

The polarizer element is started to be inserted when the centre of the movable permanent magnet reaches the beginning of the section MM_{I}. Before this point the polarizer element had the same sinusoidal path but in front of stationary permanent magnet 41. Accordingly, when the movable permanent magnet has moved between the alignment with the stationary permanent magnet 41 and the beginning of the section MM_{I}, the stationary permanent magnet has pushed it with a repulsion effect, since the polarizer element has been removed in its major part (see for more details below for the section MM_{I}).

At the first part of the section MM_{I}, until the line 43 crosses the horizontal auxiliary line interconnection, there is a pushing effect on the movable permanent magnet moving along the section MM_{I} from the stationary permanent magnet 41, and also the polarizer element starts to be inserted, but in the beginning, only slightly according to the sinusoidal curve.

It is hereby noted that the line 43 illustrates a theoretical end position of the polarizer element but only for illustration to help the interpretation the movement of the polarizer element in comparison with the movement of the movable permanent magnet. The sinusoidal line 43 is to be interpreted as how much the polarizer element is pushed in front of the stationary permanent magnet 42, i.e. it is pushed so much as the sinusoidal curve is projected onto it, so—as it is illustrated as a function of the section MM_{I}—it starts slowly, after that it accelerates and pushed fully at a point, and at the end—symmetrically to the insertion—it is removed. In other words, in FIGS. 10A-10B the position of the polarizer element is shown as a function of the position of the movable permanent magnet.

Accordingly, at the middle of the section MM_{I}, the polarizer element is fully inserted in front of the stationary permanent magnet 42 and helps the movable permanent magnet to approach the stationary permanent magnet 42 according to the pulling effect acting between the movable permanent magnet and the polarizer element. It is also illustrated that the polarizer element is started to be removed before the movable permanent magnet and the stationary permanent magnet 42 is aligned. This does not cause a problem because of more reasons. Firstly, the polarizer element will be in front of the stationary permanent magnet in its majority until the alignment, so the pulling effect will be the dominant effect between the middle of the section MM_{I} and the alignment. Secondly, other magnets will preferably also help the movement of the movable permanent magnet (cf. with FIGS. 14A-14D).

After the alignment of the movable permanent magnet and the stationary permanent magnet 42, i.e. at the end of the horizontal line interconnecting the centre of stationary permanent magnets 41 and 42. The polarizer element tends to total removal according to that part of the sinusoidal curve. In this part of the section MM_{I}, the stationary permanent magnet 42 will be able to push forward the movable permanent magnet passed in front of it. When the end of the section MM_{I} is reached, the polarizer element is becomes totally removed and the cycle with the subsequent stationary permanent magnet can continue as it started at the beginning of the section MM_{I}.

As touched upon above, in FIG. 10B a modulated movement of the polarizer element corresponding to the stationary permanent magnet 42 is illustrated (the parameters—i.e. the points where the polarizer is moved—of the modulated movement can be varied, FIGS. 14A-14D below illustrate a modulated movement with modified parameters). It can be interpreted similarly to the sinusoidal movement of FIG. 10A. The references are the same in majority, but there is a line 43′ illustrating the movement of the polarizer and the section MM_{I}′ is shorter the section MM_{I} of FIG. 10A. The sections MM_{I} and MM_{I}′ correspond to that part of the movement of the movable permanent magnet which is influenced by the polarizer element (i.e. the polarizer element is inserted at least partly). For FIG. 10A this is the full cycle, since the polarizer is fully removed only for one point according to the line 43 of the sinusoidal curve (the polarizer element is in its resting position at this point in this approach). However, for FIG. 10B a shorter part of the movement of the movable permanent magnet is influenced by the polarizer element, i.e. the section MM_{I}′ is shorter (that part of the section between the centres of the stationary permanent magnets 41 and 42 which is outside the MM_{I}′ shows the resting position of the polarizer element).

According to FIG. 10B, the movement of the polarizer element is performed according to line 43′. The line 43′ corresponds to a rectangular signal having a vertical part at the beginning of the section MM_{I}′, a horizontal part at the bottom of the stationary permanent magnets along the section MM_{I}′, and another vertical part at the end of the section MM_{I}′. Accordingly, the polarizer element is inserted fully in front of the stationary permanent magnet 42 when the movable permanent magnet reaches the beginning of the section MM_{I}′, it is maintained in its position in front of the stationary permanent magnet 42 during the movable permanent magnet moves along the section MM_{I}′, and removed from in front of the stationary permanent magnet 42 at the end of the section MM_{I}′, i.e. when the movable permanent magnet is in alignment with the stationary permanent magnet 42.

In other words, the pulling effect acting by the help of the polarizer element is “switched on” when the movable permanent magnet reaches the starting point of the section MM_{I}′ (if another movable permanent magnet does not “switch on” the polarizer element of movable permanent magnet 41, then it also pushes this movable permanent magnet). Helped by the pulling effect the movable permanent magnet reaches the alignment position with the stationary permanent magnet 42, when the polarizer element is removed from in front of the stationary permanent magnet 42, and, from this point, the stationary permanent magnet 42 pushes the movable permanent magnet. As shown in FIGS. 10A-10B the amplitude of the movement of the polarizer is the same in both cases denoted by a section MP_{I}.

The manner of moving the magnetic polarizer was tested in three modes.
1. Pneumatic—modulated
2. Electromagnetic—modulated
3. Electromechanical—sinusoidal

Due to known physical limitations (it is suitable rather for holding, fixing, not for continuous work), the possibility of applying an electromagnetic drive was discarded already in the first stage of the experiments.

The sinusoidal pathway is established in case the control is based on a gear system and the polarizer element is moved by a circular motion eccentric disc functioning on a forced path.

The advantage of this design is that the driving may be directly performed by an electric motor. Further advantage is that the rotational speed of the apparatus can be adjusted easily and stable by the rotational speed of the electric motor.

During the sinusoidal movement on the forced path the time and road length of the open (work phase) and the closed (polarized phase) phases are the same. This means that the length of the work phase cannot be changed or increased.

The modulated movement path is generated if all the polarizer elements are moved independently (e.g. by a pneumatic system; compressed air, produced e.g. by an electromotor-driven compressor, is required for the operation of this apparatus. In this case the pneumatic cylinders for moving polarizer elements are operated by an optical gate controlled by a position signal from the main shaft of the apparatus (e.g. by the help of circular control element).

The advantage of this design (first embodiment) is that the movement of polarizer element is of a high speed and a straight line. The length of position signal can be varied freely (in FIGS. 14A-14B, the length of the blocking portions and transparent portions), thus the time of the open (work phase) and the closed (polarized phase) phases may be varied, which makes it possible to increase the length of the working time.

FIGS. 11A and 11B show further details of the embodiment have illustrations starting from FIG. 6A. In these figures much more components are illustrated than in previous figures.

Starting from the bottom of FIG. 11A, the stationary ring 30 is shown with permanent magnets 21. Above this, a part of the movable disc 29 is visible with the permanent magnets 23 which are spaced from each other. It is also shown in the figures (see also FIG. 11B, where both permanent magnets 21 and 23 can be seen from this perspective) that the permanent magnets have a circular cross-section for their part facing to each other (i.e. which is on the outer periphery of the movable disc 29 and on the inner periphery of the stationary ring 30). The permanent magnets 21 and 23 thus have a cylindrical shape having one of their poles at their end visible in the figures and their other pole faces to the inner side of the place in which these are arranged (in many figures it is denoted that the permanent magnets facing each other with their south poles, but these could also be the north poles).

Above the movable disc 29 a spacer ring insert 51 is shown (see FIGS. 11A-11B), in which slots 54 are formed for passing of the polarizer elements (for the arrangement of the various discs and rings see also FIG. 12). Above the spacer ring insert 51 a main disc 50 (with other words: covering disc or holding disc) for holding parts of the control means (namely, here, means responsible for moving the polarizer elements 24). In FIG. 11B the ends of polarizer elements projecting out from the main disc 50 are visible. This position of polarizer elements 24 is the resting position of them, in this position the polarizer elements are not inserted between the permanent magnets 21 and 23, more particularly inserted in front of respective stationary permanent magnets 21. Observing FIG. 11B it can be “projected” which polarizer elements 24 and permanent magnets 21 correspond to each other.

In FIG. 11A further components can be observed which are fixed to the main disc 50. Several first holding blocks 55a and second holding blocks 55b are shown (with a hole in them). These are arranged to hold respective U-shaped holding structures 56 surrounding the guiding element 27 of the polarizer element 24 (see FIGS. 6A-6C). Also, an upper holding ring 58 is arranged which holds the upper ends of driving shafts 60a, 60b along which the guiding element 27 of the polarizer element 24 can be moved. Within the U-shaped holding structures such components are arranged by the help of which a working cylinder is able to move the polarizer element (based on the control signal received from the optical gate) via the guiding element 27, e.g. by grabbing it via the driving opening 157.

Preferably, by applying a control using optical gates the movement of the preferably pneumatically driven polarizer elements has a modular system (each is driven independently based on the control signal of an own optical gate).

In the present embodiment, a first polarizer moving arrangement (realized preferably with a working cylinder and components by the help of which a working cylinder is able to move the polarizer element; the first polarizer moving arrangement is a general, summarizing name) adapted for holding and moving independently each of the plurality of polarizer element 24, being controllable by means of a control signal generated by the optical receiver (e.g. optical receiver 38b, see above) adapted based on a receipt of the light emitted by the optical source (e.g. optical source 38a, see above; i.e. whether the emitted light is received or not).

In the inner part of the main disc 50 also third holding blocks 59 are shown; these are arranged around a circle shaped hole. These third holding blocks 59 have similar configuration as the first and second holding blocks 55a, 55b (with a hole in them) and these are for holding the arrangement of optical source and receiver (the optical source and receiver can be positioned so that the blocking portions 33b and the transparent portions 33a of the circular control element 32 fall into the light path between them; it can be freely decided which of the optical source and receiver is arranged on which side of the blocking portions 33b and transparent portions 33a, i.e. in and out of the inner space of the circular control element 32, but it is preferred that all of the optical source and receivers are arranged on the same side).

At the periphery of the circle shaped hole in the main disc 50 bearing housing 48 is formed into which a bearing 47 can be taken and pushed down (fixed) by the help of a bearing pressing-down ring 49 and an inner-upper fixing insert 46 for the bearing 47. The circular control element 32 is fixed to the fixing insert 46. Further details of this configuration are observable in FIG. 11B in which a bearing fixing insert 52 and an inner-down fixing insert 53 for the bearing 47 are also shown (for the components introduced in this section see also FIG. 12, where the arrangement of them is also illustrated).

This configuration is formed in order to facilitate that the optical source and the optical receiver do not rotates together with the movable disc 29 to which the circular control element 32 is fixed (the circular control element 32 is fixed to the movable disc via the inner-upper fixing insert 46, the fixing insert 52 and inner-down fixing insert 53; see FIG. 12 in which all of these components are observable, movable disc 29 is illustrated also in FIGS. 11A-11B as having two layers fixed to each other, of course). This fixing arrangement between the circular control element 32 and the movable disc 29 is connected to the main disc 50 via a bearing 47 (see above) so it can freely rotate with respect to the main disc 50, as well as the third holding blocks 59 fixed to the main disc 50.

In FIG. 11B it is indicated that the movable disc 29 is an implementation of a movable module 29′, as well as that the stationary ring 30 is an implementation of a stationary module 30′ (i.e. these are specific implementations of the general modules).

FIGS. 11C and 11D show the assembled apparatus in a spatial view and a bottom view. In the bottom view the movable disc 29 is not visible, since a cover is arranged at the bottom of the apparatus; wherein on the inner side of the cover a central shaft can be provided onto which the movable disc 29 is connected in a rotatable manner, i.e. which allows the movable disc 29 to rotate vis-A-vis the stationary disc 30.

In FIG. 12 a section of the assembled apparatus is shown (corresponding to a quarter of it). The section is made perpendicularly to the various discs and inserts (thus to the main disc 50 and the base of the circular control element 32). FIG. 12 does not show all the components, first, second and third holding blocks 55a, 55b and 59 has been removed from their first, second and third indentations 63a, 63b and 61, which, otherwise, clearly show the positions of the holding blocks 55a, 55b and 59.

On the left part of FIG. 12, the circular control element 32 is shown. Under and near the circular control element 32, the parts responsible for holding the bearing 47 are shown. It can be seen that the main disc has a groove at its left (inner) side (it is the bearing housing 48 shown in FIG. 11A) which holds the bearing 47 from below and it is observable also that the bearing pressing-down ring 49 borders the bearing from above. Between the circular control element 32 and the movable disc 29 the inner-upper fixing insert 46, the fixing insert 52 and inner-down fixing insert 53 are arranged (these all are fixed to each other, e.g. by means of screws), these have an edge configuration fitting to the bearing 47. It is also observable in FIG. 12 that there is a gap (spacing) under the main disc 50, above movable disc 29, and the circular control element is also gapped from the bearing pressing-down ring 49. Accordingly, the circular control element 32 can rotate together with the movable disc 29 and these can rotate independently from the main disc 50.

At the right side of FIG. 12, the arrangement of the polarizer element 24 is shown. It is clearly visible that the polarizer element 24 lead through the main disc 50 can be inserted—when the guiding element 27 is pushed down along a pair of the driving shafts 60a, 60b composing together a driving shaft arrangement 60 (see also in FIG. 11A, where the driving shaft arrangements 60 are illustrated in their assembled state)—between the permanent magnet 23 of the movable disc 29 and the permanent magnet 21 of the stationary ring 30, which is the working position of the polarizer element 24 (as well as it is the resting position of the polarizer element 24 which is shown in FIG. 12). The insertion is facilitated by the help of guiding slot elements 27a arranged for each polarizer element 24.

As illustrated in FIG. 12 by the help of the first and second indentations 63a, 63b, a plurality of polarizer element moving means is arranged on the main disc 50 (one for each permanent magnet 21).

In FIGS. 13A-13D a special part of a further embodiment is illustrated. Since this embodiment is related to the previous one (a detail of which is illustrated in FIG. 12; it will be noticed comparing FIG. 12 and FIG. 13D that these have similar origin), those details are illustrated in which the present embodiment is different from the previous one.

In FIG. 13A also the polarizer element 24 fixed to the guiding element 27 is shown which illustrates the connection to the previous embodiment.

In FIG. 13A a first supporting element 154a and a second supporting element 154b are shown. A driving shaft 156 extends through the first supporting element 154a such a way that it can rotate in the first supporting element 154a. To the end of the driving shaft 156 which extends through the first supporting element 154a a first eccentric (excenter) disc 155a is mounted (in a way that it cannot rotate with respect to the driving shaft 156). An eccentric pin 171 projects from the first eccentric disc 155a at a third radius (the third radius is finite, almost equal to the radius of the radius of the eccentric disc 155a). Onto the opposite end of the driving shaft 156 a first driving gear 179 is mounted (also in a non-rotating manner with respect to the driving shaft 156).

On the left side of FIG. 13A the second supporting element 154b is shown provided with a second eccentric disc 155b connected to the second supporting element 154b via an auxiliary shaft 173 so that the second eccentric disc 155b can rotate in the second supporting element 154b but cannot rotate about the auxiliary shaft 173.

It is clear from FIG. 13A that the eccentric pin 171 can be passed through an elongated driving opening 157 of the guiding element 27 of the polarizer element and an end 177a (which is a free end in the illustration of FIG. 13A) of the eccentric pin 171 can be inserted to a hole 177b in the second eccentric disc 155b and thus it can drive the second eccentric disc 155c.

The arrangement also shown in FIG. 13A is illustrated in a sectional-spatial view in FIG. 13B. The section cuts every component shown n FIG. 13A into half, i.e. it goes along a symmetry line of the arrangement of FIG. 13A. According to the view FIG. 13B, a first bearing 178a arranged around the driving shaft 156 in the first support element, as well as a second bearing 178b arranged around the auxiliary shaft 173 are also observable. The bearings 178a, 178b make it possible that the driving shaft 156 can rotate in the first support element 154a and that the auxiliary shaft 153 can rotate in the second support element 154b (can be considered to be a bearing housing). It is also illustrated in FIG. 13B that the first eccentric disc 155a is connected to the driving shaft 156 in non-rotating manner by the help of a stud 176. Furthermore, that the second eccentric disc 155b is also fixed in a non-rotating manner to the auxiliary shaft 173, as well as the first driving gear 179 to a slimmer part of the driving shaft 156.

In FIG. 13C the arrangement of FIGS. 13A-13B are shown in a sectional view. Based on FIG. 13B, all components can be identified and yet further can be observed. In this section, furthermore, the arrangement is shown in its assembled state, i.e. the driving pin 171 is passed through the guiding element 27 and connected to both eccentric discs 155a, 155b.

In FIG. 13D, the arrangement illustrated in FIGS. 13A-13C is mounted on disc arrangement also being the part of the previous embodiment. Accordingly, on the basis of FIG. 13C, many components observable in FIG. 13D can be identified. Furthermore, parts of a compensator arrangement are connected to the arrangement of FIGS. 13A-13C.

Comparing FIG. 13D to FIG. 12, it can be identified that in the base part and in the centre part (shown in the right side of FIG. 13D):
the arrangement of FIGS. 13A-13C is mounted on a main disc 50 and the polarizer element 24 can be led into between the permanent magnets 21, 23 similarly as in FIG. 12, so the base part is the same as in FIG. 12;
in the centre part, not the circular control element 32, but a central gear disc 180 is arranged on the top of the inner-upper fixing insert 46 via a bearing ring 181 encircling a spacer disc 183. By the help of the bearing ring 181 it is provided that the central gear disc 180 rotates independently from the movable disc 29 to which the elements until the spacer disc 183 are connected (it is observable in FIG. 13D that the central gear disc does not sit on the inner-upper fixing insert 46 and there is also a gap between the top of the spacer disc 183 and the central gear disc 180). Thus, the central gear disc 180 holds the bearing ring 181 in its place which makes possible the independent rotation (the movable disc 29 will be driven exclusively based on magnetic interactions by the polarizer elements 24 moved according to appropriate stages).

In summary, in this case the polarizer elements have a direct drive and operate in a forced path. The movement of the polarizer elements is preferably sinusoidal (see above). In this configuration all of the polarizer elements are considered to be in connection with each other via a mechanical drive system the main components of which are the central gear disc and the driving shafts 156 connected to it for each polarizer element. The mechanical drive system and, thus, the polarizer elements are preferably driven by an (electrical) auxiliary motor.

The central gear disc 180 is a disc-like part having gear teeth at its upper edge connected to the first driving gear 179 in FIG. 13D (for the other polarizer elements 24, further driving gears are arranged on the central gear disc around its upper periphery). Accordingly, the first driving gear 179 is driven by the central gear disc 180 as a consequence of which the driving shaft 156 will rotate about its longitudinal axis (driven through a third support element 154c).

A control system connects all the polarizer elements 24 (arranged at a radius of the main disc 50) via the central gear disc 180 and respective driving shafts 156. The driving shaft 156 will drive the first eccentric disc 155a, which will—by means of the eccentric pin (eccentric shaft) 171—move the guiding element 27 as well as the polarizer element 24 connected to it in a straight forced path since the polarizer element 24 is passed through the guiding slot element 27a having a slot for the polarizer element 24 in which it cannot be moved in another directions (this is supported also by the fact that the guiding element 27 is moved along the driving shafts 60a, 60b) and as a result of the rotation of the eccentric discs 155a, 155b the eccentric pin 171 will go up and down while it is moving in the elongated driving opening 157. The guiding element 27 cannot move in other directions only up and down because the polarizer element 24 is guided through the slot of the guiding slot element 27a.

As shown in FIG. 13D a compensator arrangement is applicable also in this embodiment (see also in other embodiments below). In the arrangement illustrated in FIG. 13D a separate compensator arrangement is preferably applied for each polarizer unit (i.e. to the polarizer element 24 fixed to the guiding element 27). The polarizer elements are preferably controlled by the help of an electro-mechanical control system. The control system—connecting all the polarizer elements 24 as mentioned above—controls the (experimental) apparatus by a sinusoidal control (fitted preferably to the stages of the rotation of the movable disc 29 illustrated in FIGS. 14A-14D, see below).

The compensator arrangement has two main parts:
a first compensator magnet 62a arranged in a stationary compensator arrangement part 64a mounted on the second support element 154b of the second eccentric disc 155b (being stationary with respect to the stationary ring, of course), and
a second compensator magnet 62b arranged in a movable compensator arrangement part 64a (can be also called a magnet holder block) mounted to the guiding element 27 of the polarizer element 24 such that—as illustrated in FIG. 13D—the second compensator magnet 62b faces to the first compensator magnet 62a with their same magnetic poles (the same poles facing to each other).

This way one of the compensator magnets (namely, the movable compensator magnet 62a) moves together with the polarizer element 24, and, as a consequence of the repulsive interaction between the compensator magnets 62a, 62b the compensating counter force effect.

In this embodiment the apparatus comprises—a rather general form of—a compensator arrangement having
a stationary compensator arrangement part 64a (i.e. that part of the compensator which is stationary) being stationary with respect to the stationary ring 30 (the stationary compensator arrangement part is fixed to the stationary ring via the second supporting element 154b) and having a first compensator magnet arrangement (in this embodiment, the first compensator magnet arrangement comprises only the first compensator magnet 62a), and
a movable compensator arrangement part 64b (i.e. that part of the compensator arrangement which is movable; the parts could be also called arrangements) being fixed to the guiding element 27 (as shown in FIG. 13D) having a second compensator magnet arrangement (in this embodiment, the second compensator magnet arrangement comprises only the second compensator magnet 62b),
   wherein magnetic poles of the first compensator magnet arrangement and the second compensator magnet arrangement are arranged to facilitate a movement of the polarizer element 24 out of the working position, preferably from the working position to the resting position (in the present embodiment, this is simply provided with that the same poles of the compensator magnets 62a, 62b face to each other).

In the following figures we get back to the first embodiment applying the optical control by the help the circular control element 32 and the manner of the rotation is disclosed herebelow.

In FIGS. 14A-14D the rotation of the movable disc 29, i.e. the movement of the permanent magnets of the movable disc 29 is illustrated. In FIGS. 14A-14D the same permanent magnets can be seen as were observable in the previous figures, however, in the present figures these are denoted with letters also to differentiate them. Accordingly, those permanent magnets are designated with the very same reference which are at the same phase compared to the other type permanent magnet. Namely, on the left side of FIG. 14A, permanent magnets 23a are the first and the last of the permanent magnets of the movable disc 29 starting from above, since these are alignment with permanent magnets 21a of the stationary ring 30. The “inner permanent magnets” are a second permanent magnet 23b and a third permanent magnet 23c in the movable disc 29, and second, third and fourth permanent magnets 21b, 21c, 21d in the stationary ring 30.

The rotation of the movable disc 29 can be interpreted based on FIGS. 14A-14D, in which figures permanent magnets 23a, 23b and 23c will be moved and the permanent magnets 21a-21d of the stationary ring 30 will remain in their place.

FIGS. 14A-14D are also shows the role of polarizer elements 24a-24d (having a differentiating letter according to the stationary permanent magnet 21a-21d to which these correspond to). To help understanding of the rotation, the status of the optical gate is as a function of the rotational position of the movable disc is illustrated by arcs 68 in FIGS. 14A-14D. When the centreline in the radial direction of a permanent magnet 23a-23c is within any of arcs 68, then the polarizer element 24a-24d of the permanent magnet 21a-21d corresponding to the respective arc 68 (every arc 68 correspond to a permanent magnet 21a-21d of the outer stationary ring 30).

In other words: the circular control element 32 rotates together with the movable disc, and the blocking portions vis-A-vis the light path of the optical source and optical receiver arranged so that when a permanent magnet 23a-23c is at a position with its centreline in front of an arc 68 of a permanent magnet 21a-21d of the stationary ring 30, then the respective polarizer element 24a-24d is in its resting position, and if the centreline of every permanent magnet 23a-23c is outside of the arc 68 of a permanent magnet 21a-21d then the respective polarizer element 24a-24d is in its working position.

It is noted here that preferably a separate pair of optical source and receiver is arranged for each polarizer element 24a-24d, i.e. for each stationary permanent magnet 21a-21d for detecting whether a blocking portion is in the light path. However, it is also conceivable that only a single pair of optical source and receiver is arranged for detecting—based on the position of the blocking portions—the position of the circular control element 32 and the to-be-set status of each of the polarizer elements 24a-24d is determined based on the single optical control signal of this pair. For this the—preferable equidistant—distribution of the blocking portions has to be known. Moreover, other methods are conceivable to detect the position of the movable disc to set the status of the polarizer elements.

Now, the different stages of the rotation are illustrated by the help of FIGS. 14A-14D. In FIG. 14A the clockwise rotation is started from a position—as touched upon above—where permanent magnets 21a and 23a are in alignment on the top of the figure and also at the bottom of that. In this position of the movable disc 29 the centrelines of permanent magnets 23a falls within the arc 68 of the corresponding permanent magnets 21a (which are in alignment with the permanent magnets 23a). Thus, the corresponding polarizer elements 24a (visible otherwise in FIGS. 14C and 14D) are in their resting position (and not denoted in front of the permanent magnets 21a).

This alignment of permanent magnet 21a and 23a is the time instance when the movable permanent magnet 23a passes in front of the stationary permanent magnet 21a (in front of which it was driven by the help of the already removed polarizer element 24a, see below the details for the timing of removal of a polarizer element).

It can be observed in FIG. 14A that the centreline of permanent magnet 23b is also within the corresponding arc 68, which is the arc 68 of permanent magnet 21b. There is no need at this stage to have the polarizer element 24b in front of permanent magnet 21b, since the movable permanent magnet 23b has already passed in front of the stationary permanent magnet 21b which pushes away the movable magnet 23b by a repulsive force, so this pair of permanent magnets 21b and 23b helps the clockwise motion of the movable disc 29.

The centreline of permanent magnet 23b is within the arc 68 of the stationary permanent magnet 21b. Thus, it is clear that permanent magnet 23b is not in front of the arc 68 of permanent magnet 21c. This arc 68 has already left by the centreline of movable permanent magnet 23c, accordingly, a polarizer element 24c is in its working position in front of stationary permanent magnet 21c (i.e. the polarizer element 24c is denoted in FIG. 14A). The polarizer element 24c in its working position also helps the movement of the movable permanent magnet 23b, since there is an attractive (attracting) force between the polarizer element 24c and the movable permanent magnet 23b (this attractive force is small at the beginning, but it is same direction force as the repulsive force of the stationary permanent magnet 21b).

In the case of the polarizer element 24d of permanent magnet 21d, the situation is similar to that of polarizer element 24c. The movable permanent magnet 23c have not reached the arc 68 of the stationary permanent magnet 21d (but it has passed in front of the arc 68 of the permanent magnet 21c, so—according to the above—it does not influence at this time instant the placement of polarizer element 24c in its working position). In the illustrated arrangement with the polarizer element 24d in its working position, there will be an attractive interaction between the movable permanent magnet 23c and the polarizer element 24d (the movable permanent magnet 23c does not have a pushing repulsive force—but, instead an attractive force—from the stationary permanent magnet 21c since it has the polarizer element 24c in front of itself).

To summarize, at the time instant illustrated in FIG. 14A, the following forces are exerted on the movable disc 29 (in the illustrated group of permanent magnets 21a-21d, 23a-23c):
pushing effect of the stationary permanent magnet 21b to the movable permanent magnet 23b,
attractive force between the permanent magnets 23b and 21c, as well as between the permanent magnets 21c and 23c, but these two attractive forces are in the opposite directions and based on the distances these effects eliminate each other to a good approximation,
attractive force between the permanent magnets 23c and 21d.

Consequently, in summary there are such forces in this set of permanent magnets which help the clockwise rotation of the movable magnet 29. Since—based on symmetrical principles—there will be similar permanent magnet sets (three other) in the apparatus, it can be concluded that the clockwise rotation of the movable disc 29 is facilitated. Note that the position of the aligning permanent magnet pair continuously changing in FIGS. 14A-14D. It can be understood based on this that the manner of movement can be generalized to the whole movable magnet 29 from the illustrated section of FIGS. 14A-14D.

Now, let us turn to FIG. 14B, where the movable disc 29 is rotated further compared to its position in FIG. 14A, this can be observed on the position of the movable permanent magnets 23a-23c, which is detailed in the following.

The first movable permanent magnet 23a is rotated in the clockwise direction compared to the stationary permanent magnet 21a. The movable permanent magnet 23a is pushed by the stationary permanent magnet 21a when the centreline of the previous left the centreline of the latter. At the same time, the centreline of movable permanent magnet 23b left the arc 68 (or with other name, an arc portion) corresponding to stationary permanent magnet 21b, thus—since the centreline of the movable permanent magnet 23a has not reach this arc 68—the polarizer element 24b becomes into its working position in front of the stationary permanent magnet 21b. The polarizer element 24b facilitates also the movement of the movable permanent magnet 23a, but does not hinder the movement of permanent magnet 23b, since the polarizer element 24b is taken to its working position when the centreline of the permanent magnet 23b left the stationary permanent magnet 21b at a sufficient degree, so at the time instant which is illustrated in FIG. 14B, the attractive force of the polarizer element 24c dominates on the movable magnet 23b.

Note that an arc 68 extends over the corresponding stationary permanent magnet in the clockwise direction in a certain extent as well as the centreline of the stationary permanent magnet in the anti-clockwise direction in a certain extent. This is because the removal of the polarizer elements 24a-24d has to be started in time in order that the corresponding stationary permanent magnet 21a-21d can transmit as much as possible pushing effect to the movable magnet 23a-23c passing in front of it (if the polarizer element would be removed too late, then less—and because of the distance between the magnets: weaker—pushing effect could be exerted). The insertion (depending also on the arc 68) should also be started in time based on the same reasons to facilitate the polarization of a stationary permanent magnet with appropriate timing.

The appropriate setting of the arcs 68 can be determined by experiments, however, according to FIGS. 14A-14D:
the starting of an arc 68 is shifted to be before the centreline of a stationary permanent magnet by approximately ⅙ (i.e. preferably 0.1-0.2, particularly preferable 0.14-0.19 of it; these values—according to the large outer radius of the movable disc 29 and the inner radius of the stationary ring 30—can be considered to be valid when the arc 68 is projected into front of the first permanent magnet, where these can be compared to the first permanent magnet arc 68′ corresponding to the first permanent magnets) of the arc 68 corresponding to the stationary permanent magnet itself, and
the end of the arc 68 is shifted from the halfway between two stationary permanent magnets by the same extent.

Because of the configuration at the start of the apparatus, the moving of the movable disc will start by this polarizer management. Moreover, during operation the existing momentum of the movable disc will help to have a continuous motion. It is noted here also, that the movable disc will move as a consequence of the movements of the polarizer element. Accordingly, the above can be summarized as that the movement of the movable disc will develop as it is determined by the movements of the polarizer elements (the movement frequency of them can be varied: e.g. starting from a lower frequency which is increased later; the frequency is independent on whether the movable disc rotates freely or a loading is taken to it; the free or loaded status varies only the energy needed for moving the polarizer element, the status does not, however, varies the frequency). The movable disc can start from any position, since the polarizer elements determine its movement

A further difference between FIGS. 14A and 14B is that after the attracting effect of the polarizer element 24d on the movable permanent magnet 23c helped it to reach the line of the stationary permanent magnet 21d, its centreline also reached the arc 68 corresponding to the permanent magnet 21d, thus the polarizer element 24d became to its resting position in FIG. 14B (and the movable permanent magnet 23c became aligned with the stationary permanent magnet 21d, the polarizer element 24d has been removed with an appropriate timing to reach this position). It is also observable that in case of the first magnets of the next section, the next stationary permanent magnet 21a has a pushing effect on the next movable permanent magnet 23a.

Summarizing FIG. 14B it is clear that the clockwise rotation of movable disc 29 is also facilitated in the stage of the movement illustrated in FIG. 14B:
the stationary permanent magnet 21a has a pushing effect on the movable permanent magnet 23a,
the polarizer element 24b has a (small) pulling effect on the movable permanent magnet 23a,
the polarizer element 24c has an attractive force on the movable permanent magnet 23b which dominates the attraction of the polarizer element 24b on it.

Now, turning to FIG. 14C the followings can be determined. The movable disc 29 turns further, the movable permanent magnet 23a which is shown in the upper part of FIG. 14C gets close to the stationary permanent magnet 21b, which still has the polarizer element 24b in front of itself, it has an attracting effect to the movable permanent magnet 23a. Since the movable permanent magnet 23a left the arc 68 corresponding to the stationary permanent magnet 21a, the polarizer element 24a became to the working position in FIG. 14C, which means that the stationary permanent magnet 21a exerts no more a pushing effect on the movable permanent magnet 23a. This does not cause a problem, since the movable permanent magnet 23a is closer to the stationary permanent magnet 21b than to the permanent magnet 21a.

In FIG. 14C, after the attraction of polarizer element 24c placed in front of the stationary permanent magnet 21c, the movable permanent magnet 23b reaches the arc 68 corresponding to the permanent magnet 21c which leads to the removal of polarizer element 24c and the movable permanent magnet 23b becomes aligned with the permanent magnet 21c.

At the same time, the movable permanent magnet 23c moved—according to the rotation of the movable disc 29—from the alignment with the stationary permanent magnet 21d, thus the latter pushes the former. It is also to be noted in FIG. 14C that according to the cyclical arrangement, the polarizer element 24a is also in its working position at the bottom of FIG. 14C.

In FIG. 14D, the movable permanent magnet 23a reached the alignment with the next stationary permanent magnet, which is the permanent magnet 21b (the polarizer element 24b is removed). Consequently, FIGS. 14A-14D shows the rotation of the movable disc 29 between two aligned position of the movable permanent magnet 23a. Any of the aligned movable and stationary permanent magnet pairs could have been selected for illustration, so, in this way, every relevant detail of the rotation is illustrated in FIGS. 14A-14D. This is also visible when FIG. 14A and FIG. 14D are compared to each other: the alignment, the pushing, and the arranged polarizer elements are shifted with one stationary permanent magnet.

Accordingly, in FIG. 14D the movable permanent magnet 23b is pushed by the stationary permanent magnet 21c. Furthermore, the polarizer element 24d and the bottom polarizer element 24a are in their working position and have an attracting effect on the movable permanent magnets 23b and 23c, respectively.

By the help of FIGS. 14A-14D, also the details of the above mentioned translational/linear motion can be visualized. It is facilitated simply by the fact that in the arrangement of FIGS. 14A-14D the curve is not too strong but the arrangement has only a slight curve. In the conceived apparatus this curve is made straight and the component yielded from the stationary ring 30 as it become straight is arranged as a base being the stationary module with the stationary permanent magnets arranged in a row on it (according to the fact that the arcuate shape of the stationary ring has been made straight). Also, the polarizer elements are arranged in the very same way as these are illustrated in FIGS. 14A-14D. Similarly, as the stationary module as visualized above, a movable module would be transformed from the movable disc 29 by straightening.

In the apparatus outlined above, the motion would lay on the same principles as detailed in connection with FIGS. 14A-14D, i.e. the stages illustrated in FIGS. 14A-14D can be realized also in the “straightened” arrangement. To visualize more: the movable module would start from a position analogue with the one illustrated in FIG. 14A. Similarly, the movable module would start to move which is analogous in the conceived case with the clockwise direction of FIGS. 14A-14D. Accordingly, after starting from the position shown in FIG. 14A, it will move to a position analogous to the one shown in FIG. 14B, between the two positions the arrangement of the polarizer elements will change as it is shown in FIG. 14A-14B. After that, the stages analogous to FIGS. 14C-14D will follow.

Furthermore, as FIGS. 14A-14D this conceived apparatus is also generalizable for lengthier sets, as well as to a lengthy stationary module and a short movable module, wherein the movable module travels along a path on the stationary module. As a consequence of the above, it is conceivable that the curve illustrated in FIGS. 14A-14D is not transformed into a straight arrangement but to general arrangement with allowing translational motion along a general path. It is naturally to be secured that there are no sharp curves in any of the directions.

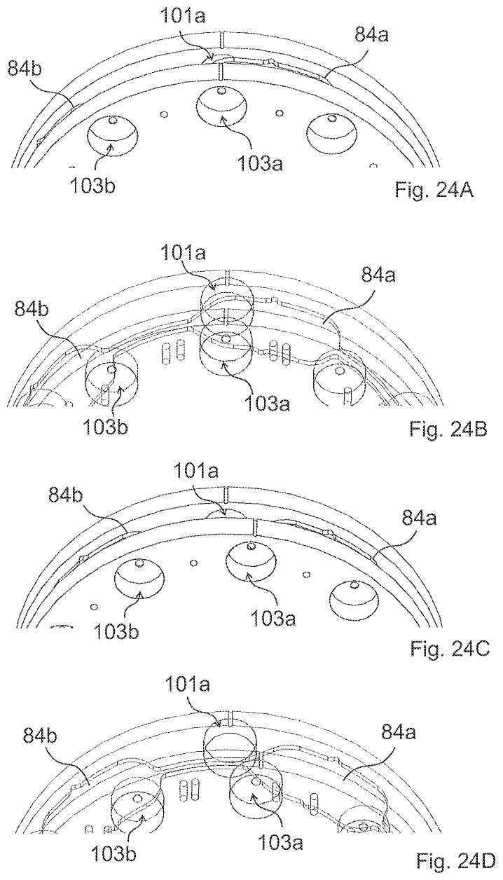

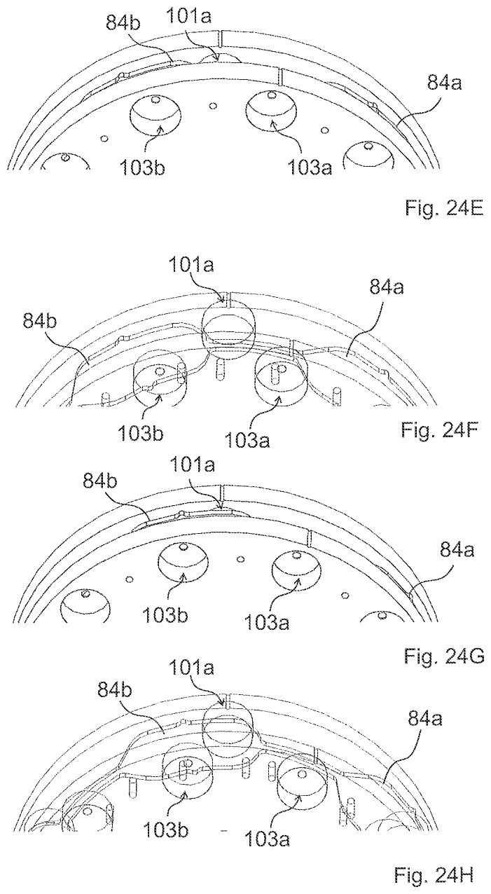

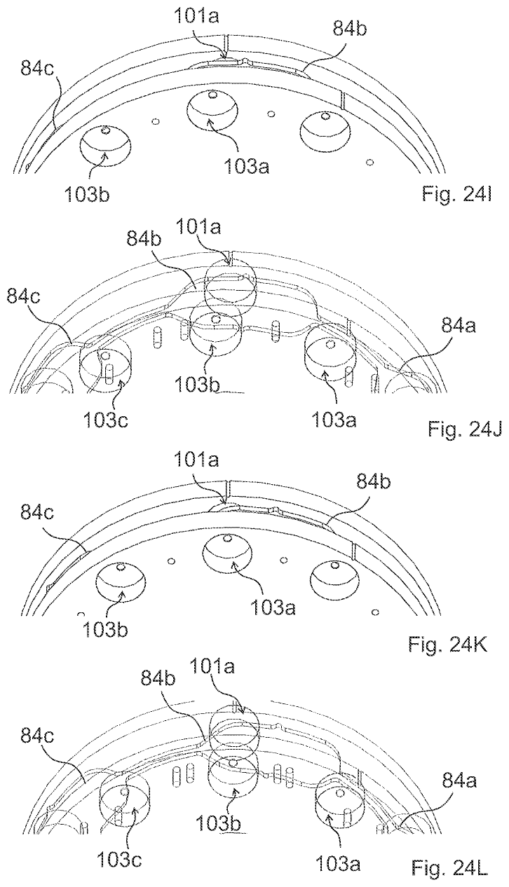

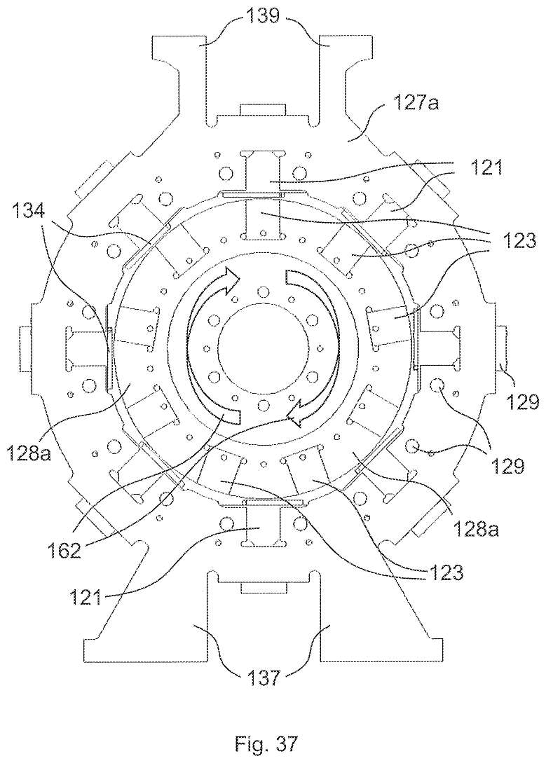

It is hereby noted that in addition to FIGS. 14A-14D the movement and arrangement illustrated on FIGS. 24A-24L, as well as FIG. 37 can be generalized similarly into translational motion along a path and, of course, to linear motion.

In connection with the rotational motion, the situation shown in FIG. 14A can also described as follows.

1. The first stage magnet (i.e. the movable permanent magnet 21a) aligns with the magnet (i.e. the stationary permanent magnet 23a) of the first magnetic unit. According to the position of the circular control element of the optical gate, the respective polarizer element has been removed, so the two magnets exert a repulsive force to each other.

2. The second stage magnet (permanent magnet 21b) and the magnet of the second magnetic unit (permanent magnet 23b) repel each other due to magnetic interaction. According to the position of the circular control element of the optical gate, the respective polarizer element is in removed state.

3. The third stage magnet (permanent magnet 21c) according to the position of the circular control element of the optical gate is in a totally polarised position, Due to the total polarisation, the polariser attracts the magnet of the second magnetic unit (permanent magnet 23b).

4. The fourth stage magnet (permanent magnet 21d) according to the position of the circular control element of the optical gate is in a totally polarized position. Due to the total polarisation, the polarizer attracts the magnet of the third magnetic unit (permanent magnet 23c).

The above so-called stages happen at the same time and the continuous rotation is generated by their continuous, cyclic repetition.

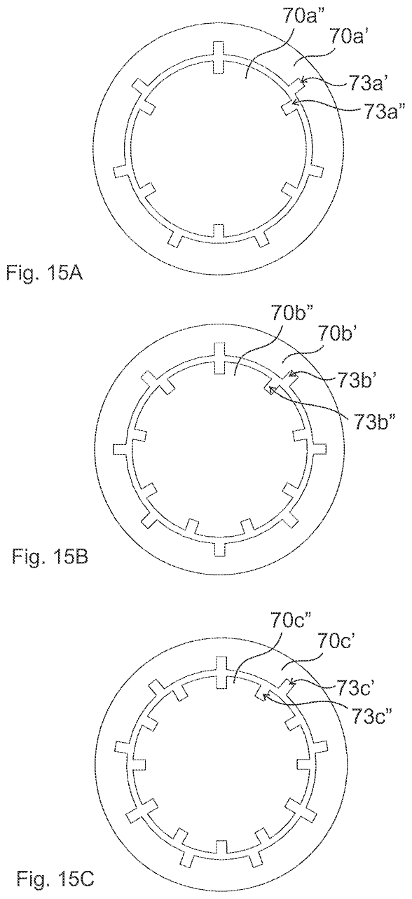

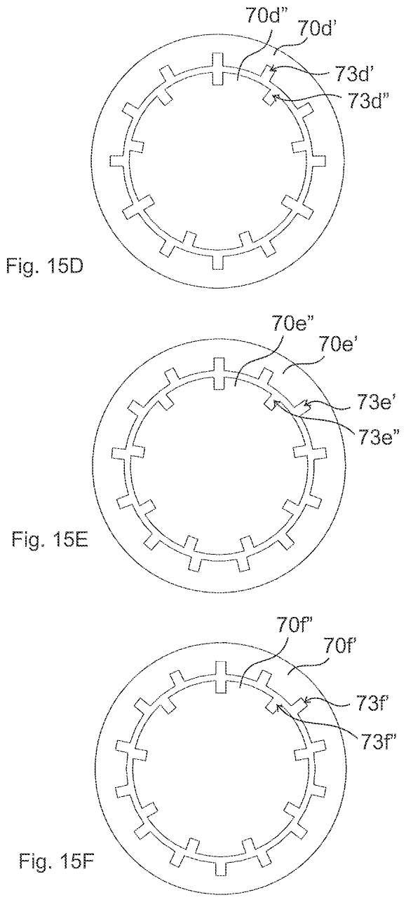

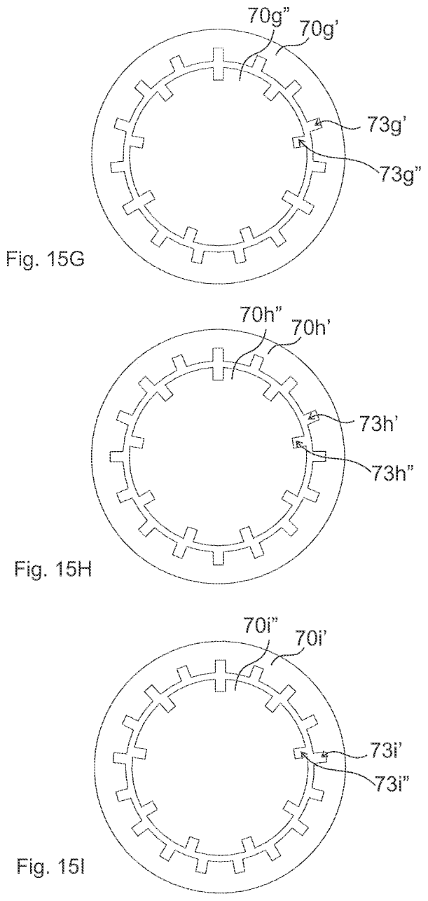

In FIGS. 15A-15I several different arrangements of the stationary rings (stationary rings 70a′-70i′) as well as the movable discs (movable discs 70a″-70i″)—in other words, the ratio of the numbers of stationary and movable magnets—are illustrated (see also disclosures about these figures below, where also FIG. 37 is considered). In FIGS. 15A-15I first indentations 73a′-73i′ for the stationary permanent magnets, as well as second indentations 73a″-73i″ for the movable permanent magnets are illustrated.

The main parameters of the arrangements of FIGS. 15A-15I are given in the following Tables 2a-2b. As it will discussed below, the arrangements of FIGS. 15A-15I are not only applicable for the embodiment disclosed above, but also for the embodiment illustrated e.g. on FIG. 30 (corresponding to the one of the stationary ring-movable disc pair). It is noted also that the arranged numbers of the stationary and movable permanent magnets are in connection with the magnetic field strength of the applied magnets. Preferably, in a realization, permanent magnets of the same type and magnetic field strength are applied as stationary permanent magnets as well as movable permanent magnets.

TABLE 2a

| | FIG. | FIG. | FIG. | FIG. | FIG. |
|---|---|---|---|---|---|
| | 15A | 15B | 15C | 15D | 15E |
| number of stationary | 7 | 8 | 9 | 12 | 13 |
| magnets | | | | | |
| number of movable | 6 | 9 | 12 | 9 | 9 |
| magnets | | | | | |
| number of polarizers | 7 | 8 | 9 | 12 | 13 |
| number of magnet units | 1 | 1 | 3 | 3 | 1 |
| number of stages | 4 | 4 | 2 | 2 | 7 |
| frequency | 0.1 Hz | 0.15 Hz | 0.2 Hz | 0.15 Hz | 0.15 Hz |

TABLE 2b

| | FIG. | FIG. | FIG. | FIG. |
|---|---|---|---|---|
| | 15F | 15G | 15H | 15I |
| number of stationary | 14 | 15 | 16 | 17 |
| magnets | | | | |
| number of movable | 9 | 9 | 9 | 9 |
| magnets | | | | |
| number of polarizers | 14 | 15 | 16 | 17 |
| number of magnet units | 1 | 3 | 1 | 1 |
| number of stages | 7 | 3 | 8 | 9 |
| frequency | 0.15 Hz | 0.15 Hz | 0.15 Hz | 0.15 Hz |

Tables 2a-2b illustrate that a huge number of different arrangements are conceivable. The number of polarizer elements is always the same to the number of stationary magnets. The number of stages defines how many different phases are needed to describe the movement of the polarizers. For the frequencies in Tables 2a-2b. The examples in the tables are given for one rotation/minute. It can be easily calculated that if 200 rotation/minute is to be achieved, then e.g. for FIG. 15A 0.1 Hz*200=20 Hz frequency will be needed.

The different ratios in the arrangement of the permanent magnets affects a number of operating conditions, such as the frequency level, number of polarisers, useful torque rate, the available speed, the amount of operating energy, etc. In a preferred case, the movable module or the movable disc comprises at least three movable second permanent magnets, the stationary first permanent magnets of the stationary module, stationary ring or stationary disc is equal to or more than the number of the movable second permanent magnets. Throughout the description many aspects are given for the number of the permanent magnets, it is clear that it is not preferred to have too small number of permanent magnets in the stationary and movable modules.

It is noted that more working block can be applied (see the third embodiment), the full extension of the arrangement can be relevant, such as also the diameter of the disc and the ring. These parameters are dependent on the space requirements as well as on the specific application.

Movable magnets arranged on the rotating disc determines the operating frequency of the apparatus. For instance, each polariser controlling a rotating disc comprising six magnets has to perform six back and forth stages during each turn (helps to polarize when a movable magnet approaches and after that the polarizer is removed to push the movable magnet away). So, every polariser at 100 rotations/minute performs 600 back and forth stages per minute, which means 10 Hz operating frequency ( 1/60-part of 600). The operating frequency affects the operating rotational speed of the apparatus as well.

The power of the apparatus depends on the torque delivered and the momentary speed. According to this, at constant torque of the apparatus, the power increases proportionately by increasing the speed.

For moving the magnetic polarizer, in an example, a pneumatic system with an operating pressure of e.g. 8 bar (see FIGS. 16A-16B) was built into the arrangement, which can be applied to fulfill all of the requirements.

As illustrated in FIGS. 16A-16B the magnetic polarizers 24 are moved by conventional—and in the figure schematically illustrated—pneumatic (working) cylinders 76. The pneumatic cylinders 76 are operated by (pneumatic) magnetic switches 71 controlled in correspondence with the rotational position of the movable disc (see also FIGS. 14A-14D).

For controlling the movement of the magnetic polarizers 24 a light-sensing optical gate breaker system (operating analogously to a circuit breaker) was applied (having an optical source 38a and an optical receiver 38b schematically illustrated in FIGS. 16A-16B, connected by a light path 39). For controlling the optical gates, a control disc comprising 18 breakers was affixed to the inner movable disc (see circular control element 32 in FIGS. 9A-9B which has a disc-like or rather a crown-like form; on the top portion of the cylindrical side wall 32a, the blocking portions 33b are the optical breakers); similar optical breaker is illustrated in FIG. 16B in the form of blocking portion 33d (analogously, a transparent portion 33c can be seen in FIG. 16A which is in the light path 39).

According to the schematic drawings of FIGS. 16A-16B, there is a power supply 79 (with e.g. 12V DC voltage) is connected to the optical source 38a and the optical receiver 38b (may be also called optical light source and optical light receiver). It is also schematically illustrated that the polarizer element 24 is moved by means of the pneumatic cylinder 76 (up and down from and into between permanent magnets 21 and 23), which is driven via air channels 77, which are operated by the pneumatic magnetic switch 71 being controlled by the control signal of optical receiver 38b and supplied by compressed air 74.

From the power supply 79 the optical source 38a (light source) operates continuously and emits continuous light towards the optical receiver 38b on the light path 39. In case there is a transparent portion 33c is in the light path, the optical receiver 38b connects the negative pole (−) of the power supply 79 to the circuit of the magnetic switch 71, which activates the air cylinder 76 and takes out the polarizer element 24 from between the permanent magnets 21, 23.

In case a blocking portion 33d is placed into the light path 39, the optical receiver 38b disconnects the negative pole (−) of the power supply 79 from the circuit of the magnetic switch 71, which activates the air cylinder 76 and pushes the polarizer element into between the permanent magnets 21, 23.

In this arrangement (see FIGS. 9A-9B), the work stages of the magnetic polarizers arranged on the stationary ring is controlled directly, at a rotation ratio of 1:18, by the movable disc. In the detailed example, the control openings are arranged with an angular separation of 20° (this is the degree value corresponds to the blocking portions 33b), at an angular shift of 8.86° (this is the degree value corresponds to the transparent portions 33a; see these in FIG. 9A).

In the exemplary experimental arrangement, at a rotational speed of 29.2 rpm (rotations per minute) of the assembled system the magnetic polarizers operate at a frequency of 8.76 Hz. Due to the limitations of the applied pneumatic cylinders (maximum 9 Hz) it was not possible to reach a higher frequency and rotational speed.

State-of-the-art pneumatic technology allows e.g. the application of the so-called “muscle cylinders” (https://www.festo.com/cat/hu_hu/products_010606; developed by Festo) that are capable of performing the necessary work at frequencies as high as 100 Hz, which amounts to a rotational speed greater than 300 rpm according to the arrangement.

In the course of our experiments, we were able to assemble a system undergoing constant rotational motion that has a constant torque irrespective of the rotational speed. This is because since the interacting energy of the magnets is constant, which will not change when the rotational speed increases or decreases.

Therefore, the higher rotational speed we seek, but it has numerous hindering effects, such as the frequency of the polarizers. The rotational speed of the arrangement is determined by the moving frequency of the magnetic polarizer (since with this frequency the movable magnet can be pulled by the polarizer element). By means of this arrangement, controllable rotational motion operating on the principle of magnetic repulsive force, with a permanent magnet power source, was realized (the main components of the assembled apparatus are shown in FIG. 11).

The torque achieved by the exemplary experimental apparatus was in total 25.4 Nm in contrast to the pre-calculated 65.00 Nm. The evaluation of the measurement data and the tests of the experimental apparatus have led us to the conclusion that the opposite-direction attractive force acting on the polarizer (which we termed the “polarization loss”, this occurs when the polarizer element is pulled out from the position when it is in front of a stationary permanent magnet) extracts from the apparatus (system) a significantly higher amount of energy than it was previously calculated.

The operation of the experimental apparatus has proven the feasibility of the concept.

Based on the results the configuration of the magnetic polarizer was rethought and additional experiments were performed.

Herebelow, experimental arrangement no. 2 is disclosed. Many details of this arrangement are also disclosed; thus, the disclosure can be considered as an example. However, with appropriate generalizations, the disclosure can be considered as a description of an embodiment (first embodiment as cited in the brief description of drawings).

In this embodiment the magnetic polarizer is circularly arranged inside the experimental working block.

Components of a working block (see FIG. 19 and FIGS. 20A-20B):
1. 2 pieces of support plates (support plates 88 in the figures)
2. 2 pieces of stator discs (with other name, stationary discs 89 in the figures)
3. 2 pieces of polarizer discs (polarizer discs 90 in the figures)
4. 1 piece of movable disc (with other name, a movable disc 91 in the figures)

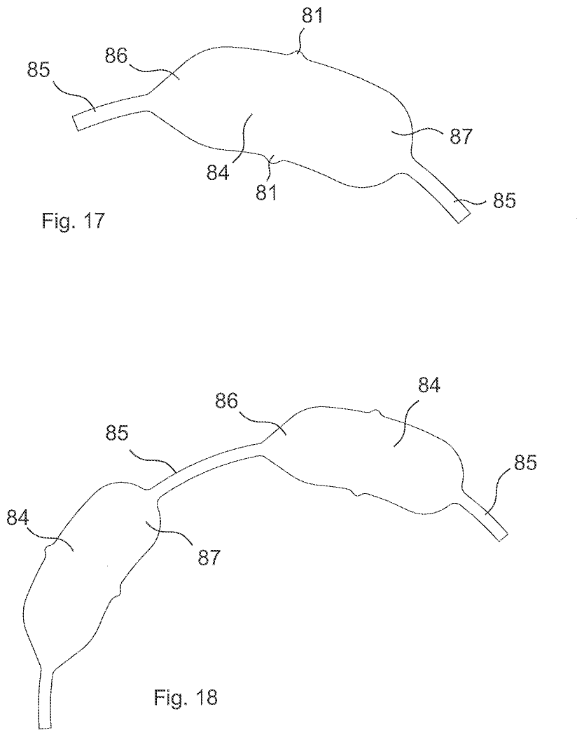

The disclosure of the present embodiment (as well as an example with specific configuration data given below) is started in FIGS. 17-18 with illustrating a single polarizer element 84 and a pair of polarizer elements 84, respectively (in this embodiment, the polarizer elements are incorporated into a polarizer disc 90, see e.g. FIG. 19 and FIG. 22, but single as well as pair polarizer elements are also illustrated).

According to FIGS. 17-18, the polarizer element has a—not regular, a little bit transformed to have an arc-shape—oval (elongated rounded) shape which have polarizer interconnections 85 at its both end with respect to its elongated direction as shown in FIGS. 17-18. In FIG. 18 it is shown, how two pieces of polarizer elements 84 are interconnected with a polarizer interconnection 85 (with other name, an interconnecting bridge). The neighboring polarizer elements 84 are fitted to an arc (i.e. they are connected in a bent configuration) in order to form a circle when the polarizer disc 90 is assembled (see below for the details, especially FIG. 22 showing the polarizer disc 90).

Accordingly, in the illustrated embodiment, neighbouring polarizer elements 84 in the annular arrangement are interconnected with each other by means of polarizer interconnections 85 being made of the same material as the plurality of polarizer elements 84.

Connecting the polarisers with an interconnecting bridge may cause negative or positive effects. The positive effect is that the polariser does not completely break out from the magnetic field, so the movement process is smoother and therefore the necessary kinetic energy is lower. The negative effect might be (in case it is present excessively) that the polarisation would remain continuous, so the interacting energy of the magnets decreases with the level of the residual polarisation. This might result in a decrease in the power of the apparatus.

By implementing such bridges that are narrow enough, the positive effect overcomes, therefore these are preferred to be used. The width of the bridge (polarizer interconnection) is preferably 5-25%, particularly preferably 10-20%, e.g. approximately 15% compared to the width of polarizer element (the width is meant in the radial direction).

Furthermore, preferably in this embodiment (see FIGS. 22-23), a polarizer arc size 94 of a polarizer element 84 on the first periphery of the polarizer disc 90 is between a magnet distance arc size 102 between two neighbouring second permanent magnet 103 (see in FIG. 23, where the magnet itself is shown, this is the distance between the closest points of the edges of the magnets) on the first periphery of the movable disc 91 and the magnet shift arc size 102 added to one and a half of second permanent magnet arc size corresponding to a second permanent magnet on the first periphery.

Size of FIGS. 22 and 23 is not fitted to each other since—as illustrated in FIGS. 24A-24L—the polarizer elements are arranged on the same radius as the permanent magnets 101, 103 so as to be able to cover them as illustrated in FIG. 19.

The polarizer elements have an arc-like shape to be able to cover the permanent magnets appropriately. In the radial direction it has a size larger than a permanent magnet i.e. it can cover it. The polarizer elements preferably slightly larger (i.e. have a larger respective width) in the radial direction than the permanent magnets 101, 103 for covering them.

According to the above, to the size of the polarizer element on the first periphery (i.e. in the tangential direction), the minimum is the arc size between two second permanent magnets, this is the magnet distance arc size (if a polarizer element leaves a movable second permanent magnet, it will immediately reach the next). Another preferred minimum can be the magnet arc size plus a second permanent magnet arc size, which means that when the trailing end of the polarizer element just fully covers a second permanent magnet (i.e. is almost leaves the magnet by this end), it does just not reach the next second permanent magnet. As given above and as illustrated in FIG. 24A-24B the preferred maximum size of the polarizer element in this direction is the magnet shift arc size 102 added to one and a half of second permanent magnet arc size, i.e. when the trailing end of the polarizer element just fully covers a second permanent magnet, the other end of it reaches to the half of the next second permanent magnet in the moving direction.

This is in line with that aspect that in the tangential direction the size of the polarizer element should be chosen so as to when it reaches the next movable permanent magnet it polarizes that before reaching the next stationary magnet (see by comparing FIGS. 24A-24B to FIGS. 24C-24F).

The trailing end (in the direction of the movement) of the polarizer element is provided with a peaked configuration so as to decrease the energy of leaving a magnet (i.e. to break away from it). The front (leading) end in the direction of the movement has a circle end which can properly cover a permanent magnet to be polarized (see also FIG. 17). It is in line with this that when FIG. 24A is investigated, the coverage of the permanent magnet being in the magnet place 101 is enough to be polarized.

It is to be noted that—however, in the apparatus, these form a polarizer disc 90—the polarizer elements 84 are to be handled as separate entities also in the present embodiment (similarly to other embodiments; these polarizer elements can also be easily and exactly differentiated). In short, these are the polarizer elements 84 of the polarizer disc 90 having the appropriate arrangement within the polarizer disc 90.

This is substantiated by that every polarizer element have an independent role when the interaction between the permanent magnets is influenced with them and by that the polarizer interconnections—if these are arranged: the embodiment can be realized also without them—play different role than the polarizer elements themselves (i.e. the interconnections do not directly have a role in establishing attractive forces, but in smoothing of the effects occurring when the polarizer elements are moved by the help of rotating the polarizer disc).

In FIG. 17 an entrant end (leading end, entrant side) 87 and a leaving end (trailing end, leaving side) 86 of the polarizer element 84 is denoted (in the case of clockwise rotation the former enters first in front of a stationary permanent magnet, and the latter leaves it last when the polarizer element rotates away). Also, projections 81 are denoted at the longer sides of the polarizer elements 84. These preferably triangle-shaped projections 81 facilitate the integration of the polarizer elements 84 into the polarizer disc 90 (help to avoid the movement of the polarizer elements 84 compared to other components of the polarizer disc 90, see FIG. 22).

The working block is configured in a sandwich-like manner according to the following. Support plate, stationary disc, 1 mm air gap, polarizer disc, 1 mm air gap, movable disc, 1 mm air gap, polarizer disc, 1 mm air gap, stationary disc, support plate (see FIGS. 19-20B). The values of the air gap determine an example; however, the general configuration may correspond to an embodiment.

Accordingly, in FIGS. 19, 20A and 20B an embodiment of the apparatus according to the invention is illustrated, in which the various discs are arranged in a working block (the illustrated configuration is thus somehow specific, other embodiments are conceivable on the same principles, also such embodiments which have only a single polarizer disc 90).

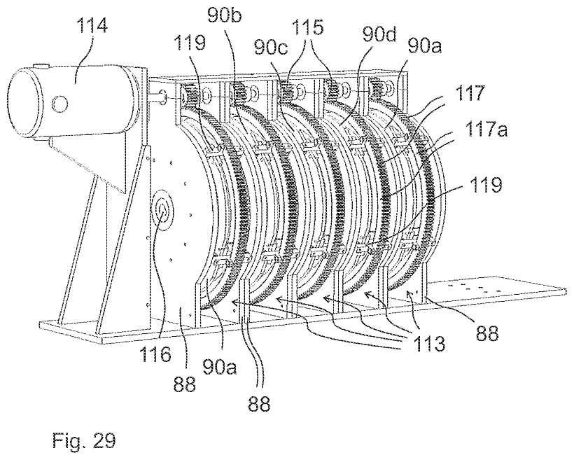

In the embodiment illustrated in FIG. 19 in an exploded view the various discs are sandwiched between two support plates (this is a working block). The support plates 88 has an upper projection with a hole and a straight base part (for the role of these, see FIG. 29), and, between these a circular part is arranged.

To the inner side of the support plates 88 facing to each other, stationary discs 89 are mounted. Between the stationary discs 89 a—doubled—movable disc 91 is arranged sandwiched between two polarizer discs 90. In this configuration the polarizer elements 84 of a polarizer disc 90 are sandwiched between a stationary disc 89 and a movable disc 91 (accordingly, the polarizer elements 84 are adapted for being arranged in front of stationary permanent magnets of the stationary disc in order to establish an attractive interaction with permanent magnets of the movable disc).

The above disclosed sandwich configuration is illustrated in an assembled state in FIG. 20A (cf. with the exploded view of FIG. 19). FIG. 20B shows the encircled part of FIG. 20A in a larger view. There are (air) gaps 92 between the various discs as shown in FIG. 20B.

In FIG. 21 the stationary disc 89 is shown, which is mounted to the support plate. According to the figure, five pieces of stationary permanent magnets 101 are arranged in the stationary disc 89 in the present embodiment (distributed evenly on a—finite—radius of the stationary disc 89, near to the edge of it). The stationary permanent magnets 101 are arranged in the stationary disc 89 with one of their poles facing outside from the stationary disc 89. This pole can be either north or south pole, but the permanent magnet is arranged in an indentation such that the other pole faces the bottom of the indentation. In an example realized according to the embodiment illustrated in FIG. 21 five N48 neodymium magnets, with the dimension of 30×15 mm (the magnets have cylindrical shape, this is diameter×length), were built into the stationary disc as the stationary permanent magnets 101.

FIG. 22 shows the polarizer disc 90 as configured in the present embodiment. In an example realized according to the embodiment of FIG. 22 five soft iron magnetic polarizers, interconnected by bridges (as shown in FIGS. 17-18) are built into the magnetic polarizer disc. The polarizer disc 90 is configured such that the polarizer unit is mounted between an inner ring 93a and an outer ring 93b made of preferably non-magnetizable material (e.g. A2 grade stainless steel, A2 is an international material notation). The inner ring 93a and the outer ring 93b are configured such that it has indentations for each projection 81 of the polarizer elements 84 in order to avoid that the ring constructed from the polarizer elements 84 moves with respect to the inner ring 93a and outer rings 93b (so that they are connected to each other in a fixed position). Accordingly, the whole polarizer disc 90 rotates together. The polarizer elements 84 will be arranged in the polarizer disc 90 at the same radius as the permanent magnets 101 and 103 in the stationary disc 89 and the movable disc 91, respectively.

In FIG. 23 the movable disc 91 is illustrated. In the present embodiment, ten pieces of movable permanent magnets 103 are evenly arranged in the movable disc 91 at the same radius as the stationary permanent magnets 101 in the stationary disc 89. Similarly to the stationary disc 89, the movable permanent magnets 103 are arranged in the movable disc 91 with one of their pole facing outside from the movable disc 91. The pole facing outside from the movable disc 91 is the same type of pole (i.e. one of the opposite type poles, namely north or south pole) which faces outside from the stationary disc 89. Thus, the same poles will face each other when the stationary disc 89 and the movable disc will be placed next to each other, and the polarizer disc 90 can be inserted between them.

In FIGS. 21 and 23 it is indicated that the stationary disc 89 is an implementation of a stationary module 89′, as well as that the movable disc 91 is an implementation of a movable module 91′, respectively.

In the embodiment illustrated in the previous figures,
the stationary module 89′ is implemented by a stationary disc 89 (see e.g. FIG. 21) and the plurality of first permanent magnets (the first permanent magnets 101 are shown in FIG. 21) are arranged at a second periphery of the stationary disc 89 with their respective magnetic poles arranged on a base plate of the stationary disc 89 (a disc have naturally two base plates which are otherwise connected by the part corresponding to the outer periphery), wherein the second periphery having the same radius as the first periphery and the plurality of second permanent magnets are arranged with their respective magnetic poles arranged on a base plate of the movable disc 91 (see e.g. FIG. 23),
the plurality of polarizer elements 84 are arranged in an annular (ring-like) arrangement and incorporated into a polarizer disc 90 (i.e. the polarizer elements 84 are unified into a ring, as for example illustrated in FIG. 22; it is the essential point of the incorporation that the polarizer disc 90 thus can be treated—and expediently driven—as a single unit), and
the polarizer disc 90 is arranged between the stationary disc 89 and the movable disc 91, wherein the stationary disc 89, the movable disc 91 and the polarizer disc 90 are arranged along a second main shaft (for a second main shaft 116, see FIG. 29, it is illustrated in connection with this figure how the polarizer disc 90 is driven).

Furthermore, it is preferably also holds true that the first permanent magnets 101 are arranged equidistantly at the second periphery of the stationary disc 89 (see FIG. 21) and the second permanent magnets 103 are arranged equidistantly at the first periphery of the movable disc 91.

Preferably, a third magnet number (i.e. the total number of) of the first permanent magnets 101 of the stationary disc 89 is half of a fourth magnet number (i.e. the total number of) of the second permanent magnets 103 of the movable disc 91.

In an example realized according to the embodiment of FIG. 23, ten N48 neodymium magnets, with the dimension of 30×30 mm, were built into the movable disc.

In summary, these are the data in an example. The (outer) diameter of the stationary disc is 260 mm. The radius of the centreline of the magnets placed on the stationary disc is R 110 mm. The type and sizes of the magnets placed into the stationary disc are N48 30 (diameter)×15 (length) mm. The (outer) diameter of the rotating disc is 260 mm. The radius of the outline of the magnets placed on the rotating disc is R 110 mm. The type and sizes of the magnets placed into the rotating disc are N48 30 (diameter)×30 (length) mm. The radius of the centreline of the polariser elements is R 110 mm. The thickness of the polariser is 4 mm. The distance (gap) within the various discs was 1.5 mm. The degree of the highest magnetic peak pushing force measured on magnet pair (R 110 mm on an arc) during the experiments is 3.6 kg*f. This value expressed in torque measured on the shaft is 4.208 Nm. The applied frequency was 25 Hz in the example.

According to the operating principle of the experimental arrangement, the magnetic polarizer disc and the movable disc have an identical rotational direction, but their speed is different at a ratio of 2:1. This means that in the course of 2 revolutions of the magnetic polarizer disc, the movable disc performs 1 revolution.

In this embodiment by the movement of the polarizer disc the moving disc will assume the movement which is illustrated in FIGS. 24A-24L.

In a single revolution, the movable disc performs ten working stages generating torque (the movable magnets work on both sides with the magnets of the two stationary disc outputting double energy). The power stroke of the magnetic polarizer consists of the following stages (see FIGS. 24A-24L, which illustrate the rotation in spatial figures showing a part of the various discs and corresponding transparent figures with the same content as the spatial figures but showing also the covered parts of the components; in FIGS. 24A-24L—for the sake of simplicity—the interconnected polarizer elements are illustrated in themselves, i.e. without being incorporated into the polarizer disc 90, the stationary disc 89 on the back and the movable disc 91 on the front are illustrated in a normal way, but these simplification is only for illustration):
1. The stationary permanent magnet being in a magnet place 101a is in (with a good approximation) full polarization with the movable permanent magnet being in a magnet place 103a. An attractive force arises between the movable permanent magnet being in a magnet place 103b and the polarizer element 84b (see FIGS. 24A and 24B; in FIG. 24B the magnet place of another two stationary permanent magnet can be see, at the bottom of the figure, these can also be observed in FIGS. 24H, 24J and 24L).
2. As the polarizer element 84a moves, a repulsive force arises between the stationary permanent magnet being in the magnet place 101a and the movable permanent magnet being in the magnet place 103a. Under the effect of the repulsive force, the movable permanent magnets being in the magnet places 103a and 103b are moved in a direction corresponding to the direction of motion of the polarizer. The movable permanent magnet being in the magnet place 103b becomes fully polarized with the polarizer element 84b (see FIGS. 24C and 24D).
3. In addition to the repulsive force between the stationary permanent magnet being in the magnet place 101a and the movable permanent magnet being in the magnet place 103a, an attractive force arises between the stationary permanent magnet being in the magnet place 101a and the polarizer element 84b. The movable permanent magnet being in the magnet place 103b remains in full polarization (see FIGS. 24E and 24F).
4. The stationary permanent magnet being in the magnet place 101a and the movable permanent magnet being in the magnet place 103b are in polarization. The repulsive force acting on the movable permanent magnet being in the magnet place 103a has disappeared; the polarizer element 84b is subjected to an attractive force (see FIGS. 24G and 24H).
5. The stationary permanent magnet being in the magnet place 101a and movable permanent magnet being in the magnet place 103b move closer to each other and are in full polarization. The polarizer element 84b is subjected to the increasing attractive force of the movable permanent magnet being in the magnet place 103a (see FIGS. 24I and 24J).
6. The stationary permanent magnet being in the magnet place 101a is in full polarization with the movable permanent magnet being in the magnet place 103b. An attractive force arises between the movable permanent magnet being in the magnet place 103a and the polarizer element 84b (see FIGS. 24K and 24L; similar arrangement as in FIGS. 24A and 24B but with the next polarizer element 84b and the next movable permanent magnet being in the magnet place 103b in front of the stationary permanent magnet being in the magnet place 101).

The above are interpreted further herebelow. The rotation of the movable disc 91 is facilitated by the help of the rotation of the polarizer disc of which only the polarizer elements 84a and 84b are illustrated. Accordingly, the position illustrated in FIGS. 24A and 24B are left by help of rotating the polarizer elements, this causes the rotation of the movable disc 91, no other influence is taken to help the movement. FIGS. 24A-24L illustrate how the rotation of the polarizer elements (polarizer elements 84a and 84b in the figures) facilitate the rotating of the movable disc 91, in other words, how the polarizer elements pull the movable disc 91.

Accordingly, when starting from the situation illustrated in FIGS. 24A-24B and changing to the situation shown in FIGS. 24C-24D, the polarizer element 84a is pulled from its position between the stationary permanent magnet being in the magnet place 101a and the movable permanent magnet being in the magnet place 103a. Because the polarizer element 84a lacks from its position between these magnets, these will act with a repulsive force on each other since the same poles face to each other. Thus, the stationary permanent magnet being in the magnet place 101a will push the movable permanent magnet being in the magnet place 103a (it is also pulled by the polarizer element 84a) in the same direction as the polarizer elements 84a and 84b was rotated.

In FIGS. 24E-24F the polarizer element 84a is pulled further away. However, at the same time, the next movable permanent magnet 84b is become polarized by the polarizer element 84b and—by the rotation of also the movable disc 91—get positioned more and more between the stationary permanent magnet being in the magnet place 101a and the movable permanent magnet being in the magnet place 103b.

As a consequence, the stationary permanent magnet being in the magnet place 101a gets polarized by the polarizer element 84b in FIGS. 24G-24H, so the stationary permanent magnet being in the magnet place 101a does not push further the movable permanent magnet being in the magnet place 103a. However, the movable permanent magnet being in the magnet place 103b is pulled by the polarizer element 84b, since there is an attractive force between them. At the end of the stage, the polarizer element 84b is pulled from its position between the stationary permanent magnet being in the magnet place 101a and the movable permanent magnet being in the magnet place 103b, and the rotation process continues in the same way as was illustrated in FIGS. 24A-24B.

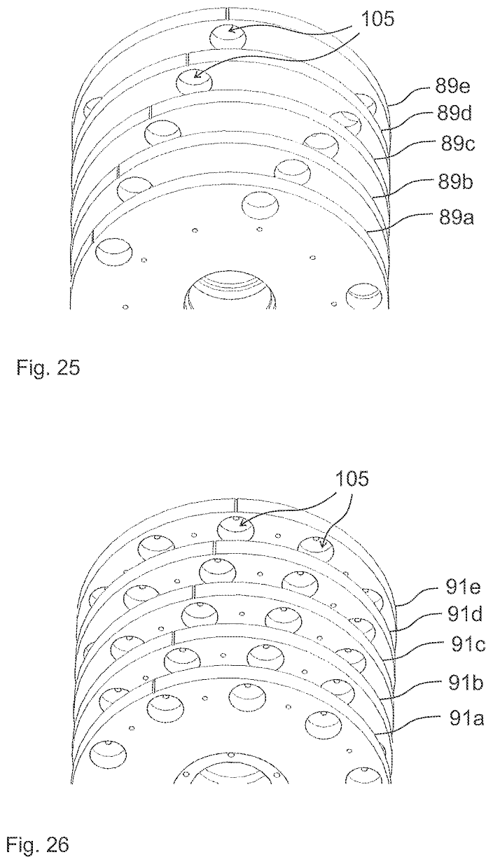

In an embodiment the experimental apparatus consists of five working blocks. In this arrangement of the magnets of the stationary disc is provided such that the stationary disc magnets of each successive working block are arranged rotated by 14.4° (in an example this is the value of the rotation shift; other values for the rotation shift are conceivable) corresponding to the direction of rotation. The stationary disc permanent magnets (the places of the permanent magnets are denoted by magnet places 105 shown in FIGS. 25-26) arranged (placed) in the 5 working blocks to form, row-by-row, a 72-degree helical line arrangement (in FIG. 25 stationary discs 89a-89e are shown).

It can be seen that a part between two stationary permanent magnets is “filled” with the rotatably arranged other stationary discs 89a-89e to have a continuous overlap and thus the working blocks being formed by the stationary discs 89a-89e (preferably all of them are doubled) can help each other during the operation. A single working block can also operate in itself. If there are more working blocks the rotation degree can be a lower value, but when there are less, it can be a larger value.

The stationary discs 89a-89e are arranged on the same main shaft (the shaft through hole for receiving the is observable in the centre of the first stationary disc 89a) for a second main shaft 116 see FIG. 29. When FIG. 25 is considered together with FIG. 29, it becomes clear that preferably two of stationary discs correspond to a working block (just like in the working block illustrated if FIGS. 19-20B). If there are two stationary discs in a working block, then stationary discs of the same working block have the same rotation position, and the stationary discs of the further working blocks are rotated compared to the earlier working block as illustrated in FIG. 25.

Movable disc 91a-91e corresponding to the stationary discs 89a-89e are shown in FIG. 26. It is also to be noted that these movable discs 91a-91e are to be arranged in pairs for the respective working blocks as shown in FIGS. 19-20B (i.e. similarly to the concept of FIG. 25, the single movable discs 91a-91e can be considered as an illustration).

In the example illustrated at the stationary discs 89a-89e in FIG. 25, the arrangement of the magnets of the movable disc is provided such that the movable disc magnets of each successive working block are disposed shifted by 7.2° corresponding to the direction of rotation. The movable disc magnets arranged (placed) in the five working blocks form, row-by-row, a 36-degree helical line arrangement (cf. FIG. 26). These values are halves compared to that of the stationary disc since the polarizer disc rotates twice as the movable disc so that continuous work performance can be established.

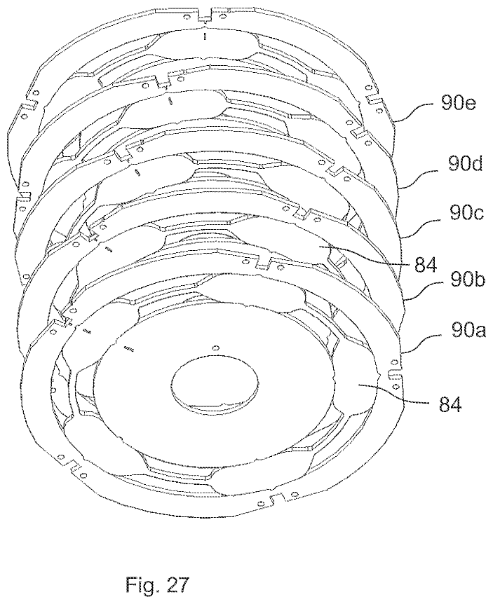

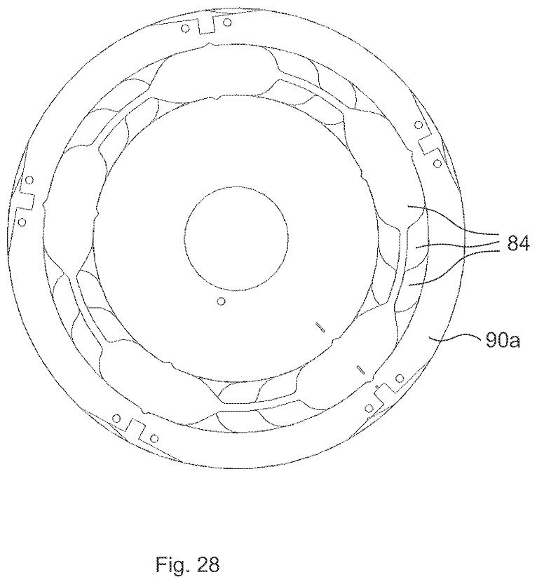

Polarizer discs 90a-90e corresponding the stationary discs 89a-89e of FIG. 25 and movable discs 91a-91e of FIG. 26 are illustrated in FIG. 27 (see also FIG. 28, where the polarizer discs with the same rotation shifts are illustrated such a way that only the first polarizer disc 90a is visible in its entirety, but polarizer elements 84 of more polarizer discs can be observed shifted by the rotation shift).

In this embodiment the discs of the working blocks are connected to the same main shaft (see FIG. 29 for the main shaft 116). The stationary discs 89a-89e—since these are not-rotating by definition—are adapted for holding the main shaft which can freely rotate with respect to them. The polarizer discs 90a-90e also freely rotate around the main shaft since the polarizer discs 90a-90e are driven at its outer periphery (cf. FIG. 29) and do not give the rotation to the main shaft. The movable discs 91a-91e are, however, fixedly arranged to the main shaft (i.e. these rotate the main shaft during their rotation, the power output is on the shaft): the movable discs 91a-91e are driven via their movable permanent magnets by the help of the polarizer elements of the polarizer discs 90a-90e.

The arrangement of the various discs in FIGS. 25-28 is a preferred arrangement. This arrangement can be set by the start of the rotation, according to the following. The stationary discs 89a-89e can be fixed to the holding structure (like the support plates 88) according to the illustrated order (if there is a stationary disc pair for a working block, then both). For the polarizer discs 90a-90e and the movable discs 91a-91e the position illustrated in FIGS. 26-28 can be set for the start of the rotation, i.e. the operation of the apparatus will be started by the help of rotating the polarizer discs 90a-90e from outside such a way that all of the discs of FIGS. 25-28 are in the illustrated rotational position.

Preferably, the arrangement of the stationary disc 89a-89e will be fixed (accordingly these are fixed also with respect to each other) and the polarizer discs 90a-90e will be fixed with respect to each other with the same rotation degree as the stationary discs 89a-89e (they are fixed according to their starting position, since these are driven from outside) to be in the appropriate position when rotated, and the movable discs 91e-91e will assume the appropriate position during the rotation.

As mentioned above, the above detailed embodiment of the apparatus—based on which an experimental apparatus can be realized, see below the results obtained with it—is illustrated in FIG. 29; this apparatus is operated by moving the polarizer discs 90a-90e.

In the apparatus the polarizer discs 90a-90e are rotated utilizing an auxiliary motor 114 via a gear transmission. By the help of the auxiliary motor 114 (auxiliary driving unit), second driving gears 115 are driven (all of them); a separate driving gear 115 corresponds to each working block 113. The driving gears 115 are adapted for drive respective driving teeth 117 of the working blocks 113. The driving teeth 117 are formed on respective driving rings 117a. Via connector elements 119 two polarizer discs are connected to each driving rings 117a (from these two polarizer discs only one is visible in FIG. 29 for each pair, since the other is in coverage by the driving rings 117a with the driving teeth in the view of the figure). In this embodiment the polarizer rings 90a-90e are driven in this way.

Thus, in an embodiment, the apparatus comprises a third polarizer moving arrangement adapted for rotating the polarizer disc 90. The third polarizer moving arrangement can be configured in a general way (i.e. much more general than it is illustrated in FIG. 29), its task is only to rotate the polarizer disc.

In the illustrated embodiment, driving teeth 117 are formed on or connected (in a fixed, non-rotatable manner) to an outer periphery of the polarizer disc 90 (in the illustrated embodiment the driving teeth 117 is formed on driving rings which is arranged at the outer periphery of the polarizer disc 90, namely connected to two of them) and the third polarizer moving arrangement comprises a driving gear 115 fitting to the driving teeth 117 and adapted for rotating the polarizer disc 90 (in the apparatus of FIG. 29, a separate driving gear 115 is arranged for each pair of polarizer discs 90).

As illustrated in FIGS. 24A-24L, when rotating the polarizer discs 90a-90e, under the effect of the repulsive force acting on the (permanent) magnets arranged in the movable discs 91a-91e (rotor discs; these are not visible in FIG. 29), the movable disc assembly is rotated in a direction identical to the direction of rotation of the polarizer discs. The operating rotational speed of the experimental apparatus is determined and controlled by the rotational speed of the polarizer discs 90a-90e. The magnetic polarizer discs 90a-90e and the movable discs 91a-91e have an identical rotational direction, but their speed is different at a ratio of 2:1.

We measured the torque of the experimental apparatus realized according to the embodiment shown in FIG. 29 utilizing a digital torque meter. The torque meter was connected to a stub formed at the end of the main shaft 116 connecting the working blocks 113. As the magnetic polarizer discs 90a-90e are rotated together, the actual momentary output torque of the experimental apparatus is given by the sum of the repulsive forces acting on the magnets arranged in the movable discs 91a-91e.

In the embodiment illustrated in FIG. 29, multiple second working units of a polarizer disc 90 arranged between a stationary disc 89 and a movable disc 91 are arranged along the second main shaft 116.

In the exemplary experimental realization, the apparatus (system) was equipped with and was operated utilizing a preferably direct-drive 24-V electro-mechanical auxiliary drive unit applied as the auxiliary motor 114.

The peak torque value measured with the experimental apparatus realized according to the above detailed embodiment was only 87.70 Nm instead of the previously calculated 32.50 Nm. With a prolonged load, a torque of 29.1 Nm was measured. We established that this was caused by the low degree of overlap between the magnets (see below).

With this arrangement we were unable to achieve the 300 revolutions/minute target speed. In the course of the tests, it was found that the maximum speed the apparatus (system) is capable of is 135-140 revolutions/minute. In this revolution range the highest frequency of the polarizer is 22.9 Hz (i.e. the frequency of moving the polarizer is maximized e.g. in approx. 23 Hz). Based on the tests it can be established that magnetic polarization is not particularly effective at high frequencies. Due to the high frequency, the interaction between the polarizer and the work magnets generates an opposite-direction eddy current that has a braking effect on the rotor of the system. The magnetic forces are not dependent on the frequency, so same quantity of energy can be transmitted with a polarization performed at high frequency as at low frequency.

The low-speed operation of the experimental apparatus has proven the feasibility of the concept.

These can be illustrated in FIG. 14E showing the concept of overlap of working magnets in a rather generalized way.

The power of the apparatus is determined by the degree of overlap of consecutive work magnets. The peak torque of the magnets of the apparatus presented as an example was 87.7 Nm, though the continuous torque measured during operation was altogether 29.1 Nm. This is illustrated in FIG. 14E where the value of the torque is shown as a function of time.

A magnet pair is a pair of magnets consisting of one fixed and one moving magnet in operation. The two ended arrow corresponding the respective magnet pairs indicates the time of the repulsive effect of the pair of magnets. Furthermore, the curve is a scale curve of the torque between the pair of magnets.

The graph of FIG. 14E shows that during the repulsive time occurring between magnet pair 1, the repulsive effect starts to occur between magnet pair 2 as well. The repulsive effect between magnet pair 1 ceases, during the repulsive time occurring between magnet pair 2, the repulsive effect occurs between magnet pair 3 as well. The repulsive effect between magnet pair 2 ceases, during the repulsive time occurring between magnet pair 3, the repulsive effect occurs between magnet pair 4 as well. This process is repeated cyclically during the rotational motion.

This cycle can be interpreted e.g. based on FIGS. 14A-14D, where it is shown in FIG. 14A that there is a repulsive effect between permanent magnets 21b and 23b and that the repulsive effect will be effective from this moment between the permanent magnets 21a and 23a (so there is an overlap between these two pairs). FIG. 14B shows the repulsive effect between the permanent magnets 21a and 23a and illustrates that the permanent magnets 21d and 23c will have the same repulsive effect immediately. FIG. 14C shows the permanent magnets 21d and 23c and the permanent magnets 21c and 23b as overlapping pairs, and for FIG. 14D, these are the pair of the permanent magnets 21c and 23b and the permanent magnets 21b and 23a.

The time of the overlap of the repulsive effect between the two pairs of magnets is called magnetic overlap.

Peak torque (shown by a vertical line 202, it is 87.7 Nm above) is torque measured on the shaft generated by maximal repulsive force between the magnet pair. It is not equal with the utilizable continuous power of the apparatus. The continuous useful power of the apparatus is originated from, based on the overlap of the magnet pairs, the continuous torque measurable on the shaft (shown by a vertical line 204, it is 29.1 Nm above). By increasing the number of magnet pairs, the scale of the overlap can be increased, thus the useful power of the apparatus also increases.

The sizes of the apparatus are adjusted for example to the scale planned and required to be reached of the torque. The size of the necessary magnetic repulsive force, which determines the size of the magnet, can be calculated from this value. The sizing of the polarizer, furthermore the stationary and the movable ring/disc and the ratio of the magnets placed on them, can be determined based on the size of the magnet.

The approach disclosed by the help of FIG. 14E is applicable to all embodiments. The overlap can be established with the same working block in the first and third embodiments. In the second embodiment the overlap can be established by the application of more working blocks (and by the help of the multiple working blocks, the extent of the overlap can be set, see FIGS. 25-27).

Based on the results the configuration of the magnetic polarizers was rethought and additional experiments were performed. It is also noted that the different embodiments may be utilized for different applications. Accordingly, although the embodiments have been developed in order of appearance in this specification, their applications may be chosen based on their configuration and operability details.

The required modifications of the apparatus (system) and the direction of further development (to have further embodiments) was determined based on the results of the earlier experimental apparatuses. These were primarily the following:
Reduction of the energy required for driving the polarizer (see the aspects disclosed in connection with the compensator),
Increasing polarization efficiency
Providing a direct, controlled drive of the polarizers applying an electromechanical drive system,
Achieving the planned speed of 300 revolutions/minute,
Optimizing the dimensions of the system.

In the course of the research and development process we built an experimental arrangement (and achieved corresponding embodiments) that fulfilled all the target conditions.

Based on our experience with the earlier experimental arrangements (i.e. the other embodiments), the following modified arrangement (having common aspects mostly with the first embodiment detailed above) of a further apparatus is disclosed, which can be referred as experimental arrangement no. 3 (generally, third embodiment as cited in the brief description of drawings).

The arrangement comprises a double-disc working block (see e.g. FIGS. 30 and 37, but many other figures are relevant for this embodiment, see below), or in other words, it can be said that the arrangement (apparatus) may be built up (i.e. consists of) of one or more double-disc working block.

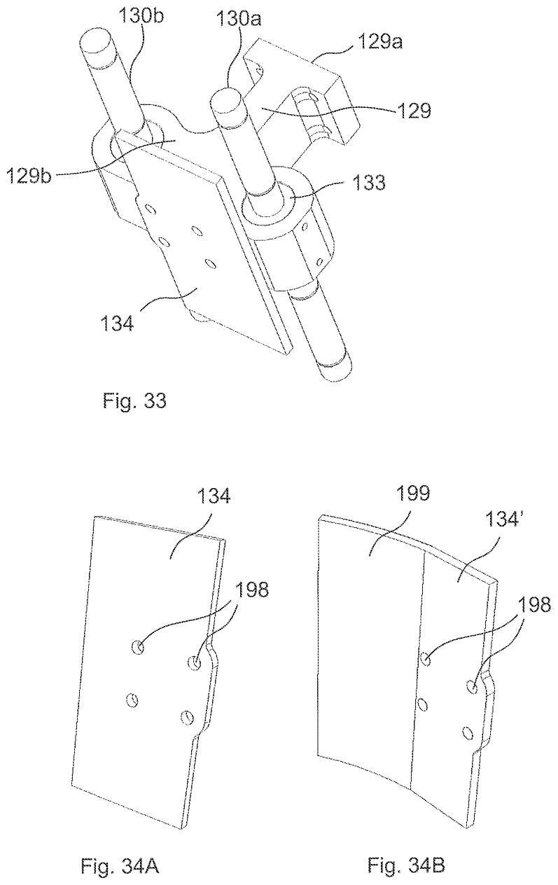

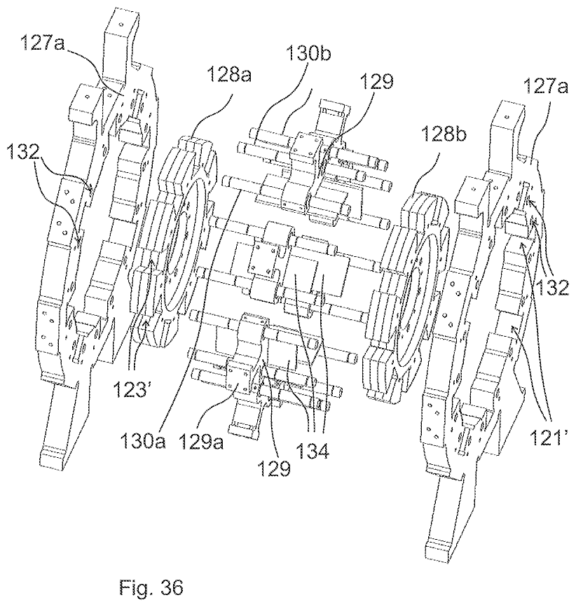

Major components of the working block:
1. 2 pieces of stationary rings (with other name stationary or stator discs—if interpreted as a hollow disc with another disc within it; see stationary discs 127a and 127b in FIG. 30)
2. 2 pieces of movable discs (rotor discs; see movable discs 128a and 128b in FIG. 30, see also FIG. 36)
3. 1 piece of tubular shaft (see tubular shaft 131 in FIG. 30)
4. 8 pieces of polarizers (see FIG. 33 and also FIG. 36 for the arrangement of these)
5. 8 pieces of polarizer movable modules (see FIGS. 33 and 36)
6. 16 pieces of linear bearing shafts (shafts with linear bearing connection to the guiding element, see FIGS. 33 and 36)

Being the components in line with the above list, a further embodiment is shown in FIG. 30 (in this figure, an assembled working block). It is important to note at the beginning of the description of this embodiment that in an embodiment which has the above stationary rings and movable discs, the number of polarizer elements and, consequently, the number of stationary and movable permanent magnets can be different from the numbers listed above and also from the number of these observable in the figures (FIG. 30 shows eight indentations for stationary permanent magnets and nine indentations for movable permanent magnets). As a rule, similarly to the other embodiments, there are as many polarizer elements as many stationary permanent magnets in a stationary ring (one polarizer element for each stationary permanent magnet, any of the stationary rings can be considered to determine the number of the polarizer elements).

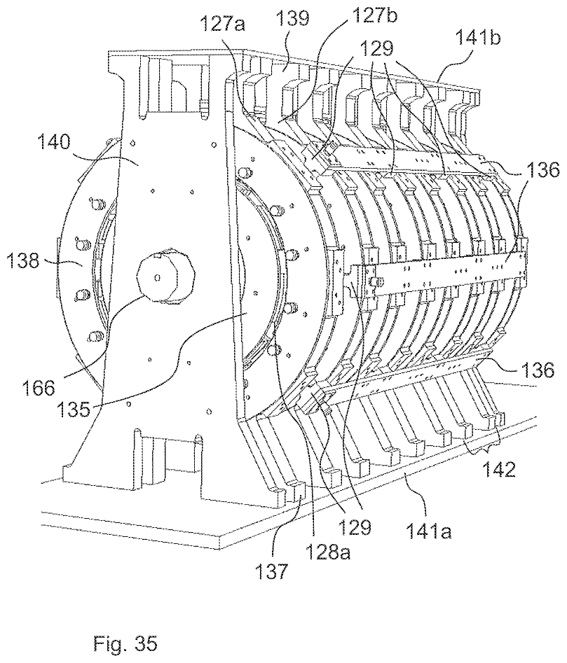

In FIG. 30 the structure of a working block is shown. It is possible also for this configuration to have a plurality of working blocks in an apparatus (see e.g. FIG. 35). The illustrated working block has two stationary rings 127a and 127b, which are arranged around a respective movable disc (from the two movable disc, only movable disc 128b is visible in FIG. 30, since the other movable disc 128b is covered by other components in the view of the figure, see FIG. 36 for movable disc 128b).

The stationary rings 127a and 127b have mainly annular shape to surround the respective movable discs 128a and 128b, but for standing and fitting to the structure, these have standing projections 137 (at the bottom part to stand on) and connections projections 139 (on the top for being connected). See also peripheric flat portions 137a.

The movable disc 128a and 128b have mainly disc shape. Both the stationary rings 127a, 127b and the movable discs 128a, 128b have indentations for placing the permanent magnets. On the inner periphery of the stationary rings 128a, 128b first indentations 121′ are formed to receive the stationary permanent magnets (in the illustrated case eight pieces of these are formed), as well as on the outer periphery of the movable discs second indentations 123′ are formed to receive the movable permanent magnets (in the illustrated case nine of them is formed).

In FIG. 30 the ends of guiding shafts 130a and 130b are visible, these two guiding shafts 130a and 130b compose a guiding shaft arrangement 130. A guiding shaft arrangement 130 (i.e. a pair of guiding shafts 130a, 130b) is arranged for each of the stationary permanent magnets (it is shown in FIG. 30 that the ends of the guiding shafts 130a, 130b comes out from the stationary ring 127b at the two side of each first indentations 121′).

The guiding shaft arrangements 130 connect the two stationary ring 127a and 127b in order to guide guiding elements 129. Each or the guiding elements 129 are adapted for moving a polarizer element 134 between the two stationary rings for polarizing the stationary permanent magnets alternately, i.e. once in the first stationary ring 127a and once in the second stationary ring 127b such that it is inserted between the stationary permanent magnets of a stationary ring and the movable permanent magnets of the corresponding movable disc (see below for the details of the operation of the polarizer elements).

It is an important feature of the experimental arrangement is that two stationary rings having a completely identical configuration are arranged at a predetermined distance from each other. This any of the stationary rings 127a, 127b could be in FIG. 31, but it is illustrated as a stationary ring 127a. The number and position of the stationary magnets (i.e. stationary permanent magnets) mounted on the stationary rings is the same for all such rings. The number of magnets built in each stationary ring of the experimental apparatus —which has been tested as a realization of the present embodiment—is eight.

Each movable disc (rotor disc) of the experimental apparatus comprises nine magnets (the pair of movable discs 128a and 128b is illustrated in FIG. 32, the exact number of movable permanent magnets on a movable disc 128a, 128b is not visible, but it is observable in FIG. 30; in FIG. 32 the movable disc 128a is covered by a first covering plate 135). As it is shown in FIG. 32, into each working block two movable disc 128a and 128b and one movable disc connector tubular shaft 131 are built. The movable discs 128a and 128b have an identical configuration, i.e. these are identical as far as their shape and positions of the magnets is concerned. As illustrated in FIG. 32 (the figure shows a rotating disc unit), the movable discs are mounted to both ends of the tubular shaft 131 at an angular displacement (angular difference or angular distance) corresponding to the half of the arc between two indentations 123′ (considering the centre of the indentations on the periphery).

In FIGS. 31 and 32 it is indicated that the stationary ring 127a is an implementation of a stationary module 127′ (i.e. one of the stationary rings 127a, 127b is an implementation of the stationary module 127′, any of the stationary rings 127a, 127b would have been chosen), as well as that the movable disc 128b is an implementation of a movable module 128′ (i.e. one of the movable discs 128a, 128b is an implementation of the stationary module 128′, any of the movable discs 128a, 128b would have been chosen), respectively.

In FIG. 33, a guiding element 129 adapter for moving the polarizer element 134 connected to it is shown (cf. with FIG. 36, where this assembly is arranged in an exploded view to its respective positions). Accordingly, the guiding element 129 can be called also polarizer-movable module or polarizer-moving holding element.

The guiding element 129 in the illustrated embodiment has an approximate T-shape. It has a stem with a widened connector end 129a (this is a foot for the T-shape) which is adapted for connecting a moving assembly to the guiding element 129 (see e. g. FIG. 35).

It is also shown in FIG. 33, that on the other end of the stem a wider structure than the connector end 129a—crosswise to the stem—is formed, this is a shaft holder end 129b (this is the top cross line of the T-shape). On the one hand, the polarizer element 134 is connected to the top of the T-shape, i.e. on the outer side of the shaft holder end 129b. On the other hand, guiding shafts 130a and 130b extend through the guiding element 129 in the terminal parts of the shaft holder end 129b connected into the shaft holder end 129b via a linear bearing 133 which allows that guiding shafts 130a, 130b can move in the shaft holder end 129b along their longitudinal axes.

As shown in FIG. 33, the guiding shafts 130a, 130b as well as the polarizer element 134 are connected to the guiding element 129 in such a way that that these extends towards it in two directions (perpendicular to the T-shape). This is because the guiding element 129 has to lead the polarizer element 134 to be inserted between the stationary and movable permanent magnets of the stationary rings 127a, 127b and the movable discs 128a, 128b which are arranged in the mentioned two directions from the guiding element 129, i.e. at the front and back side of the T-shape (cf. FIG. 30). The polarizer element 134 has such overextensions on both side of the guiding element 129 that the polarizer element can be fully inserted to between the stationary ring 127a, 127b and the corresponding movable disc 128a, 128b so as to cover the respective stationary permanent magnet 121.

In FIG. 34A a polarizer element is shown separately with holes 198 for fixing it to the guiding element 129. The polarizer element 134 is a sheet having approximately rectangular shape and—according to the sheet like configuration—the polarizer element 134 is relatively thin (the rectangular sheet has a small thickness) similarly to polarizer elements of other embodiments (see e.g. polarizer elements 24 and 84, the results of Table 1 are hereby referred also, where polarizer elements with small thickness were tested).

In FIG. 34B polarizer element 134′ has an overextension 199 (these two are curved as observable in the figure). The asymmetry of polarizer element 134 will be touched upon in connection with FIG. 37, where the cross sections of the polarizer elements 134 are observable. The polarizer element 134′ has a yet larger asymmetry with the overextension 199.

An appropriately sized asymmetry can help in the situation, where a polarizer element is to be pulled out of two permanent magnets. At the other stationary ring-movable disc pair where the polarizer element is transferred, only one permanent magnet has an attractive force on the polarizer element since the movable magnet being in late, in accordance with the alignment in the other stationary ring-movable disc pair. If in this case the overextension is large enough, the polarizer element can reach the approaching movable magnet in the receiving pair of stationary ring and movable disc. Thus, the energy needed for transferring the polarizer element can be decreased.

In FIG. 35 an apparatus comprising four working blocks (preferably, all configured the same) of FIG. 30 as assembled is shown. Based on some components the arrangement of working blocks 142 can be determined in FIG. 35. The working blocks 142 stand on a basis sheet 141a and connected to each other at their top projections 139 by means of a connector sheet 141b. The terminal stationary rings of the working blocks 142 are confined between confining sheets 140 (the confining sheet 140 at the front is visible in its whole in FIG. 35, only the leg of the other confining sheet can be observed at the other end of the row of the stationary rings 127a, 127b), which stand also on the basis sheet 141a and connected to the connector sheet 141b. The confining sheet 140 has similar shaped projections as the stationary rings 127a, 127b as shown in FIG. 35.

The arrangement of each stationary rings 127a, 127b in the row in the apparatus is observable by the help of their projections (legs) 137 and 139 (visible at the basis sheet 141a and the connector sheet 141b). Other parts of the stationary rings 127a being at the beginning of the row are covered by a ring-shaped second covering plate 138. The edges of the covering plates 138 are visible for all of the stationary rings 127a, 127b of the apparatus.

In FIG. 35, the first movable module 128a is also visible surrounded by the first (or front) covering plate 138 (and partly covered by the front confining sheet 140). The ends of the guiding shafts 130a, 130b are also visible on the front covering sheet 138 since these are also let through it.

It is to be noted in the apparatus shown in FIG. 35 that the moving structure (as a part of a second polarizer moving arrangement) of the guiding elements 129, is realized by the application of the controlling elongated elements 136. In the right side of the apparatus three controlling elongated elements 136 are shown. It is best observable at the that one arranged on the top of these that the controlling elongated element 136 is connected to each guiding element 129 in a row.

The working blocks 142 are arranged in a row (as also mentioned above) and the arrangement of the guiding elements 129 helps to understand the structure of the working blocks 142. Four guiding elements are visible for top controlling elongated element 136 and three guiding element 129 is visible at the right side of the apparatus for the front working block 142 (the guiding elements 129 are similarly arranged for the other working blocks 142 not arranged at the front and the left part of the apparatus is in coverage, but it has similar structure as it will be shown in other figures below). It can be observed that each guiding elements 129 of the top controlling elongated element 136 are inserted between two stationary ring 127a, 127b of a respective working block 142 (for the peipheric flat portions 137a giving a flat place and somewhat projecting out of the outer periphery of the stationary rings 127a, 127b—see the role of the peripheric flat portions 137a, below in connection with the compensator arrangements—between which the guiding element is arranged, see FIG. 30, 31, but in FIG. 35 these are covered partly by the covering plate 138). The other controlling elongated elements 136 also connect such rows of guiding elements 129 of the working blocks 142.

Accordingly, by the help of the controlling elongated elements 136 the guiding elements 129 of the working blocks 142 in the row can be operated simultaneously (i.e. parallelly, at the same time by the help of the second polarizer moving arrangement, see below). In line with the above disclosures the guiding elements are operated in such a way that they are moved between the two stationary ring-movable disc pair of a working block 142. Thus, by the help of the controlling elongated elements rows of the guiding elements 129 are operable together, and other guiding elements 129 of a working block 142 operated together with that of other working blocks 142 also in rows.

Thus, in the embodiment illustrated in FIG. 35, multiple first working units (called as working blocks above) of a pair of a first stationary ring 127a and a second stationary ring 127b arranged around a first movable disc 128a and a second movable disc 128b, respectively, are arranged along a first main shaft 166, and the guiding elements 129 corresponding to each of the pairs of the first stationary ring 127a and the second stationary ring 127b are arranged in controlling rows (called elsewhere simply rows), and the guiding element 129 of each controlling row are connected to a respective controlling elongated element 136.

In this embodiment, the apparatus comprises a second polarizer moving arrangement adapted for moving independently of each other each of the plurality of polarizer elements 134 via moving each guiding element 129 along the respective guiding shaft arrangement 130 (this is the way how the polarizer elements 134 can move independently).

Furthermore, preferably, each guiding element 129 is movable (displaceable) by means of a respective controlling elongated element 136 (with other name, controlling connection or rod element) connected to the respective guiding element 129, wherein each controlling elongated element 136 is elongated in a moving direction (in order to be able to move the guiding element effectively from a distance) of the respective guiding element 129 (thus, the second polarizer moving arrangement is realized by the controlling elongated elements driven independently by an appropriate driving unit, e.g. a motor).

In FIG. 36 a working block of the apparatus of the present embodiment is shown in an exploded view. On the left and the right side, outermost of the components the stationary rings 127a, 127b are shown. The movable discs 128a, 128b fitting to the stationary rings 127a, 127b are shown between them. Similarly to FIG. 30, the stationary rings 127a, 127b and the movable discs 128a, 128b are illustrated without the stationary and movable permanent magnets (these are observable in FIG. 37). Accordingly, the indentations 121′, 123′ are shown in FIG. 36.

In the center part of FIG. 36, the guiding shaft arrangements with the polarizer elements 134 are shown (shown also in FIG. 33). It is observable in the figure that a separate guiding shaft arrangement corresponds to each of the stationary permanent magnets (the places of which can be identified based on the indentations 121′, the guiding shafts 130a, 130b can be inserted into holes 132 formed at two sides of the respective indentations 121′), the eight guiding shaft arrangement is arranged with respect to the angular positions of the indentations 121′ for stationary permanent magnets so that the respective polarizer element 134 can be inserted in front of the stationary permanent magnet in both stationary rings 127a, 127b. In FIG. 36 it is also observable that the movable discs 128a, 128b have different angular positions.

In FIG. 37 the operation of operation of a working block of the present embodiment is illustrated. In FIG. 37 the stationary ring 127a and the movable disc 128a of a working block is shown. FIG. 37 shows also stationary permanent magnets 121 arranged in the stationary ring 127a on its inner periphery, as well as movable permanent magnets 123 arranged in the movable disc 128a on the outer periphery.

In the position illustrated in FIG. 37, the uppermost stationary permanent magnet 121 and movable permanent magnet 123 is aligned, these face to each other. It is clear from FIG. 37 that other pairs of a stationary permanent magnet 121 and a movable permanent magnet 123 can be brought into alignment (according to a rotation denoted by arrows 162), i.e. to a position in which these face to each other.

In the side view of FIG. 37, the polarizer elements 134 are shown (the guiding shaft arrangements are arranged behind the stationary ring 127a and the movable disc 128a). From this view, the polarizer elements are always visible (i.e. irrespective that these are brought into the position in front of the stationary permanent magnets 121 of the stationary ring 127a or the stationary ring 127b, or when they are in between the stationary rings 127a, 127b).

It is observable also in FIG. 33 that—compared to the T-shape of the guiding element 129—the polarizer element 134 is arranged asymmetrically. This asymmetric arrangement can be observed in FIG. 37, according to which the polarizer element 134 extends over the front section of the stationary permanent magnet 121 (in the left direction e.g. for the uppermost stationary permanent magnet 121). It can be observed in FIG. 37 that the polarizer element 134 has a larger lateral overextension in one direction in that view than in the other. E.g. for the topmost stationary permanent magnet 121 the polarizer element 134 extends much more in the left direction. As can be observed in FIG. 37 this overextension does not influence the pushing effect on the left side of FIG. 37 (since the extension is on the other side of the stationary permanent magnet 121), but it can help by the pulling effect on the right side of FIG. 37 since they can ‘reach’ earlier the movable permanent magnet 123.

The movement of the polarizer elements 134 can be interpreted based on FIGS. 36 and 37 noting that the movable discs 128a and 128b are connected firmly to each other by a tubular shaft 131, i.e. these cannot rotate with respect to each other. This means that the angular displacement between the movable discs 128a, 128b pre-set when the apparatus was assembled remains constant.

As illustrated also in the movable discs 128a, 128b of FIG. 36, those are in a rotated position (i.e. having angular displacement) with respect to each other such that an indentation 123′ for a movable permanent magnet in one of them is projected to a position on the halfway of two indentations 123′ on the other of them.

In connection with the present embodiment the followings are to be noted. The polarizer elements 134 are moved by the help of the controlling elongated elements 136 (via the guiding elements 129). For all of the polarizer elements 134 an external rhythm is given to each of the polarizer elements 134. In order to make this possible, the controlling elongated elements 136 are arranged in a number as many polarizer elements 134 are arranged in a working block (however, the polarizer elements 134 of the different working blocks can be connected to the same controlling elongated element 136).

It is noted hereby, that in every embodiment the rhythm of the movement is determined by moving the polarizer elements, however, e.g. in the embodiment of FIG. 12, feedback is given. Of course, the movement (in many cases, rotation) can be established also without feedback (see also the embodiment of FIG. 19).

Considering FIGS. 36 and 37 (and also the different ratios illustrated in FIGS. 15A-15I, which ratios are also applicable to the approach of the present embodiment), the followings are listed as the basic principles of the present embodiment:
all of the polarizer elements 134 will have the same frequency in their alternating (sinusoidal) movement, in other words, the controlling elongated elements 136 will be moved with the same frequency;
to the alternating movement of the respective polarizer elements 134 also a phase parameter will be assigned, the phase parameter will be dependent on the number and arrangement of the stationary and movable permanent magnets considering first the case when the stationary and movable permanent magnets are arranged symmetrically (equidistantly) in the stationary ring and movable disc, respectively;
because of the angular displacement applied in the present embodiment, the sinusoidal movement of the polarizer elements 134 fits to the arrangement, since the magnets of the ring-disc pairs of the working block “need” the presence of a polarizer element 134 alternatively.

It is noted, furthermore, that when the phase parameters are fixed then the frequency can be adjusted. Accordingly, the apparatus for example may start with a lower frequency (and, thus, rotating speed of the movable disc) which can be increased continuously or gradually.

The arrangement is also conceivable for the case where the permanent magnets are not arranged equidistantly, but in a less ordered manner. The movement of the respective polarizer element can also be determined even if the arrangement is not equidistant for the embodiments in which the polarizer element should be inserted with appropriate timing.

Let us now consider FIG. 37 to interpret the phases. It is to be noted that the rotation will be established based on the movement of the polarizer elements 134. Thus, when the above parameters of the rotation are set, a certain position of the movable disc 128a will correspond to a certain time instance and to the phase distribution of the polarizer elements 134 assumed at this time instant. However, in view of this the phase distribution can be interpreted based on FIG. 37.

Considering the topmost part and the bottommost part of the movable disc 128a, it can be observed that at the topmost part, permanent magnets 121 and 123 face each other (these are in alignment), while at the bottommost part the stationary permanent magnet 121 is just in the halfway of two movable permanent magnets 123. It is clear in these positions (namely in from of these two stationary permanent magnets) the polarizer elements 134 will be in an opposite phase considering the stationary ring 127a and movable disc 128a. Such an opposite situation also happens at the same time with the stationary ring 127b and movable disc 128b, however, the positions of the polarizer elements 134 for these is naturally determined by the positions of the polarizer elements 134 for the front —namely, for this figure, stationary ring 127a and movable disc 128a.

According to the arrangement shown in FIG. 37 the position of the polarizer element 134 on the topmost will be something that the polarizer comes into between the topmost permanent magnets 121 and 123, since the rotation is clockwise and there is a repulsion for the movable permanent magnet 123 being at the left of the topmost permanent magnet 123 and there is an attraction of the movable permanent magnet 123 being at the right of the topmost permanent magnet 123.

Furthermore, it is given, that for the arrangement shown in FIG. 37 the polarizer will have nine alternating movement when the movable module 128a rotates once, since there are nine movable permanent magnets 123 and a polarizer element 134 corresponding to a stationary permanent magnet 121 will have to “react” to these nine movable permanent magnets 123 in a single turn of the movable disc 128a. On “react” it is meant that the polarizer element will help to attract a movable permanent magnet 123 while it approaches and by its removal will facilitate that the respective stationary permanent magnet 121 will push the same movable permanent magnet 123 after it has passed the stationary permanent magnet 121.

Thus, the polarizer elements 134 will be such a position for the right-side stationary permanent magnets 121 that a full or part polarization of them can be established for them to help the pulling of the respective movable permanent magnets 123. At the same time, for the left-side stationary permanent magnets the polarizer elements 134 will be more or less removed from between the permanent magnets 121, 123 to facilitate pushing (to a larger or smaller extent) of the movable permanent magnets 123 at this side. The phase of the polarizer elements 134 will be gradually different value compared to the neighbouring stationary permanent magnets 121 (i.e. for the case illustrated in FIG. 37 a gradual phase distribution for one cycle will correspond).

It is added to the above, that in the embodiment illustrated in FIG. 37, the number of stages is four, which means that there will be four polarizer elements 134 from the eight polarizer elements 134 corresponding to the eight stationary permanent magnets 121 which have a stage independent from the other polarizer elements 134. It can be understood based on FIG. 37 that such as the topmost and the bottommost stationary permanent magnet 121 other stationary permanent magnets namely those which are arranged opposite each other in the stationary ring 127a have such phase that is dependent on each other, namely the polarizer elements 134 of these pairs are in an opposite stage, i.e. their phase is shifted by 180°.

To summarize, in connection with these movement aspects it has to be once again noted, that an alternating movement with different phases (gradually changing phases) will be given to the polarizer elements 134 and the rotation of the movable disc 128a will be established as a consequence of this. Thus, in this respect, FIG. 37 is mainly for visualize a situation.

Furthermore, the above principles for the phase can be generalized for other ratios where the permanent magnets are arranged equidistantly (it is observable that the permanent magnets are arranged at equal distances on a periphery, i.e. these are arranged in a symmetric way on a given radius; there is the same distance between all neighbouring permanent magnet on the same module, e.g. on a stationary ring or a movable disc).

Let us now consider FIGS. 15A-15I once again. Many of the cases illustrated in FIGS. 15A-15I is similar in principles to the arrangement illustrated in FIG. 37, since there is only one pair of stationary and movable permanent magnets at the same time (see below for the number of stages and other information).

However, there are some cases where more than one pairs of stationary and movable permanent magnets, such as FIG. 15C, 15D or 15G. In these arrangements there are three pairs being in the same phase when the topmost stationary and movable permanent magnets are aligned.

From the point of view of stages this means the following e.g. for FIG. 15C. The topmost pair of permanent magnets and the fourth stationary permanent magnet to the right making a pair with the aligning movable permanent magnet are in the same stage (have the same phase). There are two stationary permanent magnets between these on the right: the phases of these are dependent, namely these have opposite phases to reach after the second one the phase of the aligned permanent magnets. Accordingly, the number of stages is two for FIG. 15C, since there are only two independent phases.

Similarly, the number of stages is two in the case of FIG. 15D. There are three stationary permanent magnets between the aligned pairs, but the phase of the middle from this three is not independent from the aligned pairs: the polarizer element corresponding to this stationary permanent magnet have to have the opposite phase compared to the aligned permanent magnets. Along this approach, the number of stages in case of FIG. 15G is three.

Similarly to the case illustrated in FIG. 37, there are many different phases in other cases from FIGS. 15A-15I. For example, in FIG. 15H there are eight stages, i.e. eight different phases are needed to describe the movement of the polarizer elements. Going into the details, it can be observed in FIG. 15H that—as a consequence of the special arrangement—the stationary permanent magnets have to be in many different phases during their alternating movement. The topmost permanent magnets are aligned, the next to the right has approximately no pair in movable disc 70h″ (but it has almost had alignment with the other movable disc of the pair in case of the present embodiment with the above-mentioned angular displacement (cf. FIG. 36), the movable permanent magnet of which is at the halfway of the two movable permanent magnets illustrated here). The second to the right has to pull the respective movable permanent magnet. The third stationary permanent magnet can give some push to the movable permanent magnet already passed in front of it. The fourth should pull the same movable permanent magnet. The fifth stationary permanent magnet has to push its moving pair, the sixth has not too much particular role in this stage. At last, the seventh has to push also the movable permanent magnet having almost the same position in the movable disc 70h″. Thus, counting also the aligned stationary permanent magnet, there are eight stages, i.e. eight different phases are needed to describe the movements of the respective polarizer elements. This interpretation can be applied also for other arrangements illustrated in FIGS. 15A-15I.

To summarize the above description, the arrangements for all of the ratios can be interpreted, i.e. the movement of the respective polarizer elements can be determined based on the parameters of the arrangements. It is noted also that the situation can be projected to the stationary ring of the pair (if there is a pair, like in case of FIGS. 36-37) because the movement of the polarizer element is an alternating movement. It can be moved to cover one of the stationary permanent magnets which correspond thereto, i.e. to be in polarization with one of these permanent magnets.

The length of the movable disc (rotor disc) assembly—i.e. that of the assembly connected by the tubular shaft 131—has to be determined based on the relative distance of the two stationary rings 127a, 127b such that the length of the movable disc assembly is the same as the relative distance of the outside faces of the stationary rings (to have the same width, cf. FIG. 30).

The relative distance of the stationary rings is determined by the dimensions of the included polarizer movable module (polarizer driving block, guiding element 129, see FIG. 33) and the dimensions of the magnet to be polarized. In the experimental apparatus realized as an example based on the above detailed embodiment N52 neodymium magnets with the dimensions of 30×30×30 mm have been built in. In the experimental apparatus, the width of the polarizer movable module (guiding element 129) is 30 mm. In order to prevent the components from accidentally bumping against each other during operation, an additional safety distance (gap) of 5-5 mm must be left at both stationary ring sides. In the experimental apparatus the relative distance of the two stationary rings was thus determined to be 30 (guiding element)+15 (moving path along the shaft: first side)+15 (moving path along the shaft: second side)+5 (gap: first side)+5 (gap: second side)=70 mm.

The inner diameter of the outer ring is 280 mm. The type and sizes of the magnets placed into the outer ring are N52 30 (width)×30 (length)×30 (height) mm. It is preferred to use the same type of magnet for the compensator that we want to compensate. In this case N52. The diameter of the rotating disc is 264 mm. The type and sizes of the magnets placed into the rotating disc are N52 30 (width)×30 (length)×30 (height) mm. The sizes of the polarizer element are 105 (length)×50 (width)×4 (thickness) mm. According to the above sizes, there is 70 mm distance between the two outer rings. Based on the sizes of the polarizer, the 105 mm size is in the direction of the distance, so the polarizer extends between the moving disc and the outer ring with 17.5 mm. Since it can move a further 15 mm, it is able to cover the cube magnet having 30 mm edge sizes. The degree of the highest magnetic peak thrust measured on magnet pair (R 132 mm on an arc) during the experiments is 6.935 kg*f. This value expressed in torque measured on the shaft is 8.9875 Nm. The applied frequency was 15 Hz. In the example a compensator arrangement is also applied, N52 30×30×10 mm permanent magnets were applied on the movable compensator arrangement part (the length of it in the example was 80 mm; in this case the distance of the two stationary rings was 70 mm), and N52 30×30×20 mm were applied in the stationary compensator arrangement part.

In our experiments, we have experienced factors hindering functioning as well as efficiency which caused energy loss in the analysation of every experimental equipment. Such as for example friction, internal air resistance, magnetic force field collision, generation of eddy currents in certain configurations, polarisation pulling counterforce, etc. When designing the experimental apparatuses, we focused on eliminating or reducing these factors causing loss of energy and we utilised these solutions in the disclosed experimental apparatuses.

The polarizer movable module (see FIGS. 33, 36) ensures that the stabile mounting of polarizer, as well as that the polarizer and the polarizer movable module can be moved together. The polarizer movable module (guiding element 129) is made of a non-magnetizable material (in the experimental apparatus, aluminium). The configuration of the polarizer movable module comprises a polarizer fixing location, a retaining (fixing) location (i.e. the connector end 129a) for the control driving arm adapted for moving the polarizer movable module, and a retaining (fixing) location for the linear bearing (on the shaft holder end 129b which is adapted for receiving the linear bearing 133) adapted to guide the polarizer movable module. Each polarizer movable module comprises two—preferably high-precision—linear bearings 133 with preferably high load-bearing capacity.

The predetermined distance between the two stationary rings of the working block is provided by a linear bearing shaft that is to be built into the apparatus. The built-in linear bearing shaft has preferably ground surface, high wear resistance, and high load-bearing capacity. The arrangement of holes 132 (see FIG. 31; with other name boreholes for—the shaft of—the linear bearing) with a diameter identical to the diameter of the linear bearing shaft 130a, 130b have to be formed in the stationary ring 127a, 127b. The boreholes must be positioned such that in operation they correspond to the longitudinal axis of the linear bearing of the polarizer movable module and to the operating position of the polarizer.

Preferably, at each end of the linear bearing shaft there are disposed two seats (shown by a peripheric line on the shafts 130a, 130b: these go to the two side of a stationary ring 127a, 127b) for receiving Seeger rings (see FIG. 33) such that a Seeger ring is arranged at each side of the stationary ring. Thus, fixing of the working block is provided, while it is also ensured that the working distance between the two stationary ring is precisely maintained: the guiding element 129 can approximately move between the two Seeger rings being closer to it towards the stationary rings 127a. 127b, but cannot reach the Seeger rings, a safety distance is to be maintained (see above).

In the exemplary experimental apparatus, eight pieces of polarizers (polarizer elements) with a thickness of 4 mm, made of soft iron, were built into the working block (see FIGS. 34, 36, 37). The dimensions and geometric configuration of the polarizer can be determined, in each case, based on the dimensions of the magnet to be polarized, on the envisaged bidirectional working length and on the distance between the stationary rings.

The magnetic working stages of the double-disc working block arrangement (i.e. the present embodiment) are identical (i.e. are on similar principles) to the stages of the experimental apparatuses no. 1 and no. 2 described above. In this arrangement, the direction of movement of the polarizer is perpendicular to the direction of travel of the movable disc magnets (see FIGS. 36, 37). This corresponds to the movement direction applied in the case of the experimental apparatus no. 1. In the case of experimental apparatuses no. 1 and no. 2, 100% of the energy required for moving the polarizer had to be introduced from an external power source.

By providing the double-disc arrangement, a four-stage (four-stroke) arrangement has been provided that has two work units (i.e. two magnets working at the same time on the two discs) and is adapted for rotational motion (see FIGS. 30, 36, 37)

Advantageously, in the case of the double-disc working block, moving the polarizers is also assisted by the attractive forces of the magnets arranged in stationary rings and of the movable disc acting on the polarizer, so the external energy input required for moving the polarizer is significantly lower.

In the double-disc arrangement (see FIGS. 30, 36, 37) the positions of the magnets arranged in the stationary rings are identical. Thus, in this arrangement each magnet has a magnet pair in the opposite-lying stationary ring. The polarizer is moved between the magnets situated opposite each other. When the permanent magnet situated in one of the stationary rings (e.g. the stationary ring 127a) is covered by the polarizer the permanent magnet becomes fully polarized. The permanent magnet of the movable disc then becomes aligned, without resistance, with the fully polarized stationary ring permanent magnet. The permanent magnet situated in the other stationary ring (thus the stationary ring 127b) is free, so it acts on the permanent magnet of the movable disc with its full repulsive force. As the polarizer is moved, the stages are exchanged between the permanent magnets of the stationary rings, i.e. the permanent magnet of the stationary ring 127b becomes polarized, and the permanent magnet of the stationary ring 127a is freed up.

Due to the angular displacement (difference) between the movable discs as mentioned above (it can be considered a 180° angular difference if the difference in the arrangement of the movable discs is taken into consideration), at this point the stationary ring 127a acts with a repulsive force on the permanent magnet of the movable disc.

Because the arrangement of the stationary ring comprises an even number of magnets, the opposite-laying magnet of each stationary ring performs an opposite stage. During the operation of the double-disc arrangement, a respective magnet of each stationary disc situated diagonally with respect to each other performs a working stage in the course of the same stage. Based on the above, in each stage of each double-disc working block two magnet pairs perform a power stage (see the arrangement illustrated e.g. in FIG. 37; these can be different for other permanent magnet ratios).

Each double-disc working block operates as a standalone (independent) drive unit. The configuration of the working block allows for connecting more working blocks, whereby its power output can be increased.

Therefore, in the present embodiment, a first stationary ring 127a and a second stationary ring 127b arranged around a first movable disc 128a and a second movable disc 128b, respectively, are arranged for the plurality of polarizer elements 134, wherein
the plurality of polarizer elements 134 are arranged in the same number as the plurality of the first permanent magnets 121 of any of the first stationary ring 127a and the second stationary ring 127b (i.e. any one of them; the number of the polarizer elements to be applied is to be determined based on the permanent magnet number of one of the stationary rings being in a pair; as given in details in connection with the guiding elements, each of the plurality of polarizer elements 134 correspond both to the first stationary ring 127a and the second stationary ring 127b—namely to given stationary permanent magnets thereof which are in the same position—and is movable to be arranged in front of any of a corresponding pair of first permanent magnets 121 of the first stationary ring 127a and the second stationary ring 127b; i.e. it is true also in this embodiment that the plurality of polarizer elements are arranged in the same number as the plurality of the first permanent magnets of the movable module (movable disc) where it is given that the number of the polarizer elements is counted to a single movable disc, since it is in singular form and here it is given how it is generalized), and
the first movable disc 128a and the second movable disc 128b are connected to each other in an angular displacement (i.e. they are connected—e.g. by means of a tubular shaft 131, but other connections are also conceivable—to each other in a fixed manner; angular displacement means that these are displaced angularly, i.e. can be shifted to the same position with a rotation) wherein the movable permanent magnets are alternately arranged in the arranged in the first movable disc 128a and the second movable disc 128b (this aspect is shown dearly in FIG. 36 and it has been detailed there).

Furthermore, as it has been touched upon above, it is also holds true in the present embodiment that each of the polarizer elements 134 are fixed to a respective guiding element 129 (this was illustrated by the polarizer elements 134 and the guiding elements 129) movable along a respective guiding shaft arrangement (here, guiding shaft arrangement 130) adapted for moving the respective polarizer element 134 to the working position and out of the working position (preferably, between the working position and the resting position).

It is noted hereby, that although the guiding elements 27 and 129 have different configuration, these have the same role in connection with the moving: these are adapted for moving the respective polarizer element along a respective guiding shaft arrangement.

In the present embodiment, furthermore, the guiding shaft arrangements 130 corresponding to the plurality of polarizer elements 134 connect the first stationary ring 127a and the second stationary ring 127b so that each of the polarizer elements 134 are moveable to a first polarizer working position and a second polarizer working position, wherein in the first polarizer working position the respective polarizer element 134 is inserted between the first stationary ring 127a and the first movable disc 128a (i.e. into its working position to be arranged in front of a stationary permanent magnet 121, the first polarizer working position is a resting position with respect of the second polarizer working position and vice versa), as well as in the second polarizer working position the respective polarizer element 134 is inserted between the second stationary ring 127b and the second movable disc 128b.

It is noted that the resting position is assumed when the polarizer element is removed from the working position, i.e. it preferably “starts” earlier then the polarizer gets into the other working position. In other words, the apparatus is preferably configured in such a way that when the polarizer element is fully inserted into a working position it is fully removed from the other working position. Moreover, preferably, when it is already totally removed from one of the working positions (i.e. when it is already in the resting position from the view of this working position), a further movement of the polarizer element is needed to be fully inserted into the other working position.

Accordingly, the first stationary ring 127a and the second stationary ring 127b are arranged as stationary rings, i.e. in this embodiment two stationary rings—and corresponding movable discs—are arranged (in a working block as will be illustrated in FIG. 35; since working block is a basic block the details of it are given here), and the manner of arranging of the polarizer elements is also given above: a polarizer element can be moved between its working positions corresponding to the respective stationary rings, i.e. the number of polarizer elements can be determined based on the first permanent magnets of any of the stationary rings.

In summary, similarly to the embodiment shown e.g. in FIGS. 8 and 11A-11D, the followings are also fulfilled in the present embodiment:
the movable module (in this case, the movable module 128′, see FIG. 32) is implemented by a movable disc (both of movable discs 128a and 128b) arranged rotatable with respect to the stationary module (in this case stationary rings 127a, 127b) and the plurality of second permanent magnets 123 are arranged at a first periphery of the movable disc,
the stationary module (in this case, the stationary module 127′, see FIG. 31) is implemented by a stationary ring (both of stationary rings 127a and 127b) arranged around the movable disc,
the plurality of first permanent magnets (in this case, first permanent magnets 121, see FIG. 37) are arranged on an inner periphery of the stationary ring, and the plurality of second permanent magnets (in this case, the second permanent magnets 123) are arranged at the first periphery of the movable disc being the outer periphery thereof so that a magnetic pole of the plurality of second permanent magnets are arranged on the outer periphery of the movable disc, and
a polarizer element (in this case polarizer element 134) corresponds to each of the first permanent magnets and each of the plurality of polarizer elements is moveable to (in connection with the working and resting positions for the present embodiment, see above) a working position, wherein a respective polarizer element is arranged at the inner periphery of the stationary ring in front of a first permanent magnet corresponding to the respective polarizer element (preferably, the polarizer elements are movable between the working position and a resting position, wherein the polarizer element is removed from in front of the first permanent magnet).

Furthermore, it also holds true preferably in the present embodiment that the first permanent magnets 121 are arranged equidistantly on the inner periphery of the stationary ring (in this case, stationary rings 127a, 127b) and the second permanent magnets 123 are arranged equidistantly on the outer periphery of the movable disc (in this case, movable discs 128a, 128b). This aspect has been touched upon in connection with FIGS. 15A-15I showing the ratios applicable for the first and second (type) permanent magnets.

Furthermore, preferably, a first magnet number of the first permanent magnets 121 of the stationary ring (in this case, of stationary ring 127a, 127b) is different from a second magnet number of the second permanent magnets 123 of the movable disc (in this case, of the movable disc 128a, 128b; the first and second permanent magnet numbers are to be compared for a pair of a stationary ring and a movable disc, i.e. for the pair of stationary ring 127a-movable disc 128a or the pair of stationary ring 127b-movable disc 128b).

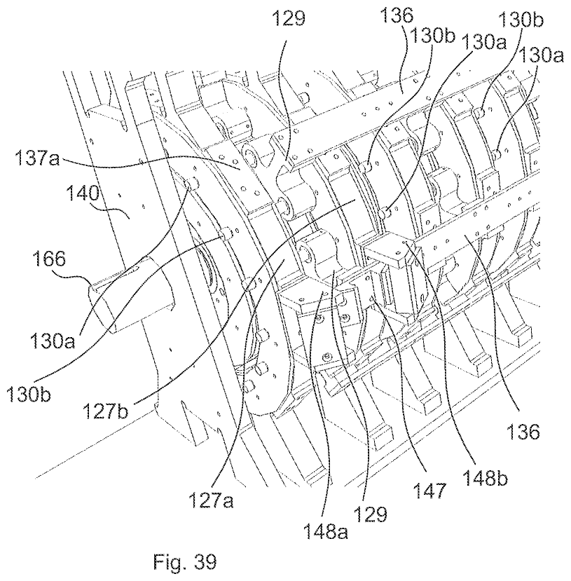

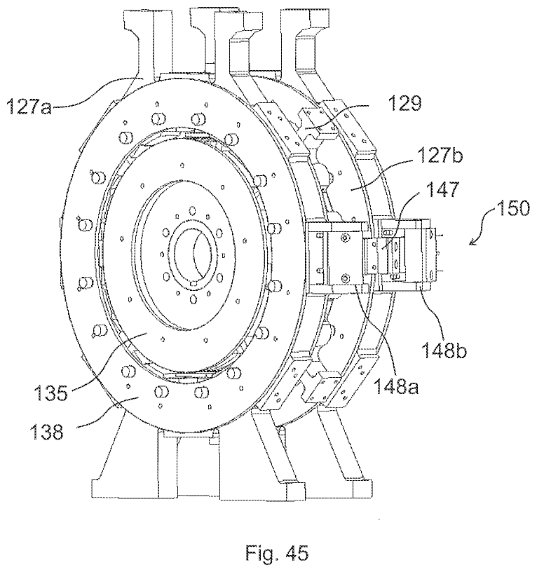

It is particularly preferred, when the difference between the first magnet number and the second magnet number is one (this is advantageous on its own since the movements of the polarizer elements can be easily designed). If, however, furthermore, on the top of the difference of one between the first magnet number and the second magnet number also compensator arrangement is also comprised for the polarizer elements (preferably for all of the guiding elements), then that embodiment is particularly preferred. Such an embodiment is illustrated in FIGS. 39-45, cf. also with FIG. 37. The compensator always help in order to fewer energy input is needed. However, in this case we will always have the opposite phases on the apparatus, as a result of which the apparatus with these parameters can operate with a less strong compensator, i.e. less strong compensator magnets. Normally, permanent magnets of same strength as the stationary and movable permanent magnets are to be used in the compensator, but in this case permanent magnets with less strength can be used.

A final configuration of the experimental apparatus realized according to the present embodiment is assembled from four independent working blocks applying a common principal shaft (see a main shaft 166 which has preferably two functions: firstly, it holds the movable discs and fixes their positions, secondly, summarizes the power output on a shaft and makes possible the utilization of it), i.e. the experimental apparatus is realized according to FIG. 36. Herebelow, the experimental results obtained with this experimental apparatus are summarized.

The four-working-block apparatus (system) was tested with a pneumatic and also with an electromechanical drive. With a pneumatic drive, the pneumatic unit performed as expected at low rotational speeds (25-30 revolutions/minute—3.75-4.5 Hz). At higher speeds (60-65 revolutions/minute—9-9.75 Hz) the pneumatic drive was unable to provide full movement of the polarizer, so the efficiency of the system was reduced significantly, approximately by 45-48%.

By way of the control arms (controlling elongated elements), the electromechanical drive provides a firm connection between the drive unit and the polarizers, resulting in that the polarizers—moving along a constrained path—had 100% polarization and 100% power output at a speed of 100 revolutions/minute and a polarizer frequency of 15 Hz.

The torque of the four-working-block apparatus (system), measured in the stationary state, is 70.8 Nm (it is like a starting torque reaching the maximum torque). In the case of a pneumatic drive, the torque value measured at low rotational speeds was 69 Nm. At higher speeds, the output torque decreased to 31.5 Nm.

By applying an electromechanical drive unit, the value of output torque measured in the stationary state and in operation was equally 71.9 Nm. A power increase of 1.53% was demonstrated by multiple repeated measurements (compared to the results obtained by the pneumatic drive).

The increase of output power is explained by the polarizers moving along a constrained path determined by the firm connection between the electromechanical system, the drive and the polarizer block can provide a 100% polarization and capability of outputting power.

In the following the role of the magnetic compensator arrangement (in short: compensator) is disclosed in the above detailed embodiment.

In the course of magnetic polarization, the stationary magnets exert a pull force on the polarizer constantly, while the movable magnets exert a pull force thereon cyclically. The amount of energy required for operating the system is determined by the magnetic pull force acting on the polarizer. In order to reduce the operating energy demand, it became necessary to apply—e.g. a repulsive—magnetic compensator to counteract the magnetic pull force acting on the polarizer.

It is an essential aspect of the magnetic compensator is that a pair of magnets with a repulsive force nearly equals the magnetic pull force acting on the polarizer is built in the given polarizer assembly, such that the opposite-direction repulsive energy reduces or compensates the energy of the magnetic pull forces acting on the polarizer.

The possibility of application and integration of the compensators in a particular apparatus is dependent on the given arrangement, so several different configurations are possible.

As an example, a magnetic compensator provided for experimental arrangement no. 3 will be described below.

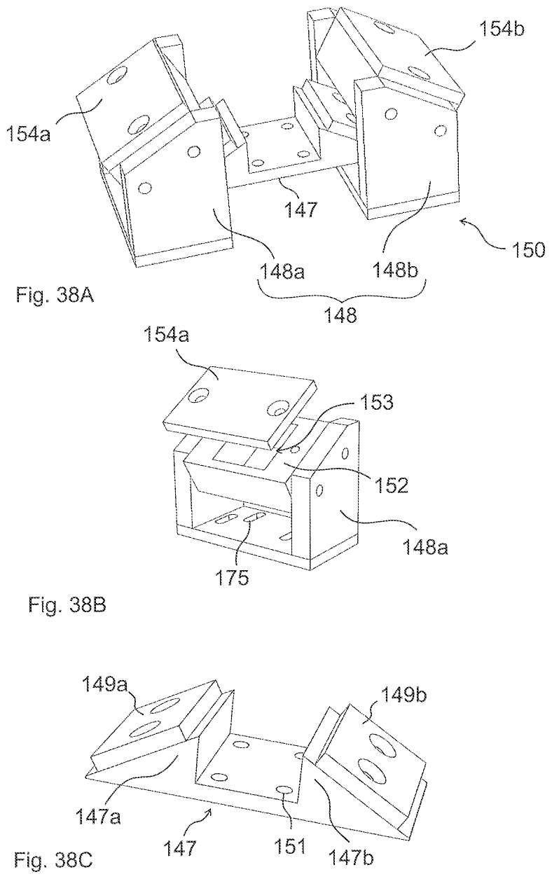

An embodiment of the magnetic compensator arrangement has two major components as illustrated in FIGS. 38A-38C. FIG. 38A illustrates the whole compensator arrangement with movable unit (with other name: movable compensator arrangement part 147) and a stationary unit (a stationary compensator arrangement part 148 having a first stationary compensator element 148a and a second stationary compensator element 148b).

The movable compensator arrangement part 147 is illustrated in details in FIG. 38C. In this figure it is shown that it has a basic part 147c which is a rectangular shaped sheet with a first wedge-shaped block 147a and a second wedge-shaped block 147b at its ends in the elongated direction. The wedge-shaped blocks 147a, 147b descend outside at both ends. The movable compensator arrangement part 147 has a third auxiliary magnet 149a and a fourth auxiliary magnet 149b on the descending parts of the first wedge-shaped block 147a and the second wedge-shaped block 147b, respectively.

Moreover, in the basic part 147c through holes 151 are formed for fixing the movable unit with screws led to the through holes 151.

In FIG. 38B the first stationary compensator element 148a of the stationary unit is illustrated. In FIG. 38A it is also shown that a respective cover element 154a and 154b are arranged on the descending top part of the stationary compensator elements 148a, 148b.

Under the cover element 154a, a magnet holder block 152 is arranged (fixed preferably by screws to the two side walls of the first stationary compensator element 148a) in which a magnet holder nest 153 (having cuboid shape having rectangular base) is formed for arranging a first auxiliary permanent magnet. The first stationary compensator element can be fixed to basement by the help of through holes 175 formed on a base plate of the first stationary compensator element. The second stationary compensator element 148b is formed in an analogous way (but symmetrically) as the first stationary compensator element 148a.

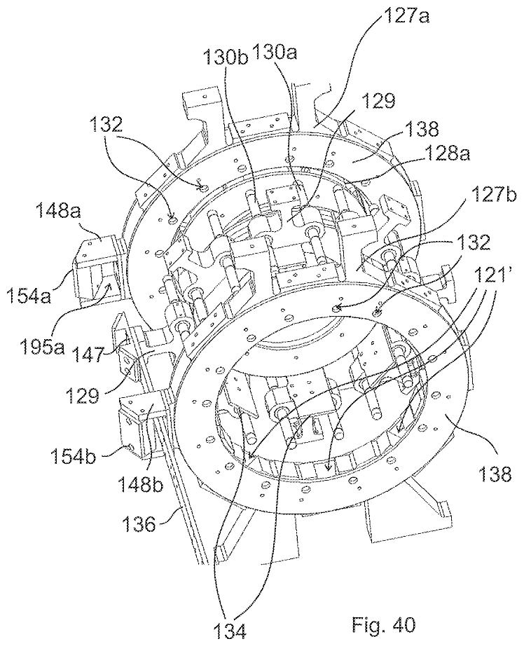

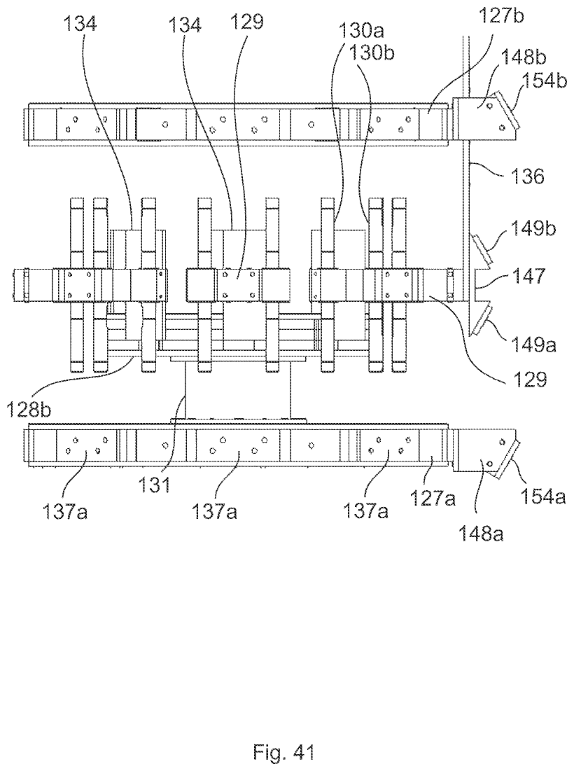

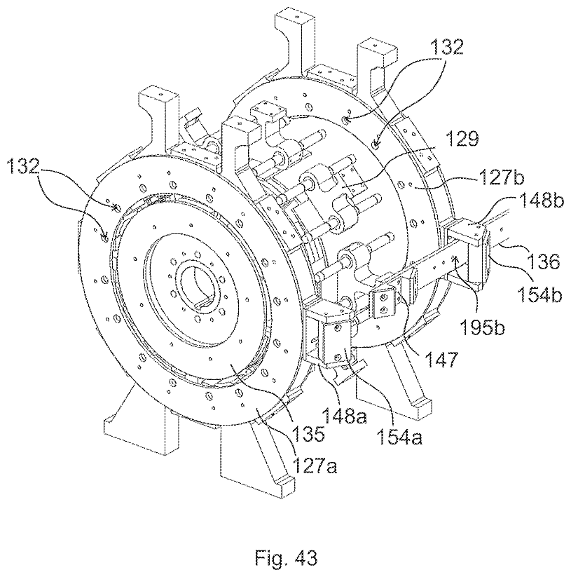

As shown in FIG. 38A the top part descends in the direction pointing outside in order to have enough place for the movable compensator arrangement part 147 to be inserted into the stationary compensator elements 148a, 148b fitting—so as to getting closer to the auxiliary magnets arranged in the stationary compensator elements 148a, 148b—the wedge-shaped blocks 147a, 147b into receiving spaces 195a, 195b (see FIGS. 40 and 43)—having also wedge-like shape—under the magnet holder nests 153 formed in the magnet holder blocks similarly descending as the cover elements 154a, 154b.

In an example, the compensator arrangement is formed so as to comprise:
1. Movable unit (moving unit; movable compensator arrangement part 147 in FIG. 38A)
   a. one piece of magnet holder block (this is the compensator movable arrangement part 147 itself)
   b. two pieces of 30×30×5 N48 magnets (bored, fixed by screws; these are the third and fourth auxiliary permanent magnets 149a, 149b)
2. Stationary unit (stationary compensator arrangement part 148 in FIG. 38A)
   a. two pieces of magnet holder blocks (these are the first and second stationary compensator elements 148a, 148b)
   b. two pieces of 30×30×20 N48 magnets (these can be arranged in the magnet holder nests 153 of the stationary compensator elements 148a, 148b)

In the movable compensator arrangement part 147, the third and fourth auxiliary permanent magnets 149a, 149b are attached to the respective magnet holder blocks (first and second wedge-shaped block 147a, 147b) of the movable unit by screws, such that the magnets 149a, 149b are arranged with their identical poles facing the magnets (first and second auxiliary permanent magnets to be arranged in the magnet holder nests 153) arranged in the stationary unit (module, in this embodiment stationary rings), but with an exemplary angular separation of 30° with respect to the base of the stationary compensator elements 148a, 148b. The movable part 147 is attached with screws to the polarizer connector and drive rail (to the controlling elongated element 136), and the stator unit is attached with screws to an attachment location formed on the stationary rings 127a, 127b.

The screw retaining location (through holes 175) of the magnet holder block of the stationary unit is configured in a manner that the magnetic compensator unit can be calibrated to the polarizer unit of the system such that the magnetic pull forces acting on the polarizer can be compensated with the highest possible efficiency.

During the tests, by the help of the compensator arrangement (an embodiment of which is illustrated in FIGS. 38A-38C), it was possible to reduce the energy required for operating the system by 67.2% in an exemplary realization of the present embodiment.

In FIG. 39 the parts of the compensator arrangement, i.e. the movable compensator arrangement part 147 and the stationary compensator elements 148a, 148b are illustrated mounted to the above disclosed embodiment. It is shown in FIG. 39 that the stationary compensator elements 148a, 148b are fixed to the outer periphery of the stationary rings 127a, 127b onto a respective peripheric flat portion 137a.

It is also shown that the movable compensator arrangement part 147 is fixed to the guiding element 129 (namely to its projecting widened connector end 129a) and thus the movable compensator arrangement part 147 and the stationary compensator elements 148a, 148b are arranged vis-A-vis each other that their respective auxiliary magnets can approach each other. The movable compensator arrangement part 147 is also fixed to the controlling elongated element 136 with the help of which the moving thereof can be managed. First, the controlling elongated element 136 is fixed to the connector end 129a, and after that the movable compensator arrangement part 147, this is clear if the connection of the upper controlling elongated element 136 and the guiding element 129 is considered.

It is to be noted that it is enough to arrange only one compensator arrangement along a single controlling elongated element 136 (it also helps the movement of the other guiding elements 129 connected to the controlling elongated element 136). It is preferred to arrange a respective compensator arrangement to each of the controlling elongated elements 136. In this case, all of these can be driven by the same driving force.

It is also clear from FIG. 39 how the guiding shafts 130a, 130b are led through the stationary rings 127a, 127b (ends of the guiding shafts 130a, 130b corresponding to further stationary rings 127a, 127b can be observer in FIG. 39) and how the guiding elements 129 can be guided along these.

In FIG. 39 also a first main shaft 166 is shown (see also FIG. 35) which is led through the confining sheet 140. The first main shaft is led through the tubular shafts 131 and preferably rotates together with them, i.e. the rotation of the movable discs 128a, 128b of the working units can be commonly output onto the first main shaft 166.

According to the above disclosures, in the present embodiment the apparatus comprises a compensator arrangement (e.g. the compensator arrangement 150 and its components are illustrated in FIG. 38A) having
a stationary compensator arrangement part 148 being stationary with respect to the first stationary ring 127a and second stationary ring 127b and having a first compensator magnet arrangement, and
a movable compensator arrangement part 147 being fixed to the guiding element 129 having a second compensator magnet arrangement,
   wherein (here, it is detailed how the magnetic poles of the first compensator magnet arrangement and the second compensator magnet arrangement are arranged to facilitate a movement (displacement) of the polarizer element out of the working position, preferably from the working position to the resting position, see also the aspects in connection with the first and second polarizer working positions)
the stationary compensator arrangement part 148 comprises a pair of a first stationary compensator element 148a provided with a first auxiliary permanent magnet (the first auxiliary permanent magnet is fixed to it) of the first compensator magnet arrangement and a second stationary compensator element 148b provided with a second auxiliary permanent magnet of the first compensator magnet arrangement, wherein the first stationary compensator element 148a and the second stationary compensator element 148b are arranged on the outer peripheries of the first stationary ring 127a and the second stationary ring 127b, respectively,
the movable compensator arrangement part 147 having a first end provided with a third auxiliary permanent magnet 149a of the second compensator magnet arrangement and a second end provided with a fourth auxiliary permanent magnet 149b of the second compensator magnet arrangement directed to the first stationary compensator element 148a and the second stationary compensator element 148b, respectively (i.e. these are arranged so that to be directed to these stationary compensator elements 148a, 148b, see e.g. FIG. 38A, in other words arranged on ends being at these stationary compensator elements 148a, 148b), is fixed to the guiding element 129, wherein
   the first auxiliary permanent magnet and the third auxiliary permanent magnet 149a, as well as the second auxiliary permanent magnet and the fourth auxiliary permanent magnet 149b have same magnetic poles facing each other, or
   the first auxiliary permanent magnet and the third auxiliary permanent magnet, as well as the second auxiliary permanent magnet and the fourth auxiliary permanent magnet have different magnetic poles facing each other (this can be also the case for the illustration, but the manner of arrangement of the auxiliary permanent magnets have to be decided based on the ‘or’ option between these two sections).

It is noted that these last two points give a certain level specialization; however, as illustrated by the compensator arrangements of FIG. 13D and FIGS. 46-47, the concept of the compensator arrangement (in short: compensator) can be generalized compared to these requirements.

The compensator can be configured to be operable based attraction or repulsion. These configurations are similar, but the compensator parts are to be applied for an apparatus configuration that they perform their effect against the forces emerging on the polarizer elements. In the case illustrated in FIG. 39 and the corresponding figures, a repulsion-based operation compensator is described.

In an equilibrium state, the stationary and movable permanent magnets exert (the same) attractive force on the polarizer element. At the same time, the stationary magnets of the compensator exert the same repulsive force to the movable magnet of the compensator fixed to the guiding element of the polarizer element.

A compensated work stage (i.e. when the compensator is effective) is that when a movable permanent magnet becomes aligned with a stationary permanent magnet in a polarized state (i.e. the polarizer element is inserted into between these). At this time instance the movable and stationary permanent magnets both exert an attractive force on the polarizer element, i.e. the polarizer element is forced into between the permanent magnets. The polarizer element moves together with the movable magnet of the compensator, thus at this stage as a consequence of the movement of the polarizer element, the distance between the stationary and movable magnets of the compensator also decreases. By the decreasing of the distance, the repulsive force between the stationary and movable magnets of the compensator increases. This force has thus an opposite direction compared to the attractive force acting between the polarizer element and the stationary and movable permanent magnets. Thus, by this repulsive force the total force on the polarizer element decreases and, consequently, the energy consumption necessary for moving the polarizer element also decreases.

In FIG. 40, a further exploded view of the present embodiment provided with a compensator arrangement is shown. In this view, the components are pulled further from each other, especially in case of the stationary rings 127a, 127b. Therefore, also the components of the compensator will be further away from each other. Accordingly, it becomes more visible how the movable compensator arrangement part 147 can be moved by the help of the controlling elongated element 136 between the stationary compensator elements 148a, 148b (the controlling elongated element 136 is led through the stationary compensator element 148b, thus the auxiliary permanent magnets 149a, 149b can be introduced into the wedge-like shape receiving spaces 195a, 195b formed in the stationary compensator elements 148a, 148b) and how the components—namely the movable compensator arrangement part 147, the controlling elongated element 136 and the guiding element 129—are connected to each other.

It is also clear from FIG. 40 how the guiding shafts 130a, 130b can be introduced into the respective holes 132 on the stationary rings 127a and 127b (the guiding shafts 130a, 130b are arranged in front of the holes in FIG. 40). Indentations 121′ of the stationary ring 127b for receiving the stationary permanent magnets are also indicated in FIG. 40.

The working block provided with the compensator arrangement is shown in FIG. 41 (FIG. 40 also shows a working block). In FIG. 41 the components of the working block are shown in a top view (the movable disc 128b is observable on the tubular shaft 131; i.e. there are not exploded—disassembled—in the figure). In this view it is also observable that the stationary compensator elements 148a, 148b are connected to the stationary rings 127a, 127b, respectively and that the movable compensator arrangement part 147 is connected to a guiding element 129.

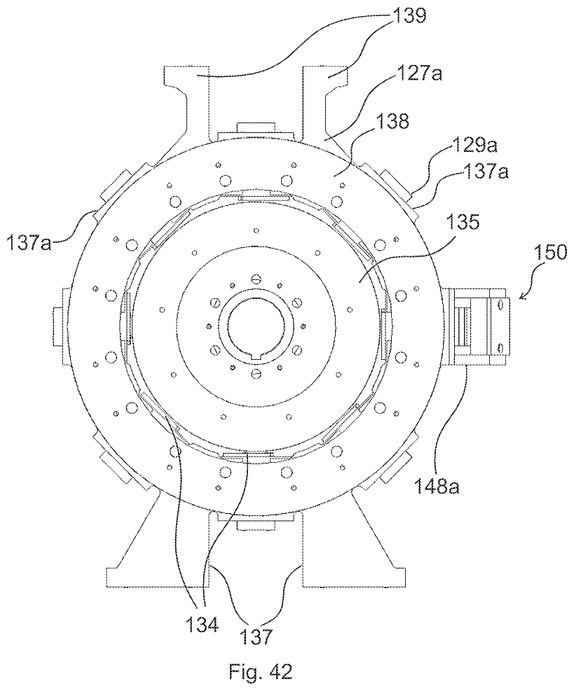

In FIG. 42 also the working block provided with the compensator arrangement 150 is shown in a front view seeing on the covering plate 138 of the stationary ring 127a and the covering plate 135 of the movable disc 128a. Where no compensator arrangement is arranged on the periphery, the peripheric flat portions 137a as well as the projecting connector ends 129a of the guiding elements 129 can be seen. A further exploded spatial view of the working block provided with a compensator arrangement is shown in FIG. 43.

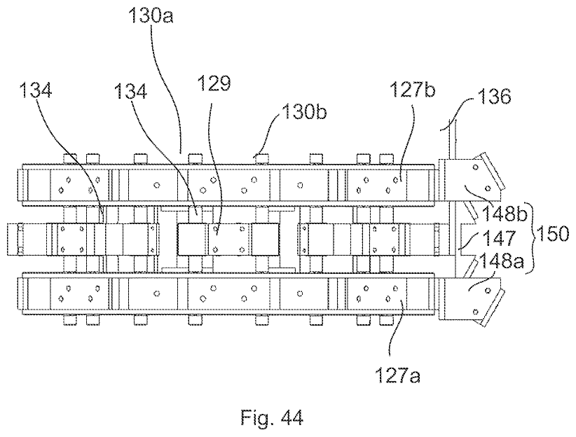

In FIG. 44 the working block with the compensator arrangement 150 can be seen also (in a top view similarly to FIG. 41), but in an assembled state. In the assembled state the base (centre) position of the compensator arrangement 150 as well as the guiding elements 129 (this is a base state in which these elements are not moved in the direction of any of the stationary rings 127a, 127b).

It can be observed that in this base state, the ends of the movable compensator arrangement part 147 are projecting into the stationary compensator elements 148a, 148b. With moving the movable compensator arrangement part 147 by means of the controlling elongated element 136 further into the receiving spaces 195a, 195b of the stationary compensator elements 148a, 148b.

At the same time, i.e. when the movable compensator arrangement part 147 is moved by means of the controlling elongated element 136, also the guiding element 129 provided with the movable compensator arrangement part 147 as well as other guiding elements 129 connected to other respective controlling elongated elements 136 are moved.

In line with the above, it is thus noted that FIG. 44 shows the base position of the polarizer element in which base position the polarizer elements 134 projecting into between both the pairs of the stationary ring 127a and the movable disc 128a as well as the stationary ring 127b and the movable disc 128b (this is clearly observable from the comparison of FIGS. 41 and 44). In FIG. 44 the guiding shafts 130a, 130b are in their assembled positions (projection out at their outer sides from the stationary rings 127a, 127b). Thus, it is also conceivable how the polarizer elements 134 are movable between the stationary rings 127a, 127b, in other words how these can be inserted more deeply into between the stationary ring 127a and the movable disc 128a or between the stationary ring 127b and the movable disc 128b to polarize the respective stationary permanent magnets (also, these can be preferably totally removed from between one of the stationary ring-movable disc pairs).

A further assembled state is illustrated of a working block provided with the compensator arrangement, here in a spatial view.

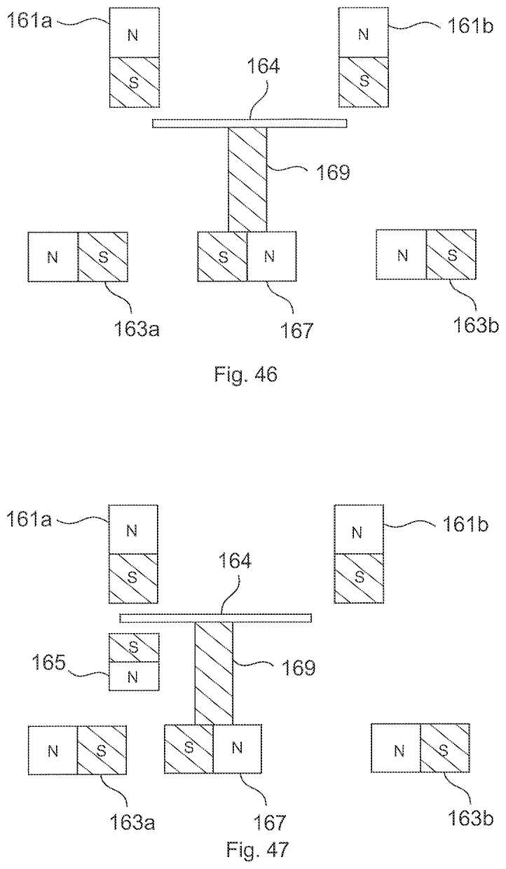

In FIGS. 46 and 47 operation principles of the compensator arrangement are illustrated in schematic drawings. In FIG. 46 a polarizer element 164 is shown which is positioned with respect of stationary permanent magnets 161a and 161b (the polarizer element 164 slightly projects under these similarly as illustrated in FIG. 44). In FIG. 46 a guiding element 169 (illustrated fully schematically, not showing the manner of the guiding) and an auxiliary magnet 167 of the movable compensator arrangement part (this latter is not illustrated separately) is shown also highly schematically. Also, auxiliary permanent magnets 163a and 163b of the stationary compensator element are shown (this latter is also not illustrated separately).

In FIG. 46 the movable compensator arrangement part (illustrated by the auxiliary magnet 167) is in the base position. It is shown that the auxiliary permanent magnets 163a and 163b are arranged with their poles such that opposite poles are arranged in front of each other between the auxiliary magnets of the movable compensator arrangement part and the respective stationary compensator elements.

In FIG. 47 that state is illustrated in which the polarizer element 164 is inserted more between the stationary permanent magnet 161a and a movable permanent magnet 165 (polarizing these). FIG. 47 illustrates that according to the configuration, during this movement the auxiliary magnet 167 of the movable compensator arrangement part is moved closer to the auxiliary magnet 163a. When these auxiliary permanent magnets 163a and 167 are moved close enough to each other that a repulsive interaction will come into effect between them and the auxiliary permanent magnet 167 of the movable compensator arrangement part will be pushed back in the direction of the other auxiliary permanent magnet 163b.

Since during the operation of this embodiment, the polarizer element has to be moved between a polarizing (working) position with the stationary permanent magnet 161a as well as that of auxiliary permanent magnet 161b, this repulsive effect can help the driving of the polarizer element 164 between the stages of the operation.

In the following a comparison is given between the invention and the prior art rotary device disclosed in U.S. Pat. No. 4,831,296 listed also in the introduction of the description. As given in the introduction, the prior art rotary device comprises a shielding member arranged between the rotor and the stator of rotary device. In the prior art apparatus, a gear connection is applied which interlock the driving shaft fixed to the rotor and the shielding member. In other words, it is mechanically provided that the rotation of the rotor and the shielding member to be dependent on each other.

In contrast, in the invention no ring-like shielding member with some through holes is utilized but a plurality of polarizer elements which can be exactly differentiated. In the invention the polarizer elements are arranged in a number that a single polarizer element can be ordered (or—in some embodiments—strictly corresponds) to each stationary permanent magnets of a stationary module (for the case of the double stationary ring, see the respective embodiment).

It is noted that the stationary module is preferably implemented by a stationary disc or a stationary ring. Sometimes (e.g. in the embodiment the illustration of which is started in FIG. 30 and in other cases more stationary modules can be arranged) preferably more stationary module (two stationary rings in the previously mentioned example) corresponds to a set of polarizers, however, even in these cases a single polarizer can be ordered to every permanent magnet of a single stationary module.

In U.S. Pat. No. 4,831,296 the shielding member is a continuous ring interrupted only by some through holes arranged in the number of the permanent magnets of the rotor, the stator has much more magnets (cf. FIG. 2 of U.S. Pat. No. 4,831,296). According to the configuration the shielding member has a continuous attracting effect between the rotor and stator permanent magnets and the shielding member having a braking effect on the movement.

In contrast, in the invention, the polarizer elements are controlled to be arranged in front of a stationary permanent magnet or to be removed from this position. In other words, it is controlled in the invention in what stages a polarizer element is applied to a stationary permanent magnet and when it is not applied (preferably in pulse like stages—modulated as well as sinusoidal movement may be called pulse like —, i.e. the polarizer element is applied time to time).

Moreover, in the comparison it is to be noted that in contrast with the interlocked rotor and shielding member of U.S. Pat. No. 4,831,296, in the invention the movement of the permanent magnets of the movable module is exclusively based on magnetic interactions which means
that in the invention there is no mechanical connection providing that the movement of the movable module and the polarizer elements to be dependent on each other,
but the movement of the movable module is driven by the pushing effect of one or more stationary permanent magnet which are not polarized (i.e. these have a repulsive effect on the movable permanent magnets) and/or the pulling effect of one or more polarizer element being in polarisation with a stationary permanent magnet.

It is noted that in U.S. Pat. No. 4,831,296 according to the description based on the configuration the permanent magnets of the rotor and the stator have a continuous attracting effect on the shielding member which leads to a continuous braking of its rotating capability. It is noted, furthermore, that in U.S. Pat. No. 4,831,296 the rotation direction of the rotor and the shielding member is opposite.

Herebelow, establishing of controlled rotational or translational motion by means of magnetic polarization is disclosed: the details are given above, additionally, some aspects are summarized here.

Controlled rotational or linear (generally, translational) motion can be established (generated) in a proven manner based on the experimental apparatuses and arrangements disclosed and described in detail hereinabove and also on several other experiments, utilizing the energy of permanent magnets, by applying magnetic polarizer.

For establishing rotational motion, the following factors can be taken into consideration:
The balance state of the movable and stationary magnets has to be disrupted (terminated, interrupted) in a direction. This disruption will determine the direction of rotation.
By the polarization of the magnetic field it is possible to disrupt the balance state, in the course of which, during the polarization, preferably, the effect of the magnets exerted on each other is eliminated as much as possible, and the magnets interact mainly with the material of the polarizer. This state is maintained as long as the polarizer remains situated between the magnets.
By removing the polarizer from between the magnets by lifting, as a result of the interaction between the magnets the rotational or linear motion is brought about as the movable magnet moves (in other words as a consequence of the removal of the polarizer, the movable magnet will start to move, i.e. the movable magnet will start—and later continue—to move as a consequence of a movement of the polarizer element).
Each pair of magnets can exert a push force on each other along a very short path. In order to achieve a continuous push force, and thus a continuous rotational or linear motion, it is necessary to apply multiple pairs of magnets (i.e. multiple pairs of stationary and movable magnets, in which—since the movable magnets move, e.g. rotate by the movable disc—there or no permanent pairs but occasional parts can be determined).
The arrangement of pairs of magnets is preferably formed such that they achieve an at least 10-15% overlap with respect to each other (i.e. the pairs producing repulsive effect are active parallelly of the time of the repulsive effect, cf. FIG. 14E, where the overlap of the finite torques is approx. 25% of a cycle time of a magnet pair); thereby the establishing of continuous motion can be ensured (see FIG. 14E, where it is detailed the overlap of the consecutive working magnet pairs provides for the continuous torque).
The polarizer has to be moved, both in timing and as far as the duration of its motion is concerned, corresponding to the relative position of the members of the given pair of magnets.
Moving the polarizer can be implemented, in relation to the speed and position of the movable magnet, applying mechanical, electromechanical and/or pneumatic systems.
The ratio of stationary and movable magnets is different in the different arrangements, but their number is not limited. This means that the number of the magnets that can be built into any arrangement is not limited, but the arrangements have to be in appropriate ratio to each other.

Herebelow, some further information is given about the magnetic polarizer, for example in connection with the definition thereof.

The material of the polarizer can be polarized only to a certain extent, because under the effect of a strong external magnetic field saturation occurs. There are no calculations for dimensioning the polarizer, so the magnetization or hysteresis curve of a given polarizer can only be determined by testing. However, by testing the applicable dimensions can be determined so these effects can be avoided.

For determining the realization of the polarizer, four factors must be considered:
the type and Gauss value of the magnet to be polarized,
the material of the polarizer,
the thickness and mass of the polarizer,
the outside dimensions and geometry of the polarizer.
   b. The Material of the Polarizer can be:
Fe (soft iron: produced from iron ores with the lowest carbon content)
Co (cobalt)
Ni (nickel)
Gd (gadolinium)
Dy (dysprosium)
and alloys of any of the above materials.
   c. Polarizer Thickness and Mass:
the mass of the polarizer must always be determined such that the desired polarization can be achieved. Its efficiency can be controlled or adjusted by modifying the thickness and other external dimensions of the material of the polarizer. No calculations exist for determining that. It is always determined by the material, dimensions, and magnetic field strength of the given magnet to be polarized.
   d. Polarizer Outside Dimensions:
The outside dimensions of the polarizer must be adapted to the dimensions of the magnetic force field of the magnet to be polarized. Based on our experiments, it is appropriate to apply a polarizer having a surface area that is at least 20% greater than the working surface area of the magnet to be polarized.
   e. Polarizer Configuration:
The polarizer must always be configured and dimensioned to correspond to the given system and use.

Herebelow, considerations are given in connection with the exact dimensioning of the magnetic polarizer.

The dimensions of the magnetic polarizer must always be determined in relation to the applied magnets. In line with the above details, based on our experiments, it is appropriate to apply a polarizer having a surface area that is at least 20% greater (preferably meant in the lateral direction, see above) than the working surface area of the magnet to be polarized. The length of the polarizer must always be adapted to the system to be produced, in relation to the ratio of the stationary and movable magnets and the relative distance of the magnets.

The thickness of the magnetic polarizer is always determined by the material, dimensions, and magnetic field strength of the given magnet to be polarized.

Polarizer materials can be polarized by the external magnetic field only to a certain extent. No calculations or equations exist for determining the exact material thickness of the polarizer. The required material thickness can only be determined through experiments and measurements, by methods adapted to the parameters of the particular system. The required material thickness can be determined only after the surface area and the geometric configuration of the polarizer have been determined based on the particular system to be utilized.

The configuration and geometry of the polarizer must always be determined according to the system to be applied. Accordingly, the polarizer types utilized in the course of our experiments are the following:
Flat configuration that is curved along its longitudinal axis (i.e. it has a shape like an arc, see FIGS. 17-18),
Flat, rectangular-block shaped configuration (see FIGS. 6A-6C and FIG. 34A),
Rectangular block shape that is curved along a direction perpendicular to the longitudinal axis (FIG. 34B).

Herebelow, some information is given about the application of the magnetic polarizer.

The magnetic polarizer can be applied for establishing any type of motion between magnets, be it along a circular or linear trajectory. Based on the experiments and tests we have performed, the practical applicability of the magnetic polarizer can be realized fulfilling the conditions below:
the magnetic polarizer must be applied in the magnetic field of the stationary magnet;
the magnetic polarizer has to be placed in front of the stationary magnet relative to the movable magnet at the optimal time, and then it must be removed at the optimal time;
in the case of a linear system, the magnetic polarizer must be moved perpendicular to the direction of movement of the movable magnet;
in the case of a circular system, the magnetic polarizer can be moved in a direction identical or perpendicular to the direction of movement of the movable magnet;
the magnetic polarizer has to be moved in the space between both the stationary and the movable magnets such that a constant air gap is left between the polarizer and the magnets; in no case the material of the polarizer can come in contact with the magnet;
the magnetic polarizer is preferred to be at an identical distance from both the stationary and the movable magnet (i.e. the arrangement is preferably so configured that a polarizer element is inserted into between the stationary and movable magnets).

Herebelow, some information is given about the applicability of the arrangement comprising a magnetic polarizer.

The application of the magnetic polarizer allows the production of kinetic energy utilizing the interaction between permanent magnets. The kinetic energy produced in such a manner is suitable for directly driving and operating machines and apparatuses. The arrangements provided applying magnetic polarizers are systems that can be operated without any harmful effects on the environment.

The present invention is not limited to the preferred embodiments presented above, and further variants, modifications, changes, and improvements may also be conceived within the scope defined by the claims.

1. An apparatus for moving a movable module thereof based on magnetic interactions, the apparatus comprising
a stationary module (30′, 89′, 127′) having a plurality of first permanent magnets (21, 101, 121, 161a-161b), and
a movable module (29′, 91′, 128′) arranged movably with respect to the stationary module (30′, 89′, 127′) and having a plurality of second permanent magnets (23, 103, 123, 165), wherein the plurality of the first permanent magnets (21, 101, 121, 161a-161b) and the plurality of the second permanent magnets (23, 103, 123, 165) are arranged on the stationary module (30′, 89′, 127′) and the movable module (29′, 91′, 128′), respectively, so that upon a movement of the movable module (29′, 91′, 128′) same magnetic poles of a first permanent magnet (21, 101, 121, 161a-161b) and a second permanent magnets (23, 103, 123, 165) are directed to each other,
characterized by further comprising a plurality of polarizer elements (24, 24a-24d, 84, 84a-84c, 134, 134′, 164) being made of magnetically polarizable material, and being arranged in the same number as the plurality of the first permanent magnets (21, 101, 121, 161a-161b) of the movable module (29′, 91′, 128′), and
the plurality of polarizer elements (24, 24a-24d, 84, 84a-84c, 134, 134′, 164) are arranged movably with respect to the stationary module (30′, 89′, 127′) so that each of the polarizer elements (24, 24a-24d, 84, 84a-84c, 134, 134′, 164) can be moved to be arranged between a first permanent magnet (21, 101, 121, 161a-161b) and a second permanent magnet (23, 103, 123, 165),
the apparatus is configured such that during an operation of the apparatus a movement of the movable module (29′, 91′, 128′) is exclusively based on magnetic interactions, wherein continuously during the operation of the apparatus for the movement of the movable module (29′, 91′, 128′) by means of moving of polarizer elements (24, 24a-24d, 84, 84a-84c, 134, 134′, 164)
a pushing effect is present between the same magnetic poles a first pair of a first permanent magnet (21, 101, 121, 161a-161b) and a second permanent magnet (23, 103, 123, 165), and/or
a pulling effect is present between a second permanent magnet (23, 103, 123, 165) and a polarizer element (24, 24a-24d, 84, 84a-84c, 134, 134′, 164) being moved into between a second pair of a first permanent magnet (21, 101, 121, 161a-161b) and the second permanent magnet (23, 103, 123, 165).

2. The apparatus according to claim 1, characterized in that each of the plurality of polarizer elements (24, 24a-24d, 84, 84a-84c, 134, 134′, 164) are adapted for covering a respective first permanent magnet (21, 101, 121, 161a-161b).

3. The apparatus according to claim 1, characterized in that the movable module (29′, 91′, 128′) is implemented by a movable disc (29, 70a″-70i″, 91, 91a-91e, 128a-128b) arranged rotatable with respect to the stationary module (30′, 89′, 127′) and the plurality of second permanent magnets (23, 103, 123, 165) are arranged at a first periphery of the movable disc (29, 70a″-70i″, 91, 91a-91e, 128a-128b).

4. The apparatus according to claim 3, characterized in that
the stationary module (30′, 127′) is implemented by a stationary ring (30, 70a′-70i′, 127a-127b) arranged around the movable disc (29, 70a″-70i″, 128a-128b),
the plurality of first permanent magnets (21, 121, 161a-161b) are arranged on an inner periphery of the stationary ring (30, 70a′-70i′, 127a-127b), and the plurality of second permanent magnets (23, 123, 165) are arranged at the first periphery of the movable disc (29, 70a″-70i″, 128a-128b) being the outer periphery thereof, and
a polarizer element (24, 24a-24d, 134, 134′, 164) corresponds to each of the first permanent magnets (21, 121, 161a-161b) and each of the plurality of polarizer elements (24, 24a-24d, 134, 134′, 164) is moveable to a working position, wherein a respective polarizer element (24, 24a-24d, 134, 134′, 164) is arranged at the inner periphery of the stationary ring (30, 70a′-70i′, 127a-127b) in front of a first permanent magnet (21, 121, 161a-161b) corresponding to the respective polarizer element (24, 24a-24d, 134, 134′, 164).

5. The apparatus according to claim 4, characterized in that each of the polarizer elements (24, 24a-24d, 134, 134′, 164) are fixed to a respective guiding element (27, 129, 169) moveable along a respective guiding shaft arrangement (60, 130) adapted for moving the respective polarizer element (24, 24a-24d, 134, 134′, 164) to the working position and out of the working position.

6. The apparatus according to claim 5, characterized by comprising a compensator arrangement (150) having
a stationary compensator arrangement part (64a, 148) being stationary with respect to the stationary ring (30, 70a′-70i′, 127a-127b) and having a first compensator magnet arrangement, and
a movable compensator arrangement part (64b, 147) being fixed to the guiding element (27, 129, 169) having a second compensator magnet arrangement,
wherein magnetic poles of the first compensator magnet arrangement and the second compensator magnet arrangement are arranged to facilitate a movement of the polarizer element (24, 24a-24d, 134, 134′, 164) out of the working position.

7. The apparatus according to claim 4, characterized in that the first permanent magnets (21, 121, 161a-161b) are arranged equidistantly on the inner periphery of the stationary ring (30, 70a′-70i′, 127a-127b) and the second permanent magnets (23, 123, 165) are arranged equidistantly on the outer periphery of the movable disc (29, 70a″-70i″, 128a-128b).

8. The apparatus according to claim 7, characterized in that a first magnet number of the plurality of first permanent magnets (21, 121, 161a-161b) of the stationary ring (30, 70a′-70i′, 127a-127b) is different from a second magnet number of the plurality of second permanent magnets (23, 123, 165) of the movable disc (29, 70a″-70i″, 128a-128b).

9. The apparatus according to claim 4, characterized in that a circular control element (32) is fixed to the movable disc (29, 70a″-70i″), wherein
the circular control element (32) comprises a cylindrical side wall (32a) having an axis coincident with an axis of rotation of the movable disc (29, 70a″-70i″) and having, at a first distance from the movable disc (29, 70a″-70i″), a plurality of transparent portions (33a, 33c) and a plurality of blocking portions (33b, 33d),
an optical source (38a) adapted for emitting light along a light path (39) and an optical receiver (38b) adapted for receiving the light emitted by the optical source (38a) and arranged on the light path (39) are arranged in a fixed manner with respect of the stationary ring (30, 70a′-70i′) so that during a rotation of the movable disc (29, 70a″-70i″) a transparent portion (33a, 33c) or a blocking portion (33b, 33d) of the cylindrical side wall (32a) is in the light path (39),
the plurality of blocking portions (33b, 33d) of the cylindrical side wall (32a) are arranged in a same blocking portion number as a first permanent magnet number of the plurality of first permanent magnets (21), a respective projected transparent arc portion overlapping at least partially with a first permanent magnet arc (68′) of the inner periphery of the stationary ring (30, 70a′-70i′) corresponds to each of the plurality of first permanent magnets (21), the plurality of transparent portions (33a, 33c) and the plurality of blocking portions (33b, 33d) are arranged in the cylindrical side wall (32a) so that, when during a rotation of the movable disc (29, 70a″-70i″) a radial centreline of a second permanent magnet (23) is within a projected transparent arc portion, a transparent portion (33b, 33d) of the cylindrical side wall (32a) is in the light path (39), and
during an operation of the apparatus, a polarizer element (24, 24a-24d) corresponding to a respective first permanent magnet (21) is in the working position when the radial centrelines of the plurality of second permanent magnets (23) are outside a projected transparent arc portion corresponding to the respective first permanent magnet (21).

10. The apparatus according to claim 9, characterized by comprising a first polarizer moving arrangement adapted for holding and moving independently each of the plurality of polarizer element (24, 24a-24d), being controllable by means of a control signal generated by the optical receiver (38b) adapted based on a receipt of the light emitted by the optical source (38a).

11. The apparatus according to claim 5, characterized in that
a first stationary ring (127a) and a second stationary ring (127b) arranged around a first movable disc (128a) and a second movable disc (128b), respectively, are arranged for the plurality of polarizer elements (134, 134′, 164), wherein
the plurality of polarizer elements (134, 134′, 164) are arranged in the same number as the plurality of the first permanent magnets (121, 161a-161b) of any of the first stationary ring (127a) and the second stationary ring (127b), and
the first movable disc (128a) and the second movable disc (128b) are connected to each other in an angular displacement wherein the first permanent magnets (123) are alternately arranged in the first movable disc (128a) and the second movable disc (128b), and
the guiding shaft arrangements (130) corresponding to the plurality of polarizer elements (134, 134′, 164) connect the first stationary ring (127a) and the second stationary ring (127b) so that each of the polarizer elements (134, 134′, 164) are moveable to a first polarizer working position and a second polarizer working position, wherein in the first polarizer working position the respective polarizer element (134, 134′, 164) is inserted between the first stationary ring (127a) and the first movable disc (128a), as well as in the second polarizer working position the respective polarizer element (134, 134′, 164) is inserted between the second stationary ring (127b) and the second movable disc (128b).

12. The apparatus according to claim 11, characterized by comprising a compensator arrangement (150) having
a stationary compensator arrangement part (148) being stationary with respect to the first stationary ring (127a) and the second stationary ring (127b) and having a first compensator magnet arrangement, and
a movable compensator arrangement part (147) being fixed to the guiding element (129) having a second compensator magnet arrangement,
wherein
the stationary compensator arrangement part (148) comprises a pair of a first stationary compensator element (148a) provided with a first auxiliary permanent magnet of the first compensator magnet arrangement and a second stationary compensator element (148b) provided with a second auxiliary permanent magnet of the first compensator magnet arrangement, wherein the first stationary compensator element (148a) and the second stationary compensator element (148b) are arranged on the outer peripheries of the first stationary ring (127a) and the second stationary ring (127b), respectively,
the compensator movable arrangement part (147) having a first end provided with a third auxiliary permanent magnet (149a) of the second compensator magnet arrangement and a second end provided with a fourth auxiliary permanent magnet (149b) of the second compensator magnet arrangement directed to the first stationary compensator element (148a) and the second stationary compensator element (148b), respectively, is fixed to the guiding element (129), wherein
the first auxiliary permanent magnet and the third auxiliary permanent magnet (149a), as well as the second auxiliary permanent magnet and the fourth auxiliary permanent magnet (149b) have same magnetic poles facing each other, or
the first auxiliary permanent magnet and the third auxiliary permanent magnet (149a), as well as the second auxiliary permanent magnet and the fourth auxiliary permanent magnet (149b) have different magnetic poles facing each other.

13. The apparatus according to claim 11, characterized by comprising a second polarizer moving arrangement adapted for moving independently of each other each of the plurality of polarizer elements (134, 134′, 164) via moving each guiding element (129) along the respective guiding shaft arrangement (130).

14. The apparatus according to claim 13, characterized in that each guiding element (129) is moveable by means of a respective controlling elongated element (136) connected to the respective guiding element (129), wherein each controlling elongated element (136) is elongated in a moving direction of the respective guiding element (129).

15. The apparatus according to claim 14, characterized in that multiple first working units of a pair of a first stationary ring (127a) and a second stationary ring (127b) arranged around a first movable disc (128a) and a second movable disc (128b), respectively, are arranged along a first main shaft (166), and the guiding elements (129) corresponding to each of the pairs of the first stationary ring (127a) and the second stationary ring (127b) are arranged in controlling rows, and the guiding element (129) of each controlling row are connected to a respective controlling elongated element (136).

16. The apparatus according to claim 3 characterized in that
the stationary module (89′) is implemented by a stationary disc (89, 89a-89e) and the plurality of first permanent magnets (101) are arranged at a second periphery of the stationary disc (89, 89a-89e) with their respective magnetic poles arranged on a base plate of the stationary disc (89, 89a-89e), wherein the second periphery having the same radius as the first periphery and the plurality of second permanent magnets (103) are arranged with their respective magnetic poles arranged on a base plate of the movable disc (91, 91a-91e),
the plurality of polarizer elements (84, 84a-84c) are arranged in an annular arrangement and incorporated into a polarizer disc (90, 90a-90e), and
the polarizer disc (90, 90a-90e) is arranged between the stationary disc (89, 89a-89e) and the movable disc (91, 91a-91e), wherein the stationary disc (89, 89a-89e), the movable disc (91, 91a-91e) and the polarizer disc (90, 90a-90e) are arranged along a second main shaft (116).

17. The apparatus according to claim 16, characterized in that the first permanent magnets (101) are arranged equidistantly at the second periphery of the stationary disc (89, 89a-89e) and the second permanent magnets (103) are arranged equidistantly at the first periphery of the movable disc (91, 91a-91e).

18. The apparatus according to claim 17, characterized in that a third magnet number of the first permanent magnets (101) of the stationary disc (89, 89a-89e) is half of a fourth magnet number of the second permanent magnets (103) of the movable disc (91, 91a-91e).

19. The apparatus according to claim 18, characterized in that a polarizer arc size (94) of a polarizer element (84, 84a-84c) on the first periphery of the polarizer disc (90, 90a-9e) is between a magnet distance arc size (102) corresponding to the distance between two neighbouring second permanent magnet (103) on the first periphery of the movable disc (91, 91a-91e) and the magnet shift arc size (102) added to one and a half of second permanent magnet arc size corresponding to a second permanent magnet on the first periphery.

20. The apparatus according to claim 16, characterized in that neighbouring polarizer elements (84, 84a-84c) in the annular arrangement are interconnected with each other by means of polarizer interconnections (85) being made of the same material as the plurality of polarizer elements (84, 84a-84c).

21. The apparatus according to claim 16, characterized by comprising a third polarizer moving arrangement adapted for rotating the polarizer disc (90, 90a-90e).

22. The apparatus according to claim 21, characterized in that driving teeth (117) are formed on or connected to an outer periphery of the polarizer disc (90, 90a-90e) and the third polarizer moving arrangement comprises a driving gear (115) fitting to the driving teeth (117) and adapted for rotating the polarizer disc (90, 90a-90e).

23. The apparatus according to claim 16, characterized in that multiple second working units of a polarizer disc (90, 90a-90e) arranged between a stationary disc (89, 89a-89e) and a movable disc (91, 91a-91e) are arranged along the second main shaft (116).
